(19) United States
(12) Patent Application Publication
(10) Pub. No.: US 2026/0299746 A1
(43) Pub. Date: Oct. 1, 2026

(54) METHODS OF FACILITATING DISPLAY OF CONTENT BETWEEN VIRTUAL OBJECTS IN A THREE-DIMENSIONAL ENVIRONMENT

(71) Applicant: Apple Inc., Cupertino, CA (US)

(72) Inventors: Adam G. POULOS, Saratoga, CA (US); Aaron M. BURNS, Sunnyvale, CA (US); Alexander T. WING, Fremont, CA (US); Alexis H. PALANGIE, Palo Alto, CA (US); David M. SCHATTEL, Munich (DE); Enrica CASUCCI, Los Altos, CA (US); Evgenii KRIVORUCHKO, San Francisco, CA (US); Jay MOON, San Francisco, CA (US); Charilaos PAPADOPOULOS, San Mateo, CA (US); Jamie J. MARCONI, Bellevue, WA (US); Jeffrey S. NORRIS, Saratoga, CA (US); Joanne LEE, Sunnyvale, CA (US); Cheuk Yin Phipson LEE, San Francisco, CA (US); Ryan S. CARLIN, Santa Clara, CA (US); Samantha KOIRE, Mountain View, CA (US); Shalva A. KOHEN, Mercer Island, WA (US); Matan STAUBER, Brooklyn, NY (US)

(21) Appl. No.: 19/578,482

(22) Filed: Mar. 25, 2026

Related U.S. Application Data
(60) Provisional application No. 63/777,443, filed on Mar. 25, 2025.
(60) Provisional application No. 64/000,740, filed on Mar. 9, 2026.

(51) Int. Cl. G06F 3/04815; G06F 3/01; G06F 3/0482; G06T 15/20; G06T 19/20

(52) U.S. Cl. CPC G06F 3/04815; G06F 3/017; G06F 3/0482; G06T 15/20; G06T 19/20; G06T 2200/24; G06T 2210/36; G06T 2219/2016

(57) ABSTRACT

In some embodiments, a computer system facilitates interactions with one or more virtual assets associated with a vertical virtual object in a three-dimensional environment, including adding the one or more virtual assets for display on a horizontal virtual object in the three-dimensional environment. In some embodiments, a computer system facilitates changing a visual appearance of a horizontal virtual object within a vertical virtual object in a three-dimensional environment based on whether the horizontal virtual object and its content are open in the three-dimensional environment. In some embodiments, a first computer system facilitates sharing of and subsequent interactions with a horizontal virtual object in a three-dimensional environment within a real-time communication session that includes a plurality of participants, including a first user of the first computer system.

### CROSS-REFERENCE TO RELATED APPLICATIONS

This application claims the benefit of U.S. Provisional Application No. 64/000,740, filed Mar. 9, 2026, and U.S. Provisional Application No. 63/777,443, filed Mar. 25, 2025, the contents of which are herein incorporated by reference in their entireties for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted display (HMD) device, a display, a projector, a touch-sensitive display (also known as a “touch screen” or “touch-screen display”), or other device or component that preserves visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system facilitates interactions with one or more virtual assets associated with a vertical virtual object in a three-dimensional environment, including adding the one or more virtual assets for display on a horizontal virtual object in the three-dimensional environment. In some embodiments, a computer system facilitates changing a visual appearance of a horizontal virtual object within a vertical virtual object in a three-dimensional environment based on whether the horizontal virtual object and its content are open in the three-dimensional environment. In some embodiments, a first computer system facilitates sharing of and subsequent interactions with a horizontal virtual object in a three-dimensional environment within a real-time communication session that includes a plurality of participants, including a first user of the first computer system.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the Figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flowchart illustrating a glint-assisted gaze tracking pipeline in accordance with some embodiments.

FIGS. 7A-7AA illustrate examples of a computer system facilitating interactions with virtual assets associated with a virtual object in a three-dimensional environment in accordance with some embodiments.

FIG. 8 is a flowchart illustrating an exemplary method of facilitating interactions with one or more virtual assets associated with a vertical virtual object in a three-dimensional environment, including adding the one or more virtual assets for display on a horizontal virtual object in the three-dimensional environment in accordance with some embodiments.

FIG. 9 is a flowchart illustrating an exemplary method of facilitating changing a visual appearance of a horizontal virtual object within a vertical virtual object in a three-dimensional environment based on whether the horizontal virtual object and its content are open in the three-dimensional environment in accordance with some embodiments.

FIGS. 10A-100 illustrate examples of a first computer system facilitating shared interactions with virtual assets associated with a virtual object in a three-dimensional environment within a real-time communication session in accordance with some embodiments.

FIG. 11 is a flowchart illustrating an exemplary method of facilitating shared interactions with virtual assets associated with a virtual object in a three-dimensional environment within a real-time communication session in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system facilitates interactions with one or more virtual assets associated with a vertical virtual object in a three-dimensional environment, including adding the one or more virtual assets for display on a horizontal virtual object in the three-dimensional environment. In some embodiments, while displaying, via one or more display generation components, a first object including one or more representations of virtual assets in an environment, the first object having a first orientation relative to a current viewpoint of a user of the computer system, the computer system detects, via one or more input devices, a first input directed to a first representation of a first virtual asset of the one or more representations of virtual assets. In some embodiments, in response to detecting the first input, in accordance with a determination that the first input satisfies one or more first criteria, the computer system displays, via the one or more display generation components, a second object, different from the first object, in the environment, the second object having a second orientation, different from the first orientation, relative to the current viewpoint of the user, and displays, via the one or more display generation components, the first representation of the first virtual asset of the one or more representations of virtual assets relative to the second object in the environment.

In some embodiments, a computer system facilitates changing a visual appearance of a horizontal virtual object within a vertical virtual object in a three-dimensional environment based on whether the horizontal virtual object and its content are open in the three-dimensional environment. In some embodiments, while displaying, via one or more display generation components, a first object having a first orientation in an environment relative to a viewpoint of a user of the computer system, the computer system detects, via one or more input devices, a first input corresponding to a request to display a second object that is associated with the first object in the environment. In some embodiments, in response to detecting the first input, the computer system displays, via the one or more display generation components, the second object that is associated with the first object in the environment, wherein the second object has a second orientation relative to the viewpoint of the user, and displays, in the first object, a first visual indication of the second object, wherein the first visual indication has a first visual appearance in the environment. In some embodiments, while displaying the second object in the environment and while displaying the first visual indication of the second object having the first visual appearance in the first object, the computer system detects, via the one or more input devices, a second input corresponding to a request to cease display of the second object in the environment. In some embodiments, in response to detecting the second input, the computer system ceases display, via the one or more display generation components, of the second object in the environment, and updates display of the first visual indication of the second object in the first object to have a second visual appearance, different from the first visual appearance, in the environment.

In some embodiments, a first computer system facilitates sharing of and subsequent interactions with a horizontal virtual object in a three-dimensional environment within a real-time communication session that includes a plurality of participants, including a first user of the first computer system. In some embodiments, while an environment is visible via one or more display generation components, the first computer system detects a first indication of a request to initiate communication with a second user, different from a first user of the first computer system, of a second computer system, different from the first computer system, wherein the request includes an invitation to share content between the first user and the second user. In some embodiments, in response to detecting the first indication, the first computer system enters a real-time communication session with the second user, including displaying, via the one or more display generation components, a first object having a first orientation in the environment relative to a viewpoint of the first user, wherein the first object is shared between the first user and the second user in the real-time communication session, and wherein the first object is displayed with a first option that is selectable to display a second object that is associated with the first object in the environment. In some embodiments, while displaying the first object with the first option in the environment, the first computer system detects, via one or more input devices, a first input corresponding to a selection of the first option. In some embodiments, in response to detecting the first input, the first computer system displays, via the one or more display generation components, the second object that is associated with the first object in the environment, wherein the second object has a second orientation relative to the viewpoint of the first user, wherein the second object is not shared between the first user and the second user in the real-time communication session.

Although the following description uses numerical indicators (e.g., terms such as “first,” “second,” “third,” or other numerical indicators) to describe various elements, these elements should not be limited by the numerical indicators. In some embodiments, these numerical indicators are used to distinguish one element from another. For example, a first element (e.g., object, input, or operation) could be termed a second element (e.g., object, input, or operation), and, similarly, a second element could be termed a first element, without departing from the scope of the various described embodiments. In some embodiments, the first element and the second element are two separate references to the same element. In some embodiments, the first element and the second element are both elements (or both the same type of element), but they are not the same element.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It should be understood that the term “and/or” as used herein refers to and encompasses any and all possible combinations of one or more of the associated listed items (e.g., “A and/or B” refers to “A and B” and, optionally, “A or B”). Unless explicitly stated otherwise, a parenthetical list of options separated by commas such as “(e.g., A, B, C)” should be interpreted as equivalent to A, B, and/or C. It should be understood that the terms “includes,” “including,” “comprises,” and/or “comprising,” when used in this specification, specify the presence of stated features, inputs, objects, integers, steps, operations, elements, and/or components, but do not preclude the presence or addition of one or more other features, inputs, objects, integers, steps, operations, elements, components, and/or groups thereof. As used herein, the phrase “one or more of A and/or B” is construed to include all combinations of A and B, including, but not limited to: A individually without B; B individually without A; as well as a combination of A and B. The phrase “one or more of A, B, and/or C” is construed to include all combinations of A, B, and C, including, but not limited to: A individually without B and C; B individually without A and C; C individually without A and B; as well as any combinations of A, B, and/or C (e.g., A and B without C; A and C without B; B and C without A; and/or A, B, and C). Additionally, as used herein, the phrase “selected from the group consisting of A, B, C, and a combination thereof” and the phrase “at least one of A, B, and C” shall be construed to have the same meaning as the phrase “one or more of A, B, and/or C” as defined above. As used herein, the phrase “at least one of A, B, or C” and “one or more of A, B, or C” shall be construed to have the same meaning as the phrase “one or more of A, B, and/or C” as defined above. As used herein, the phrase “a combination including all of A, B, and C” is construed to include a combination of all the elements listed (e.g., a combination of A, B, and C).

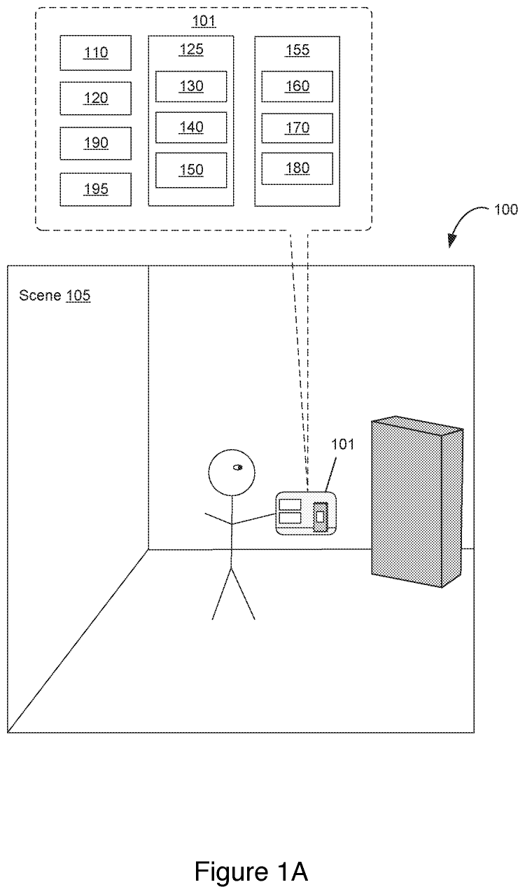

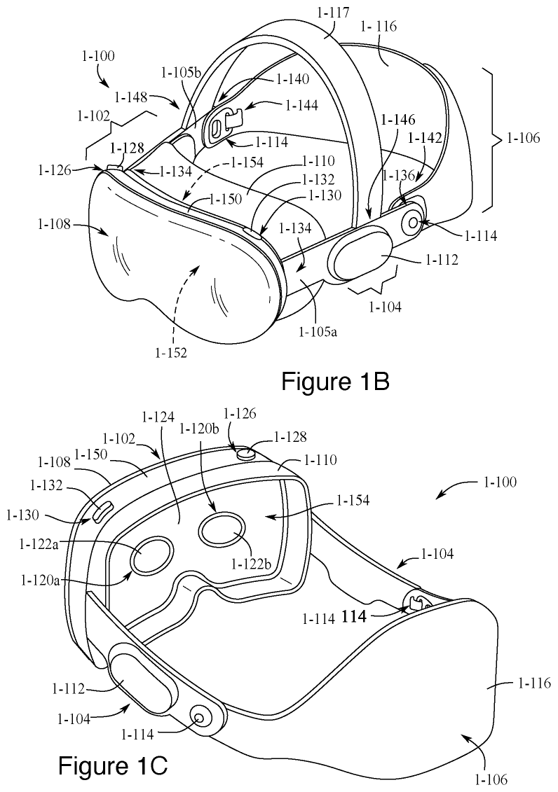

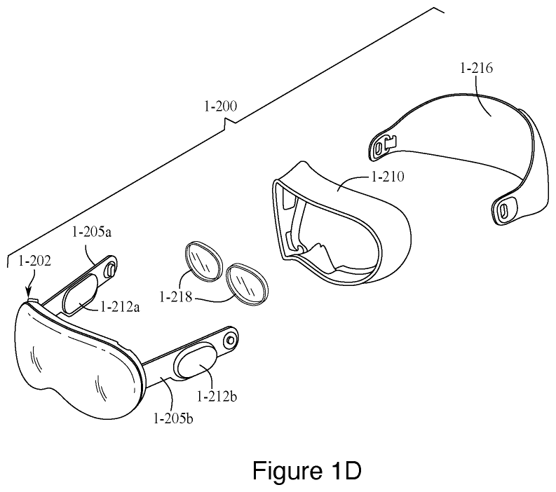

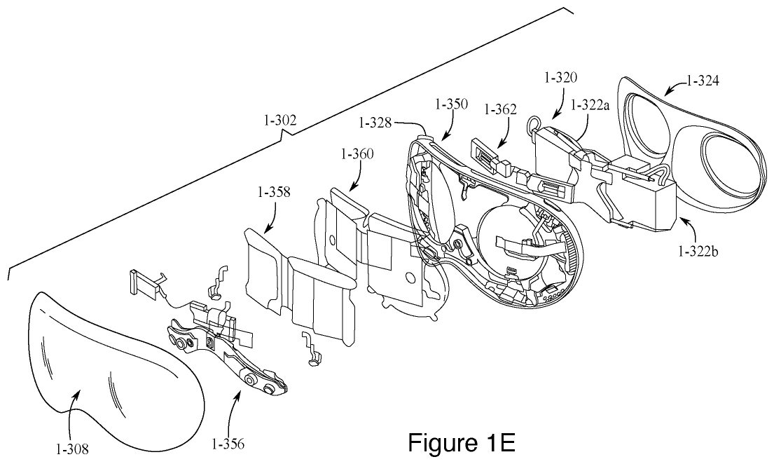

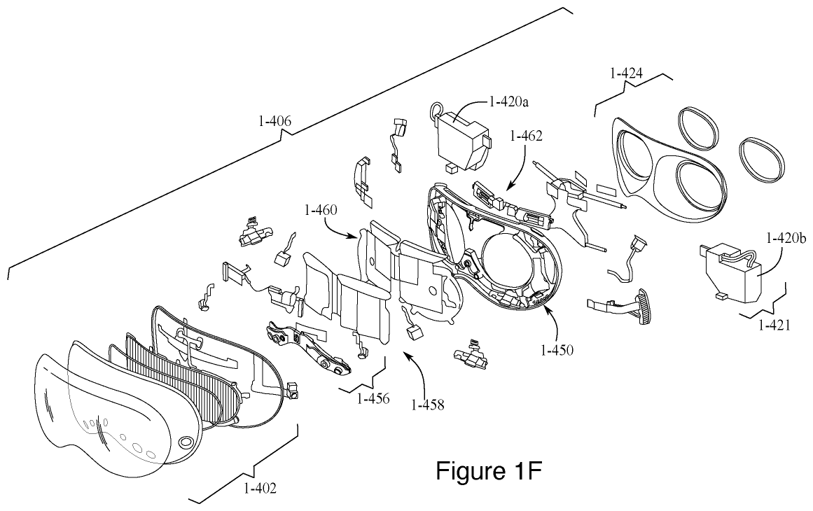

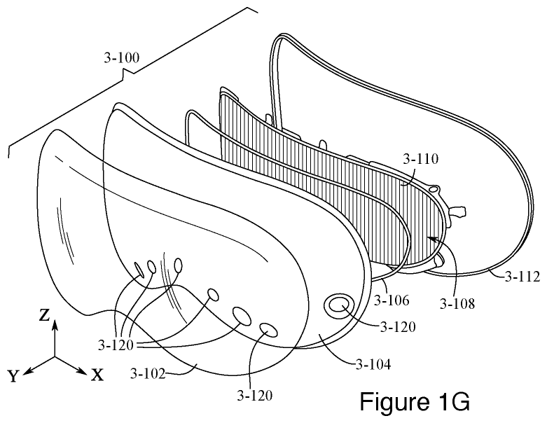

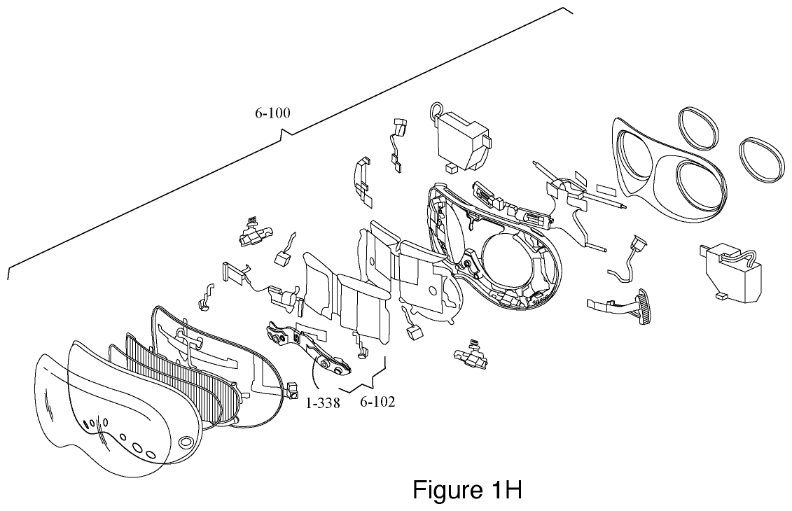

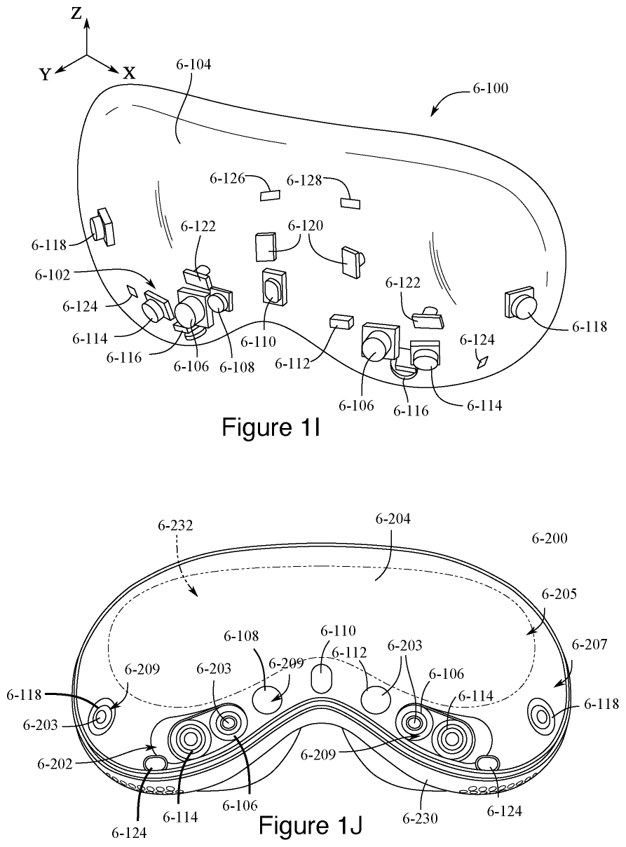

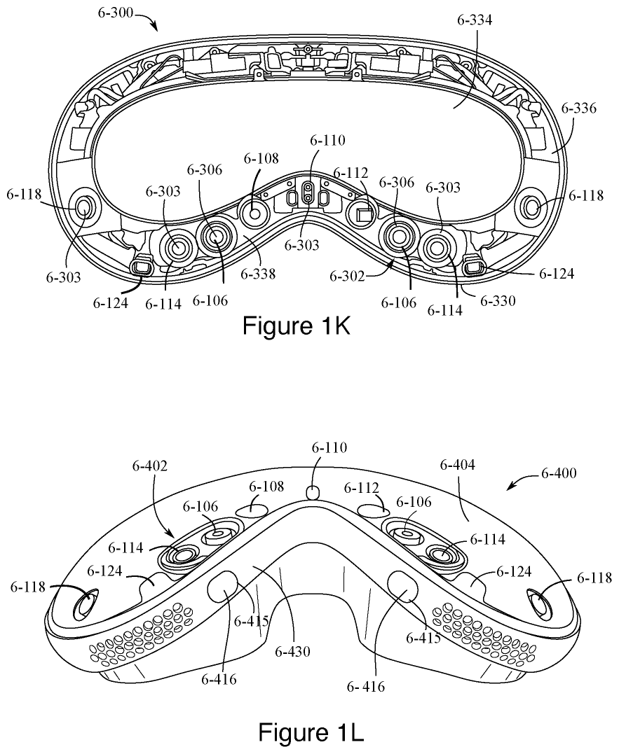

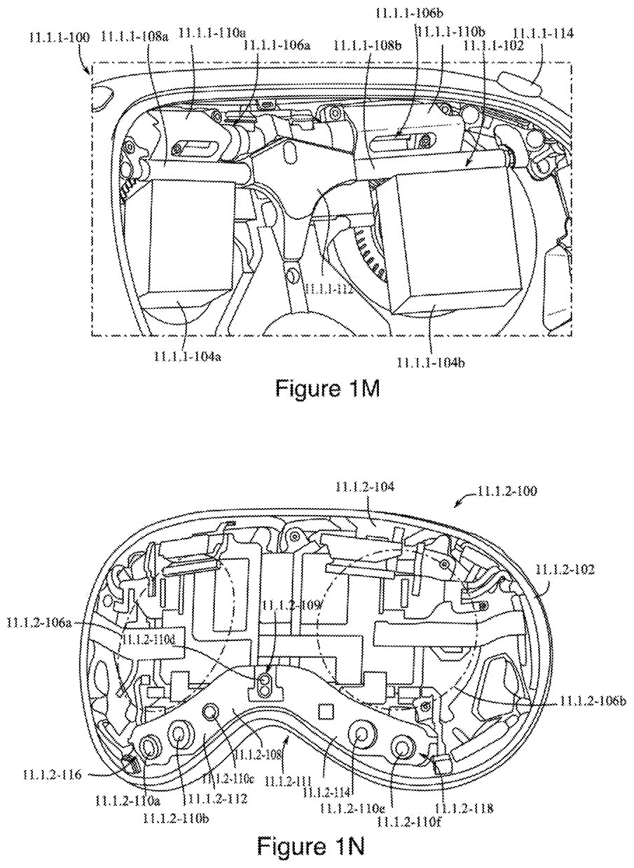

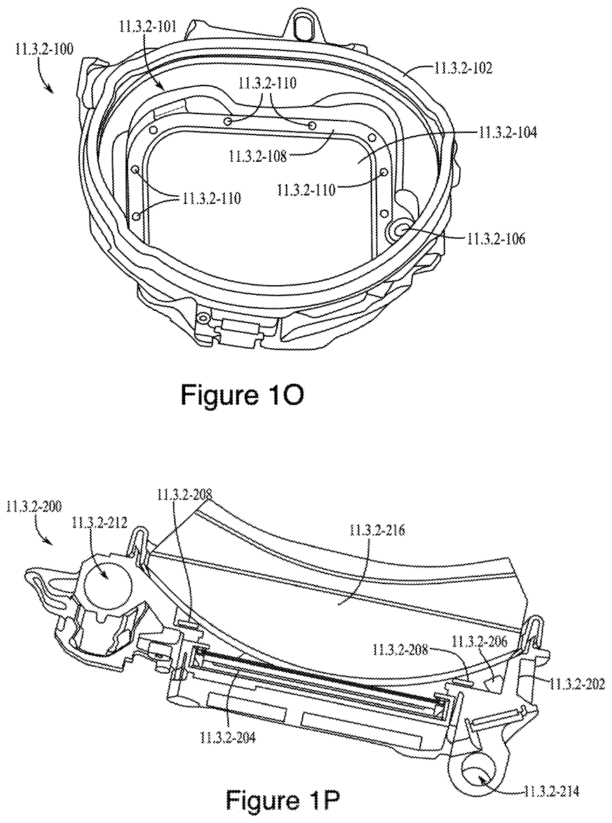

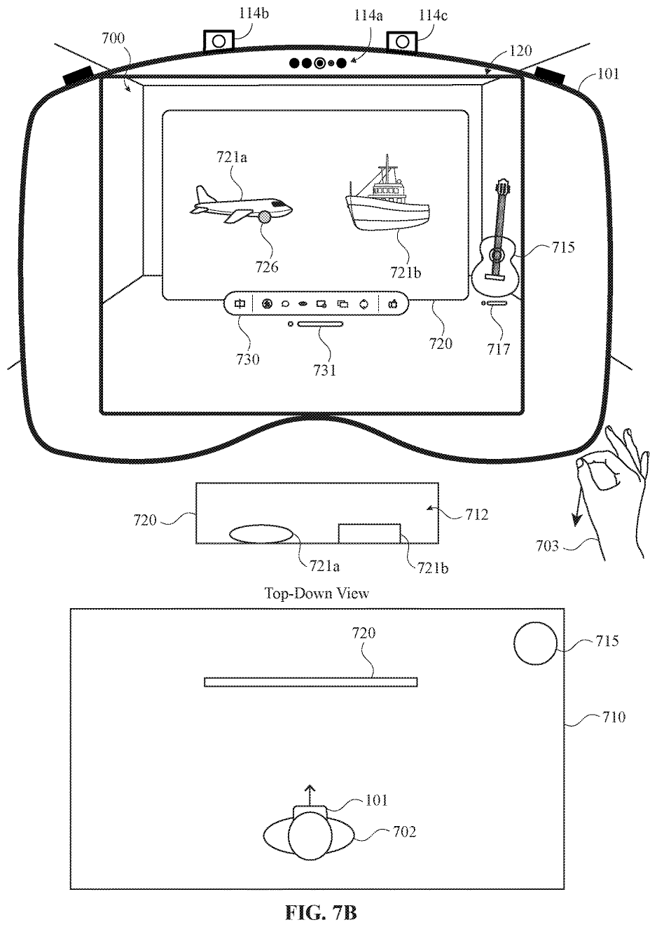

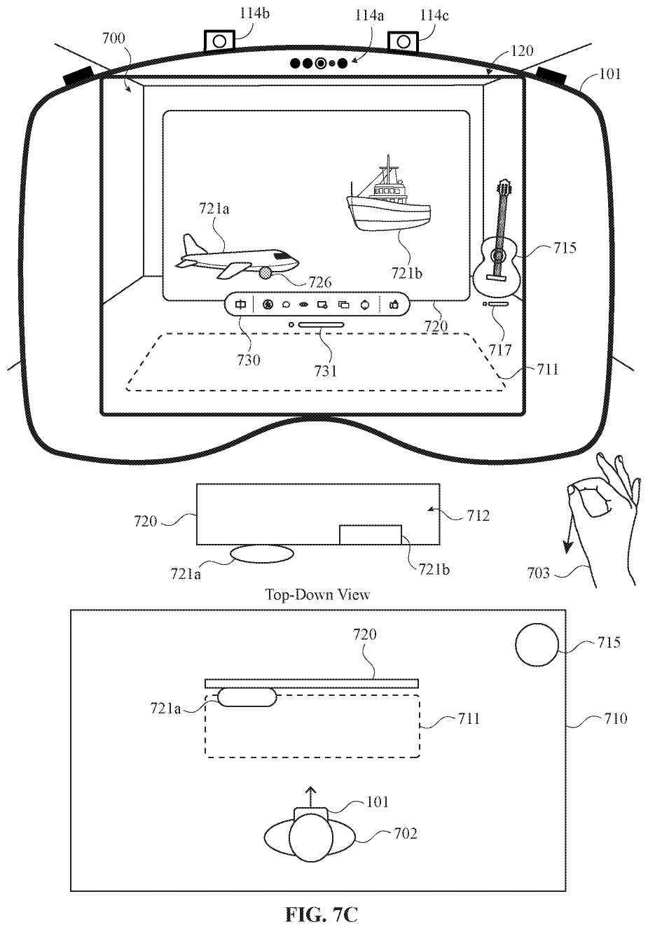

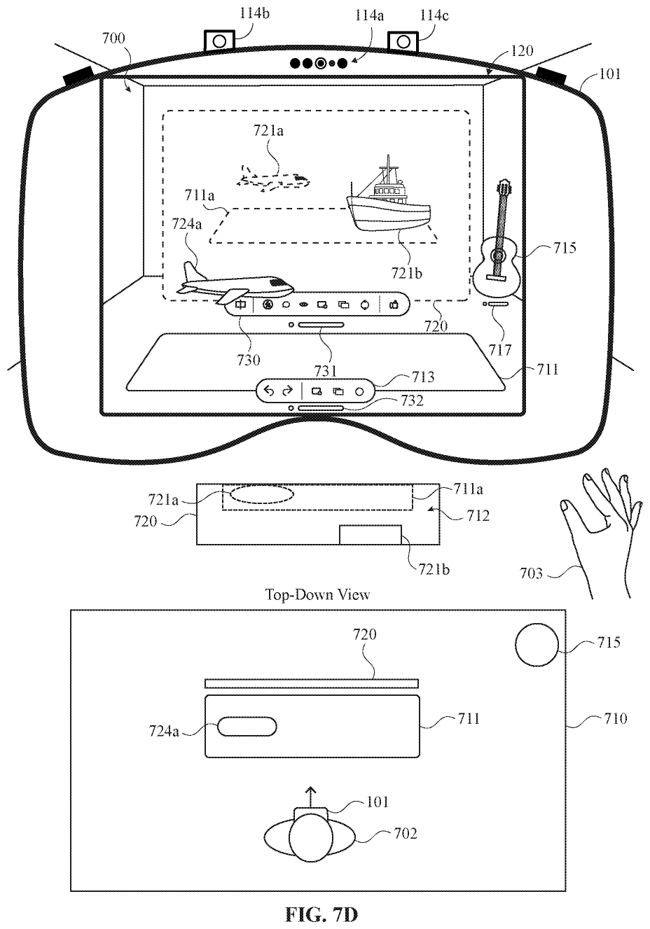

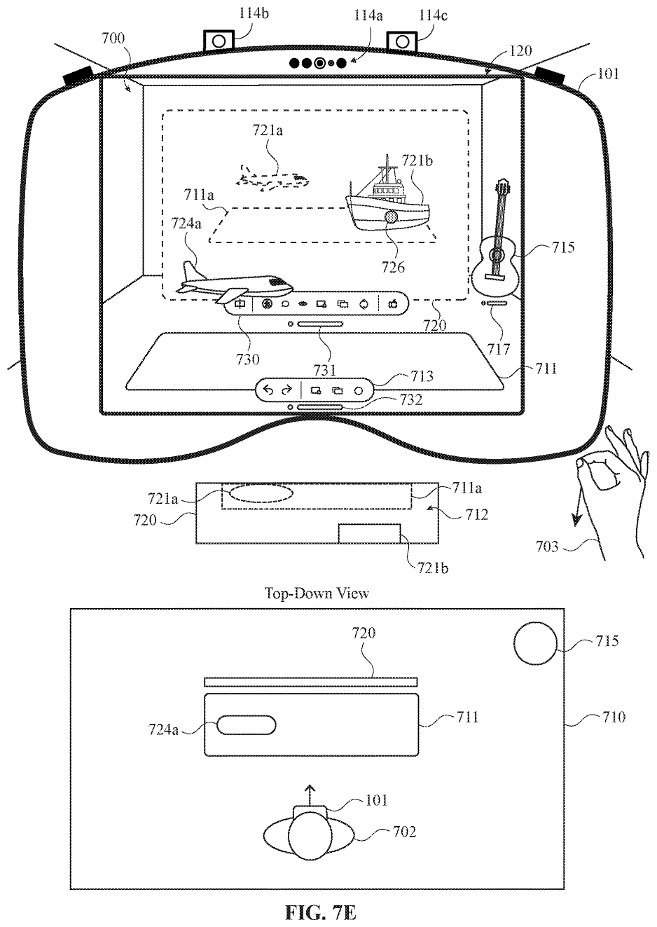

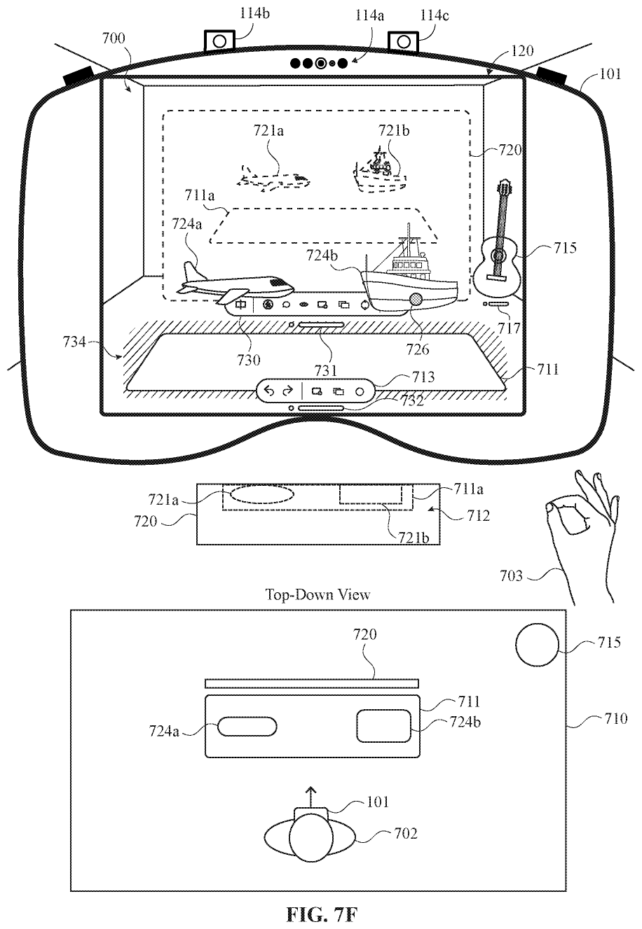

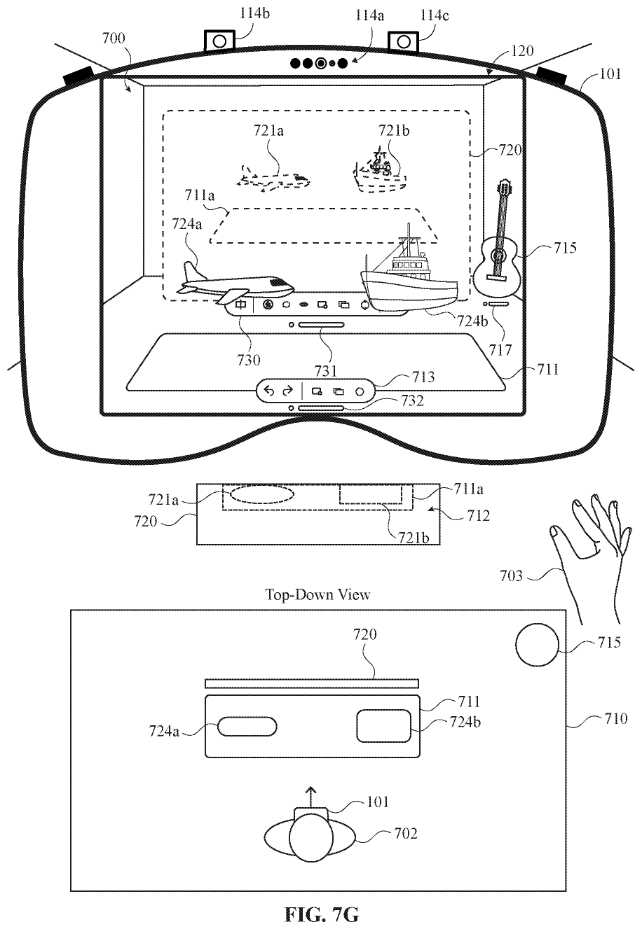

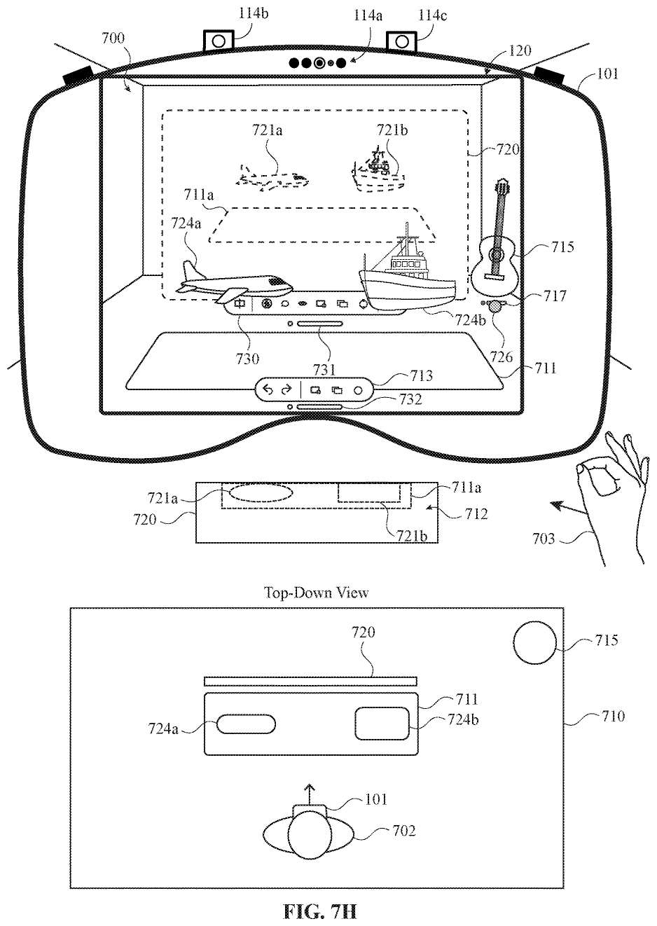

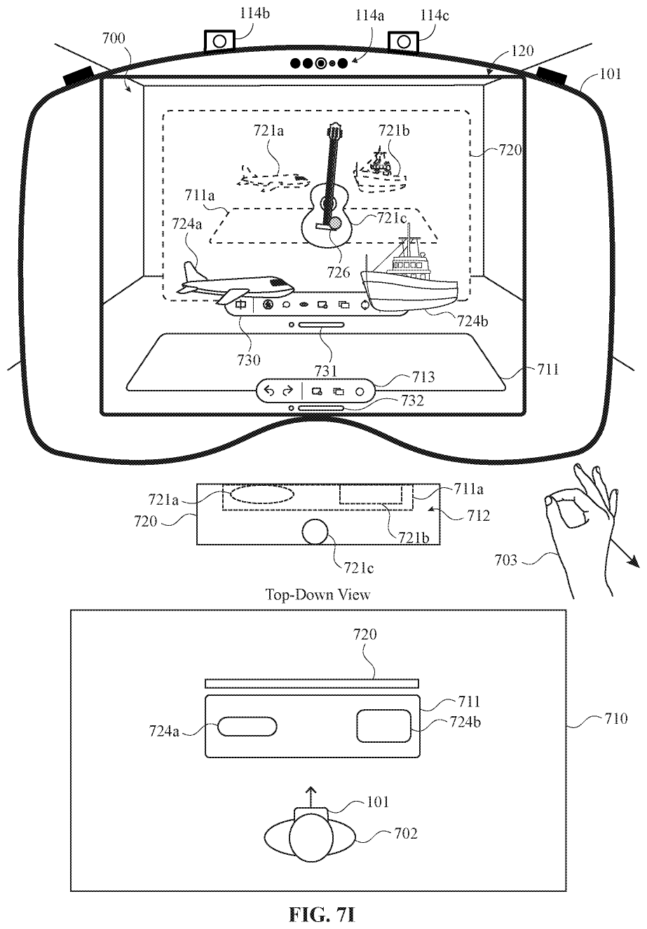

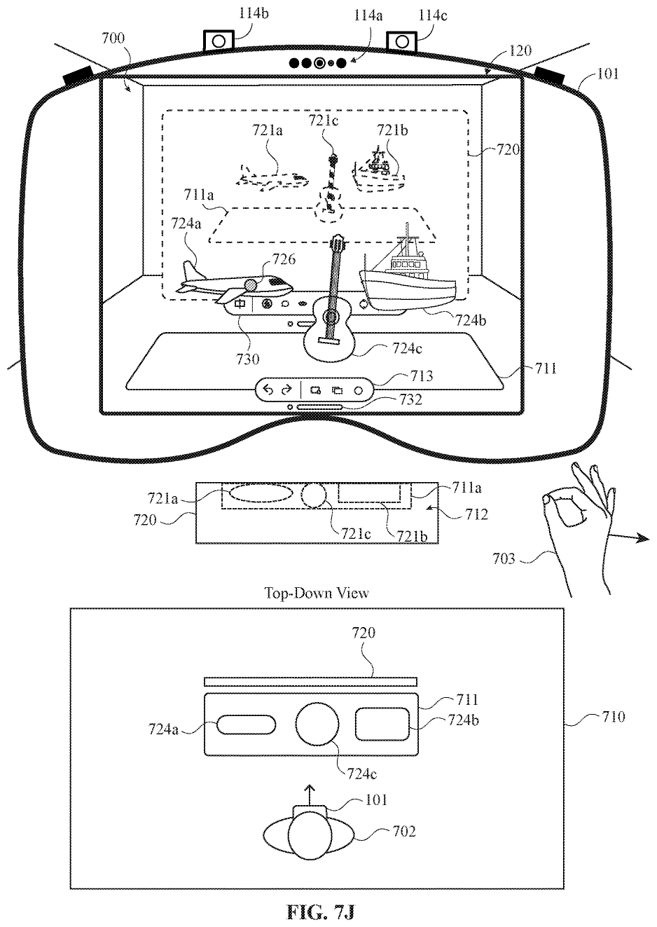

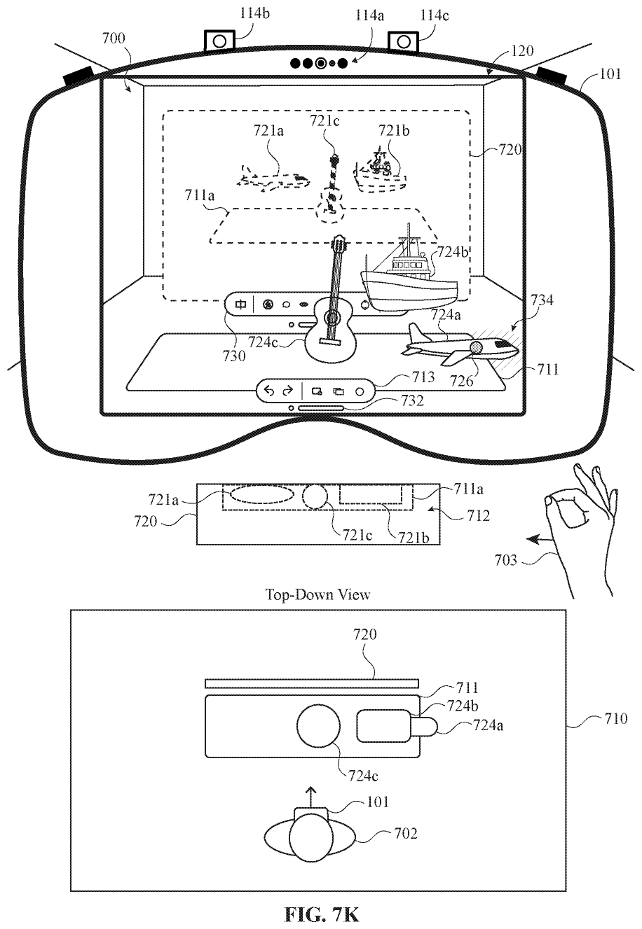

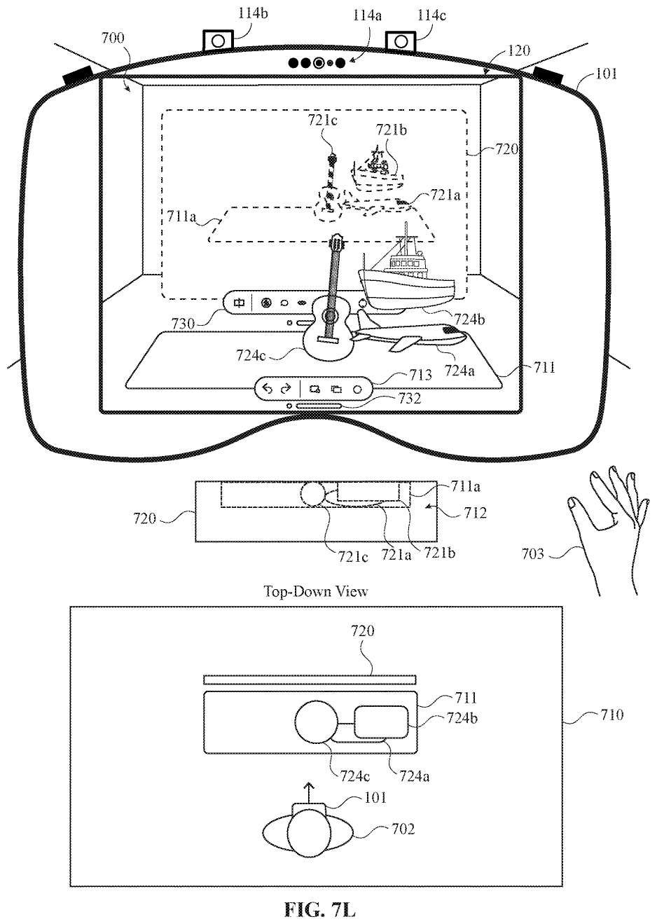

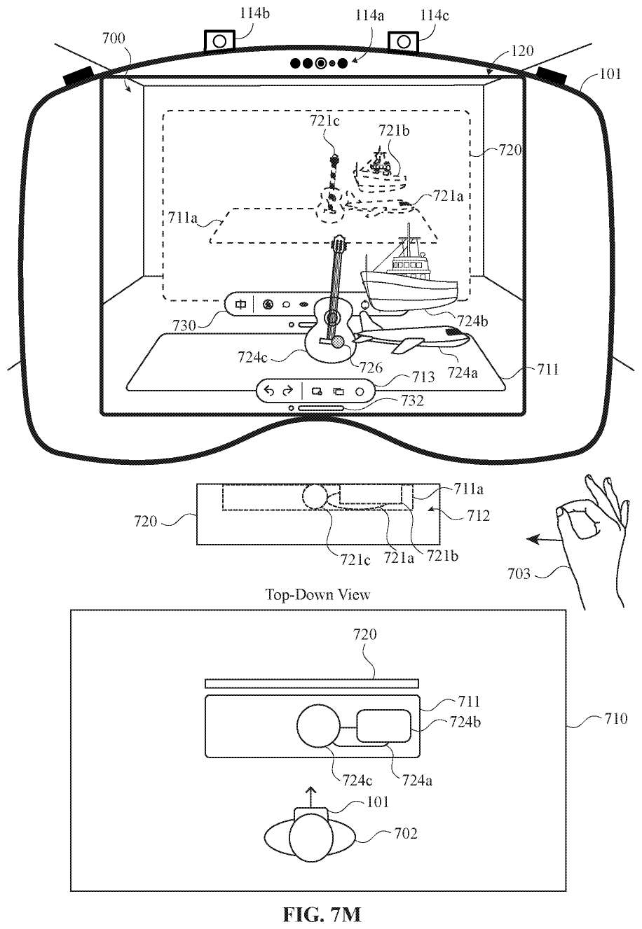

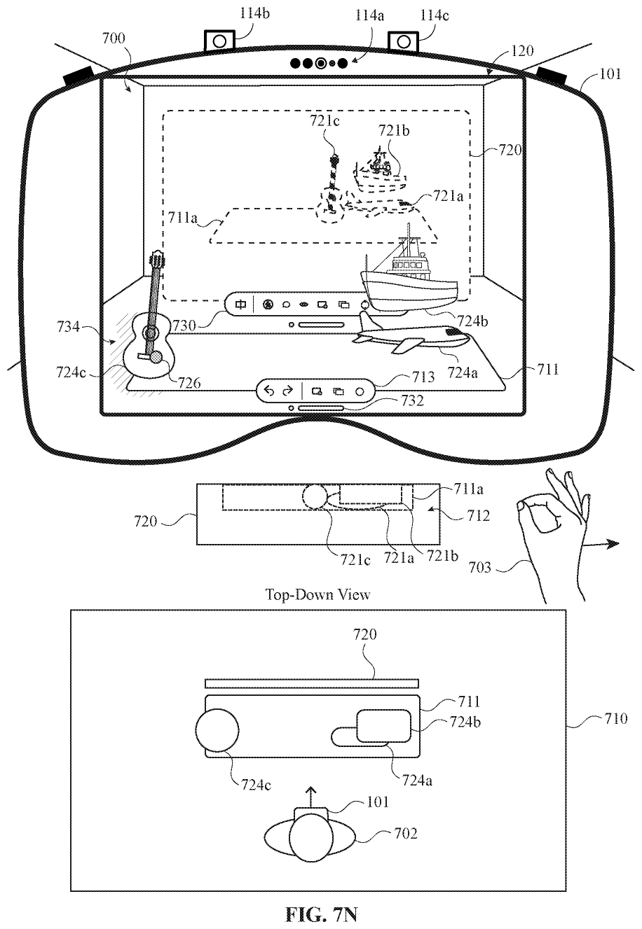

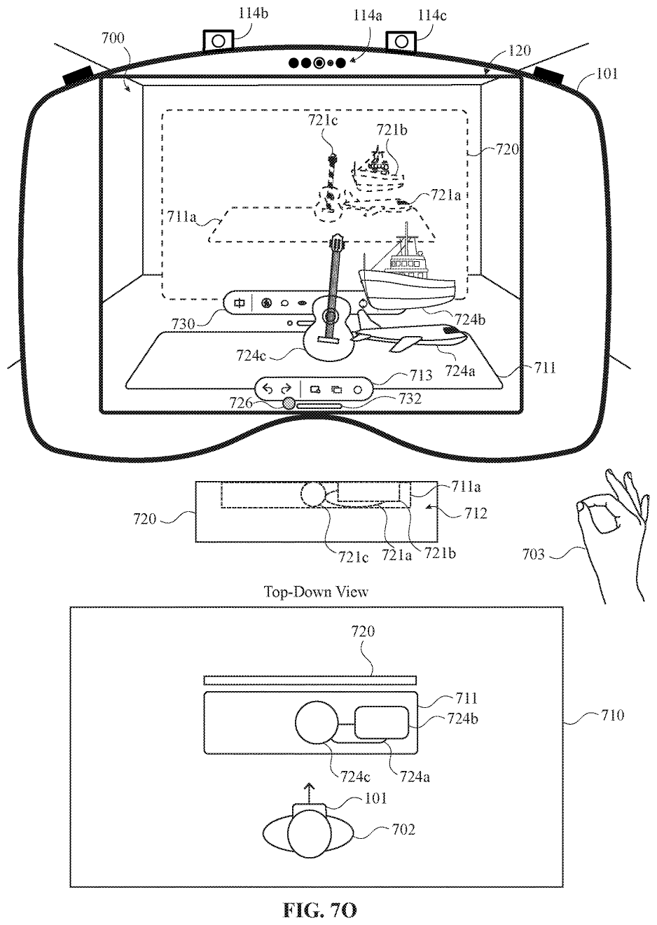

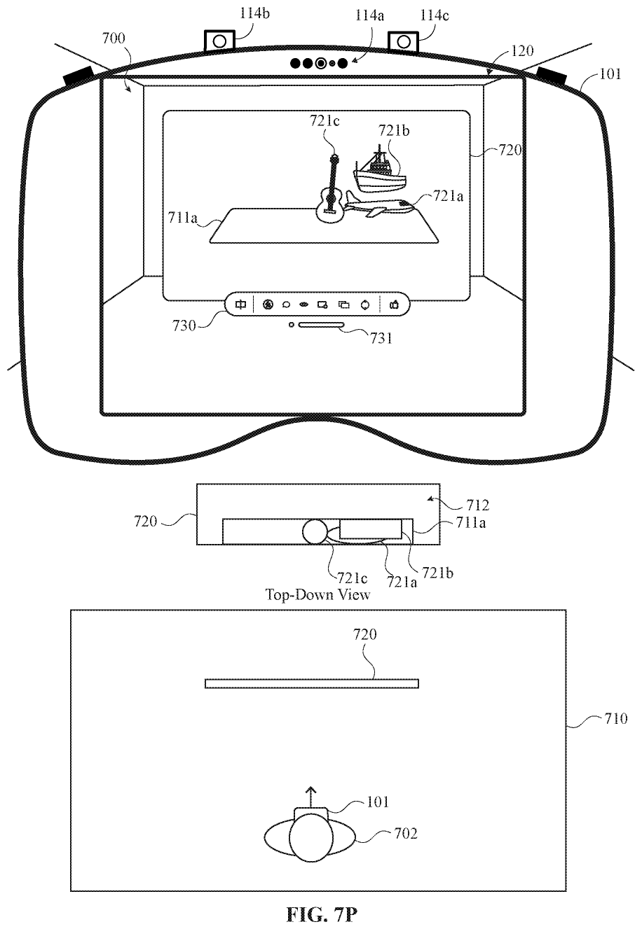

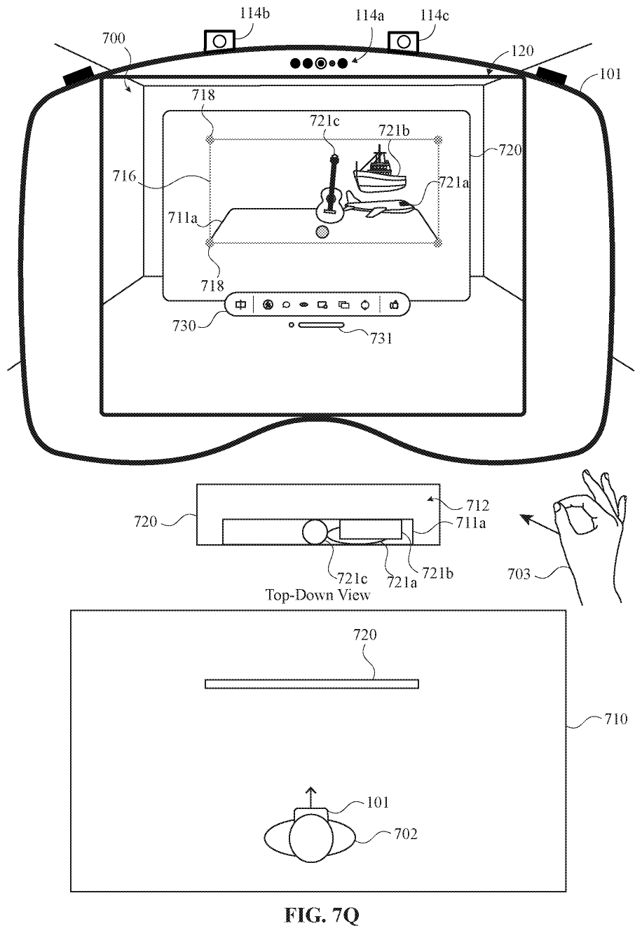

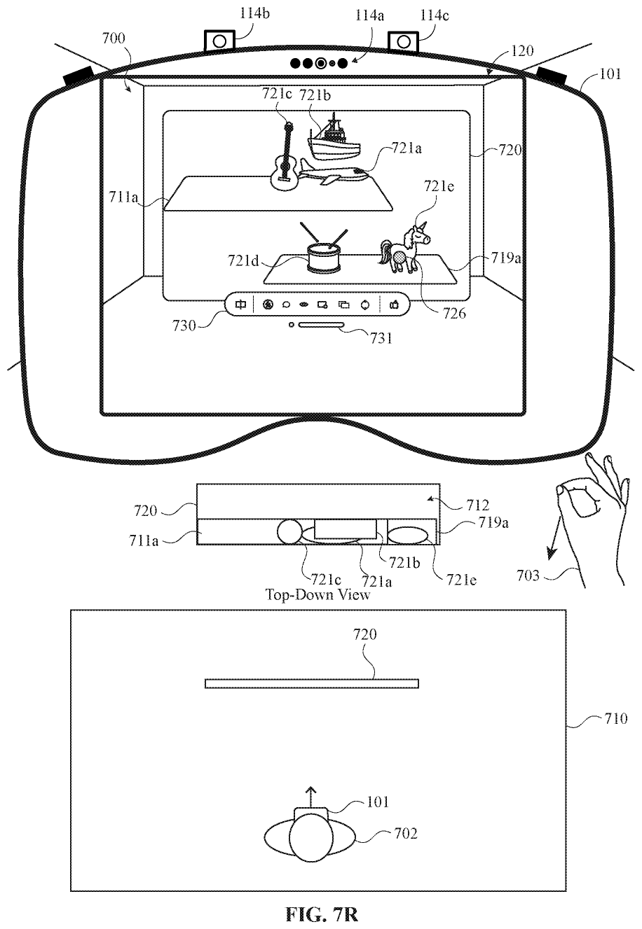

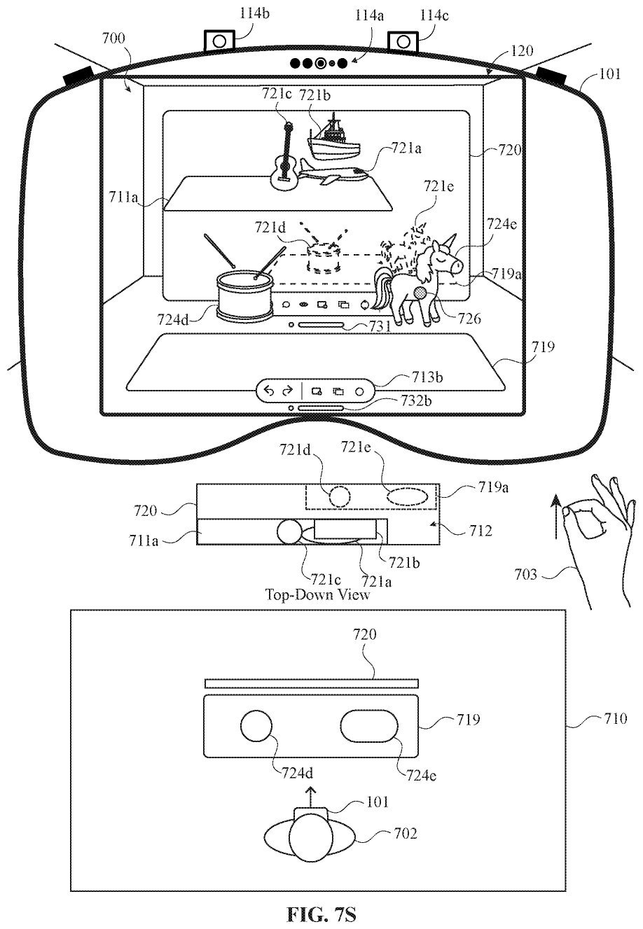

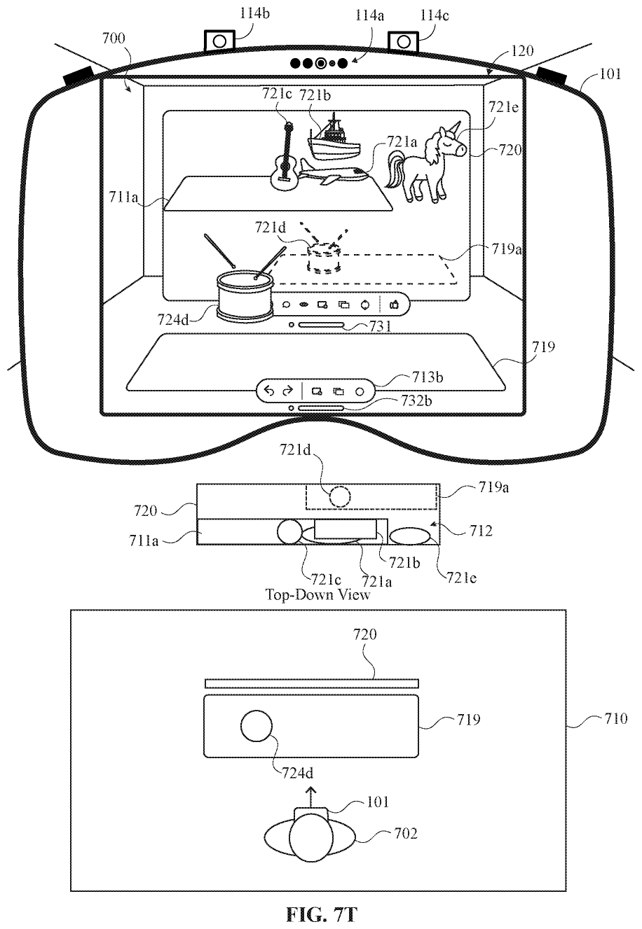

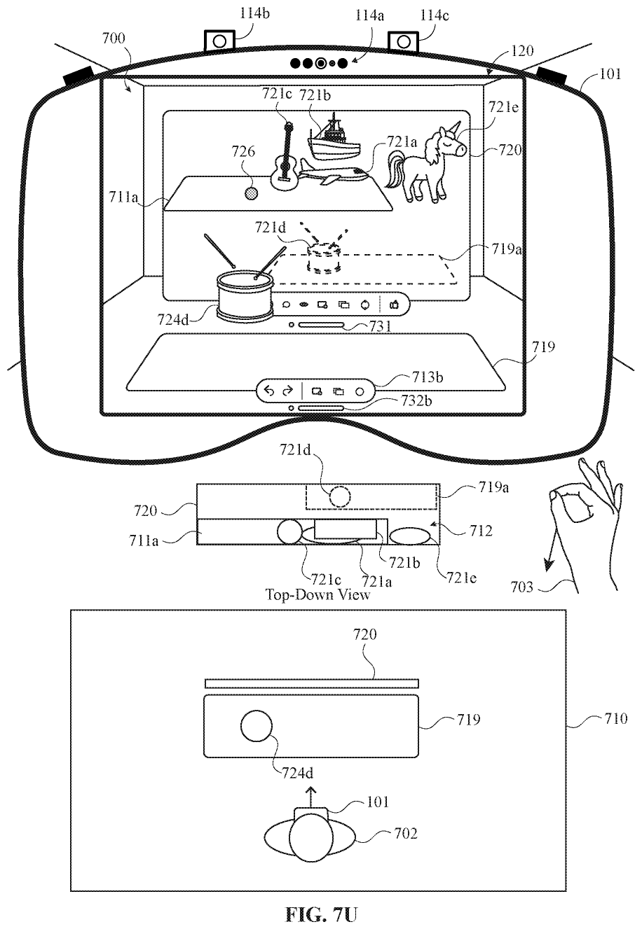

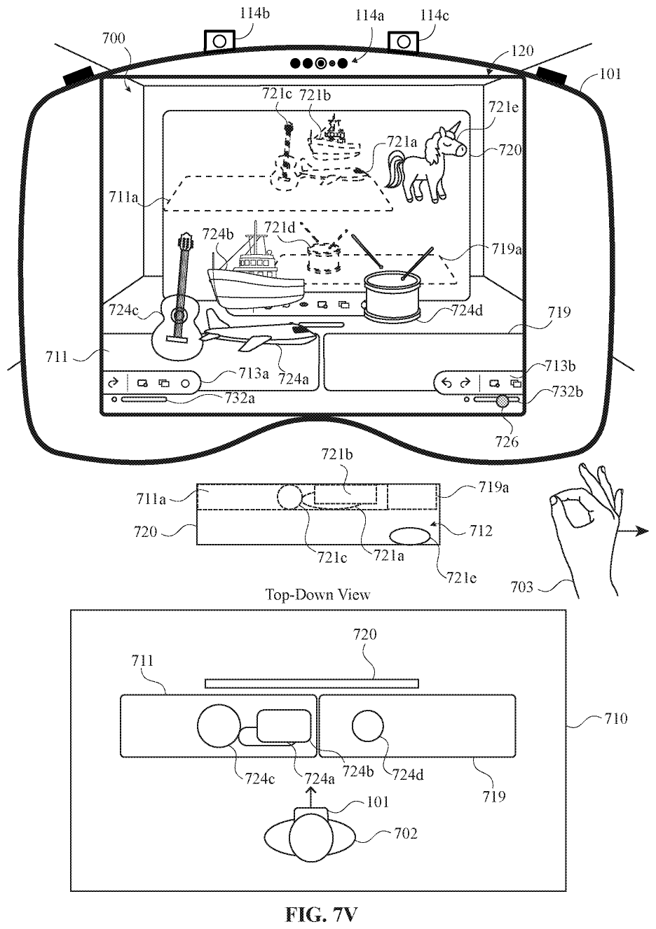

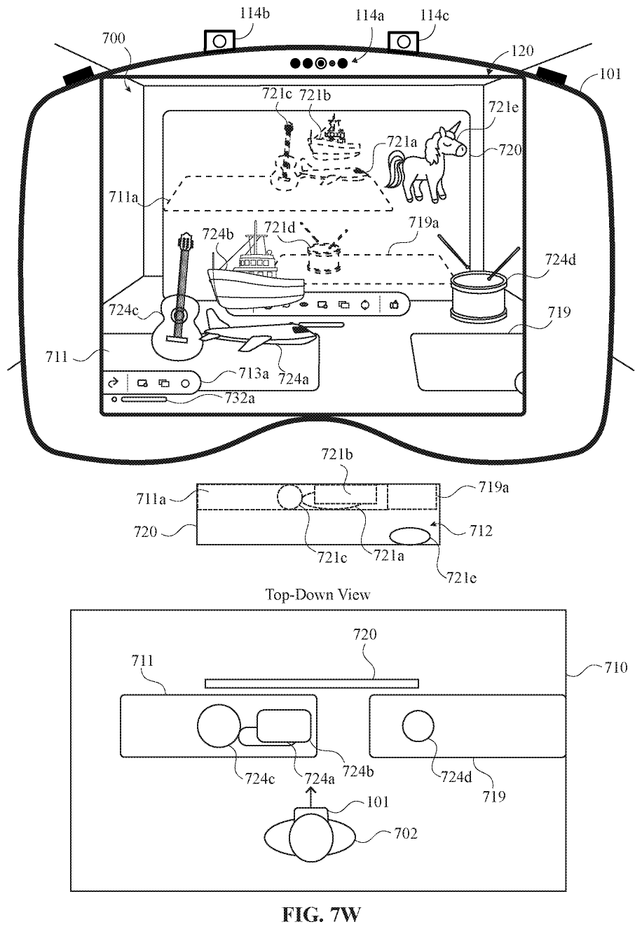

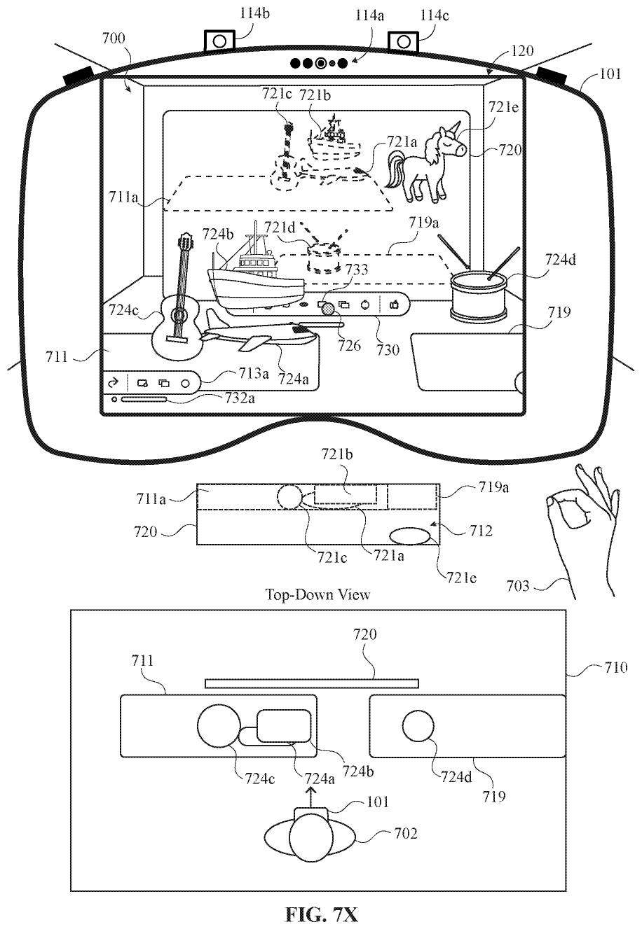

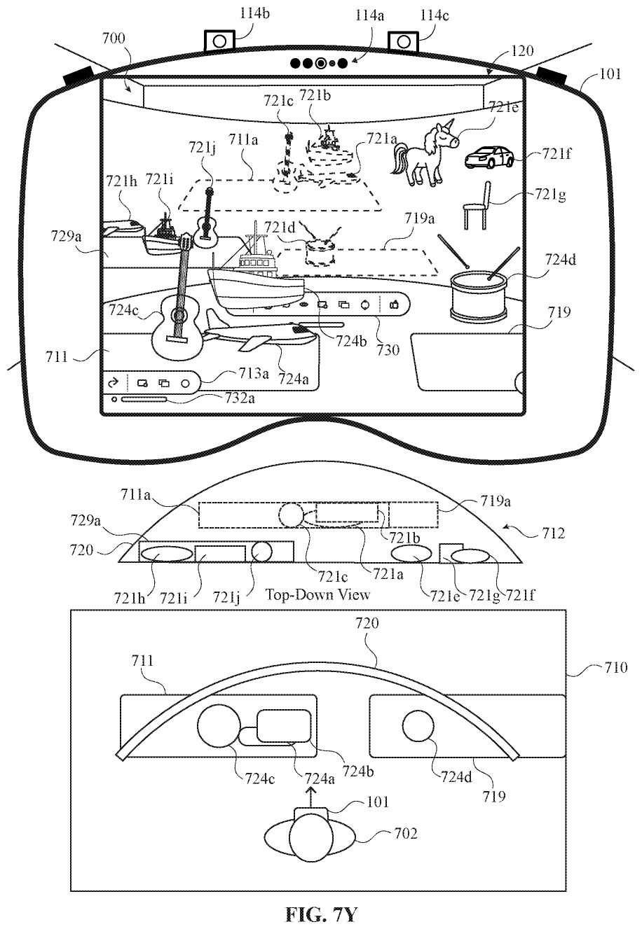

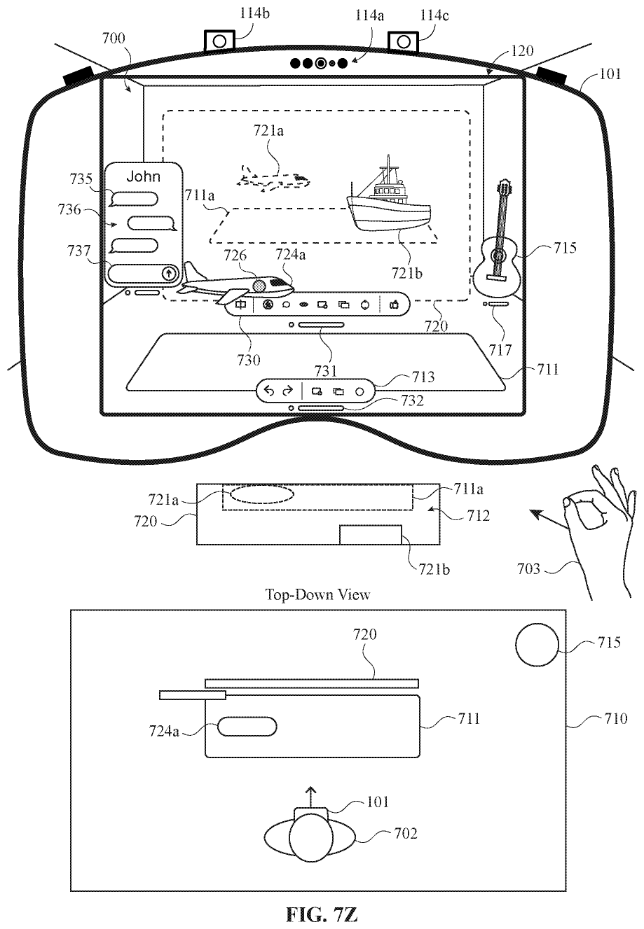

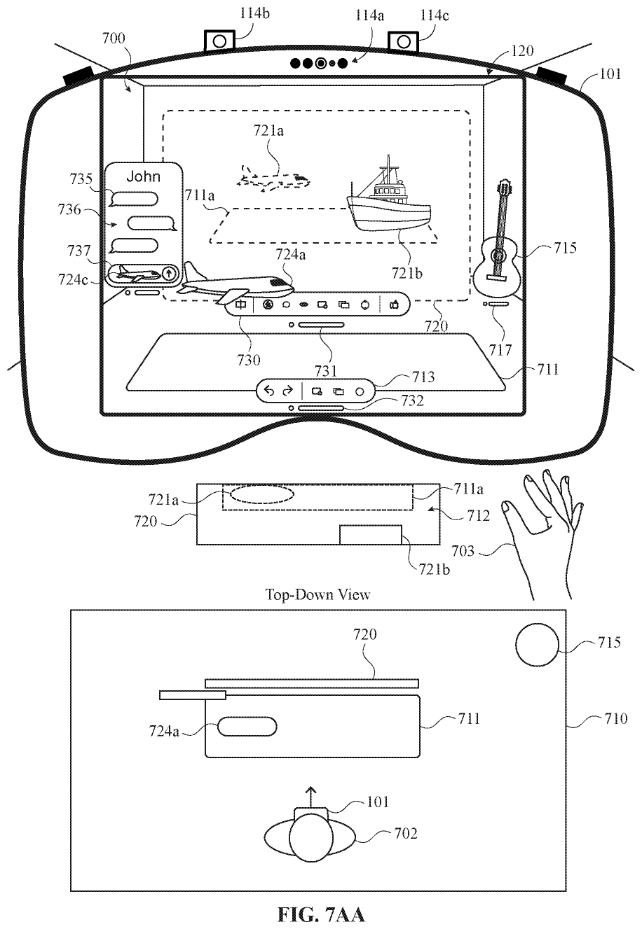

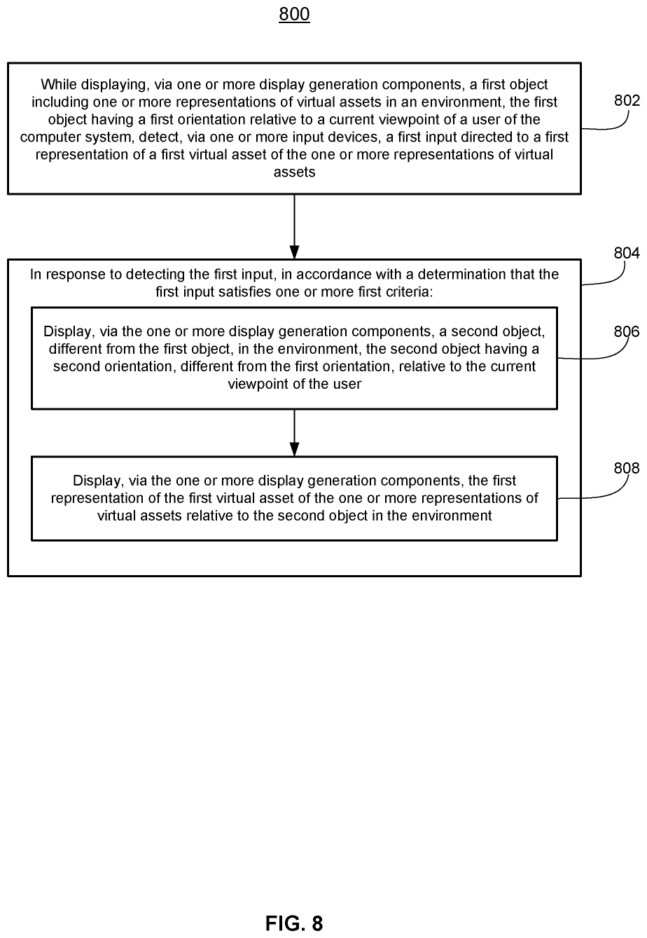

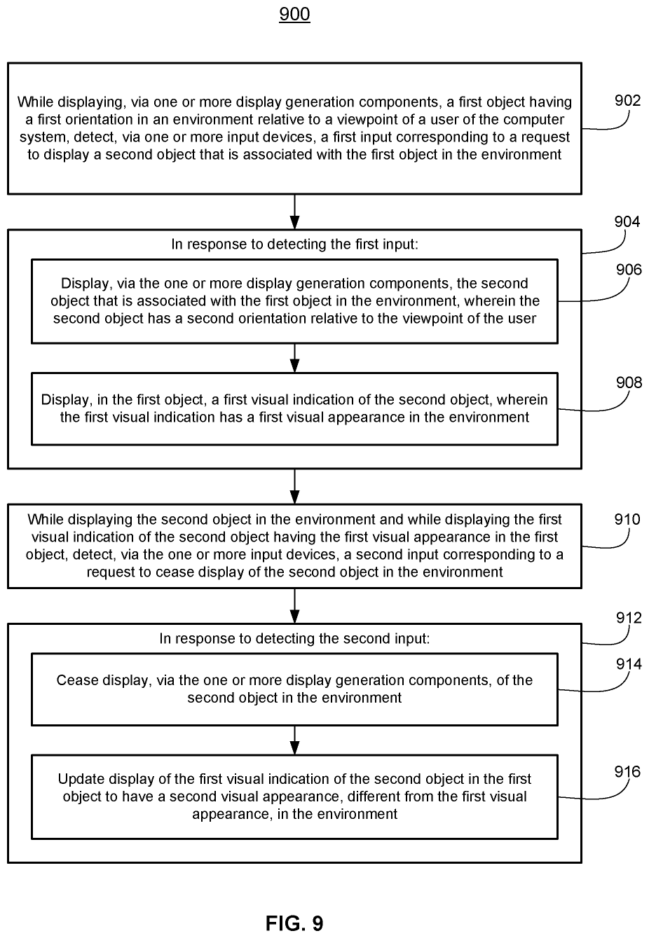

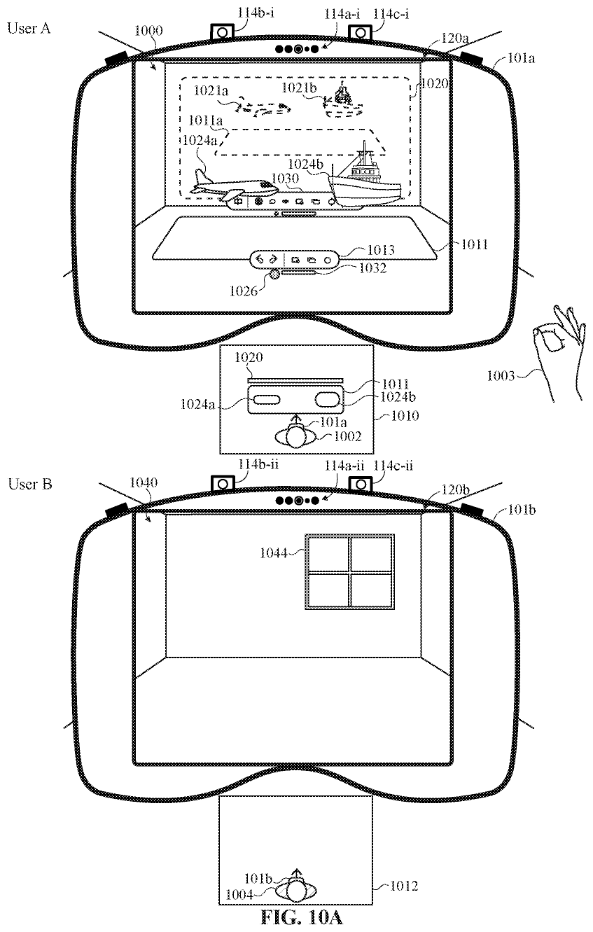

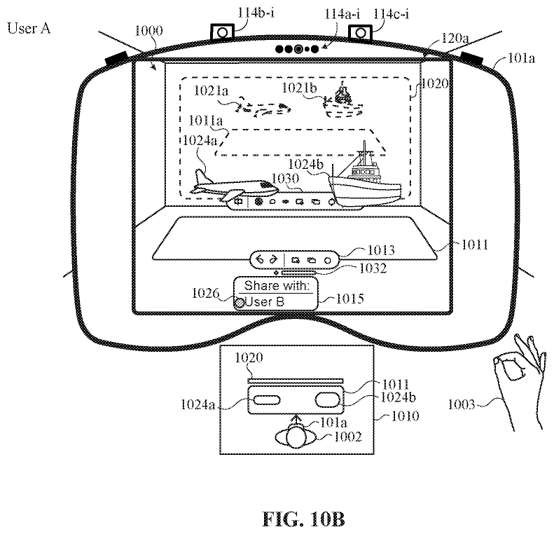

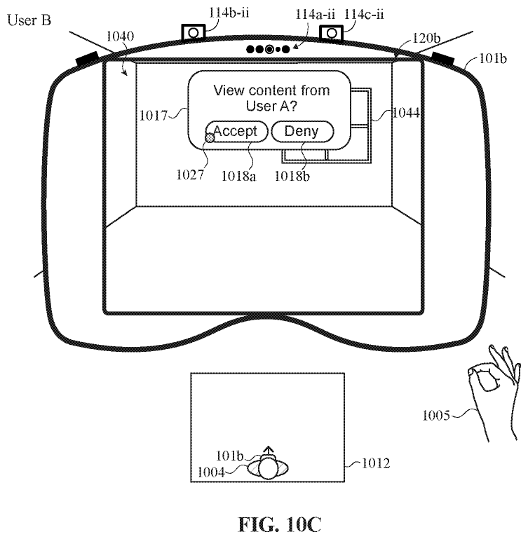

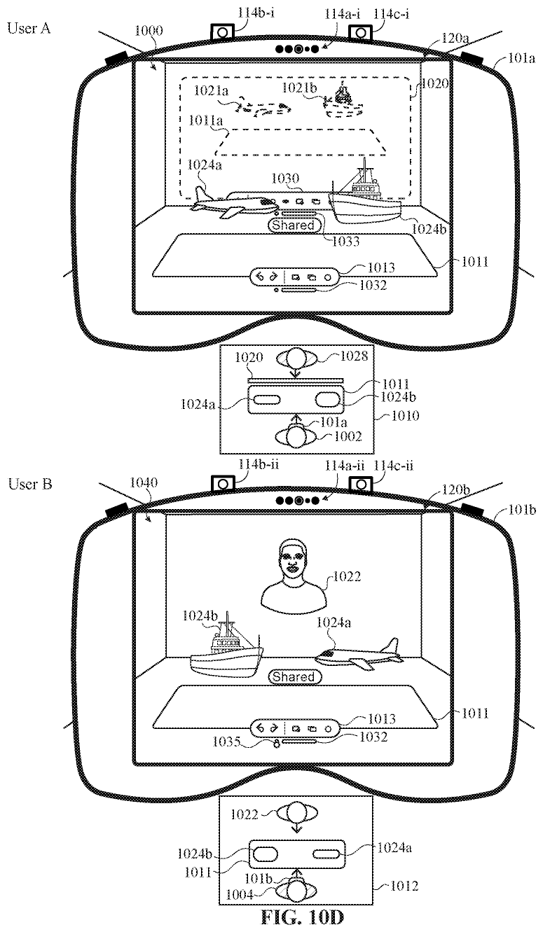

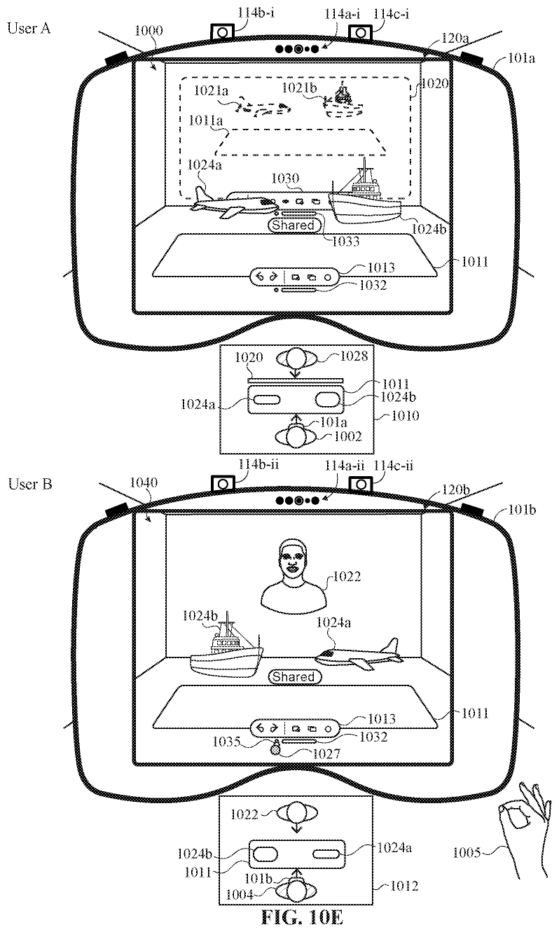

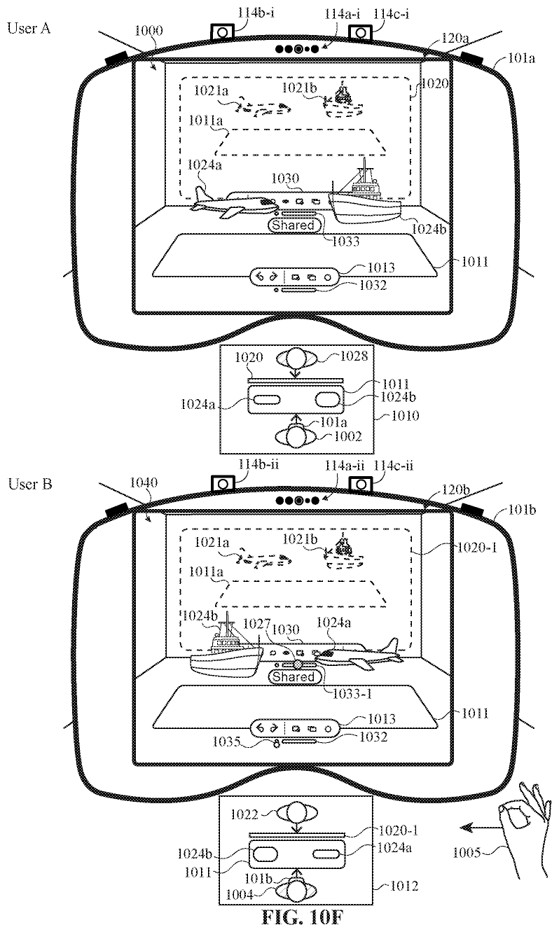

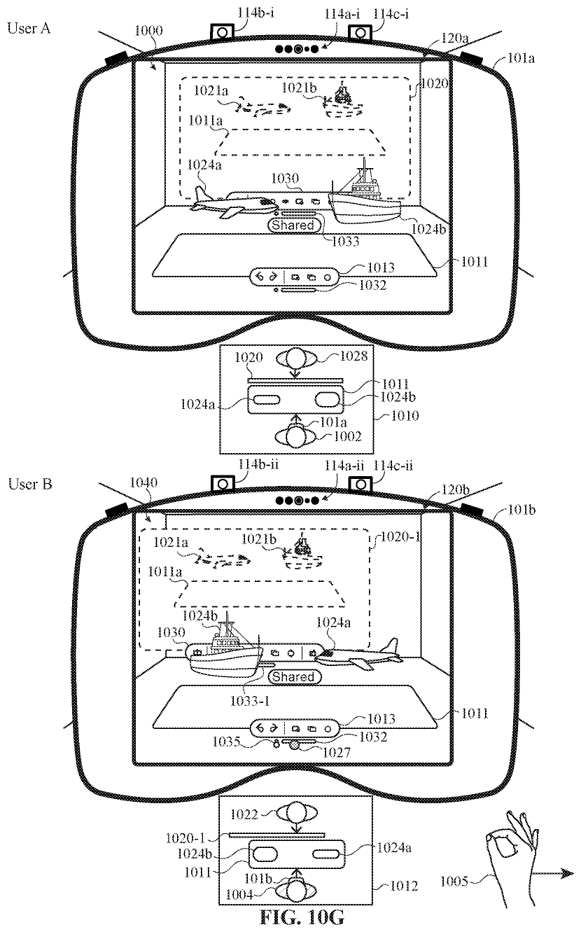

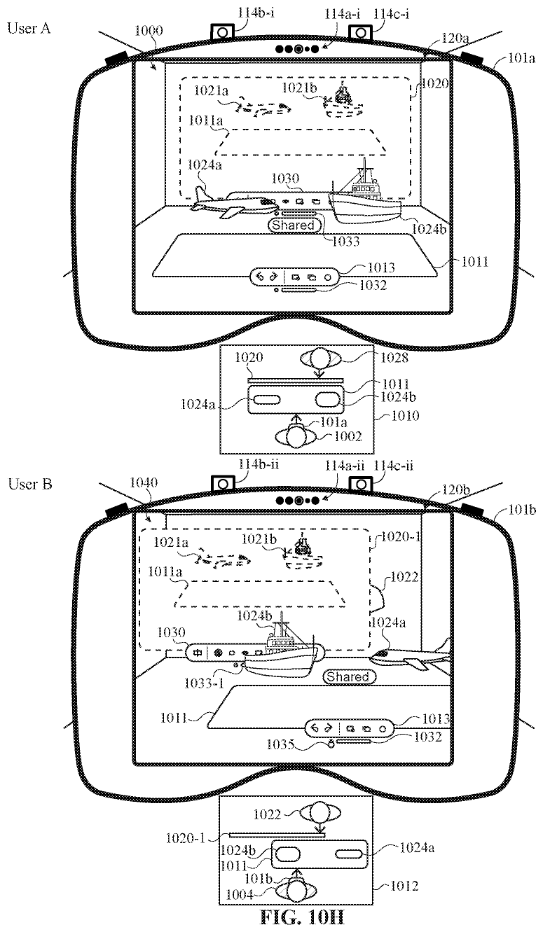

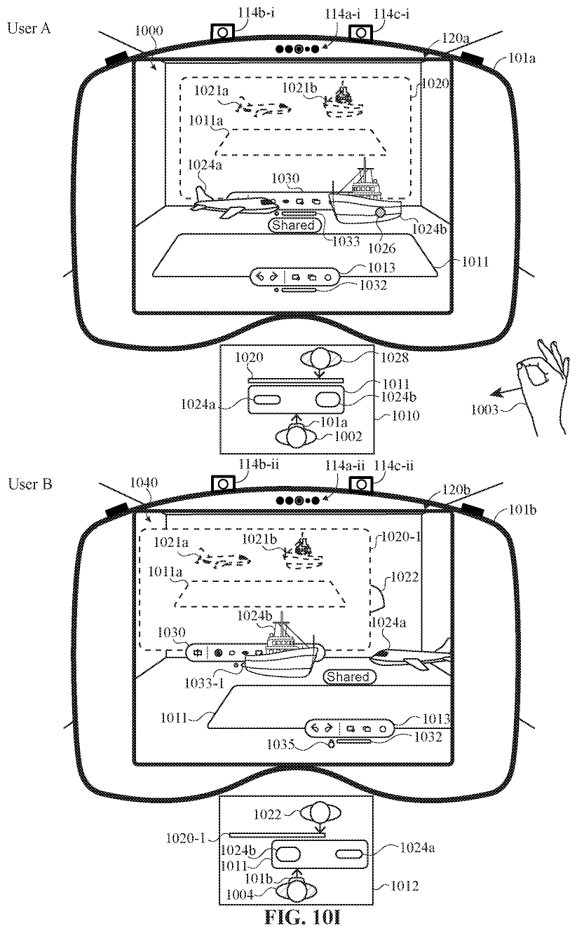

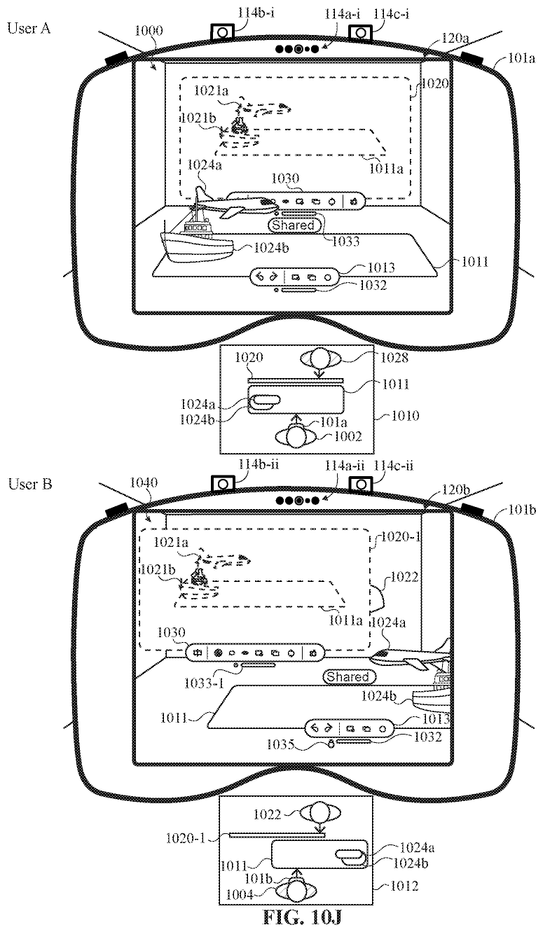

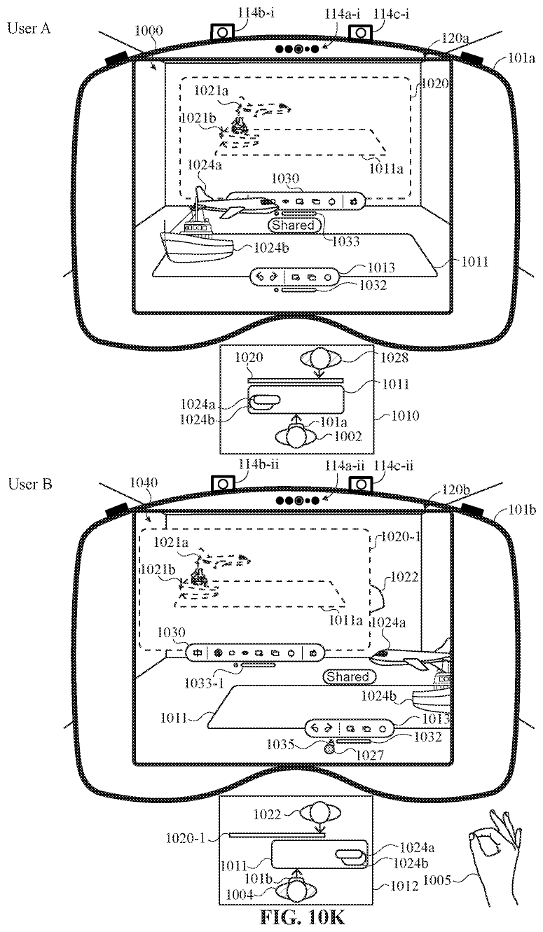

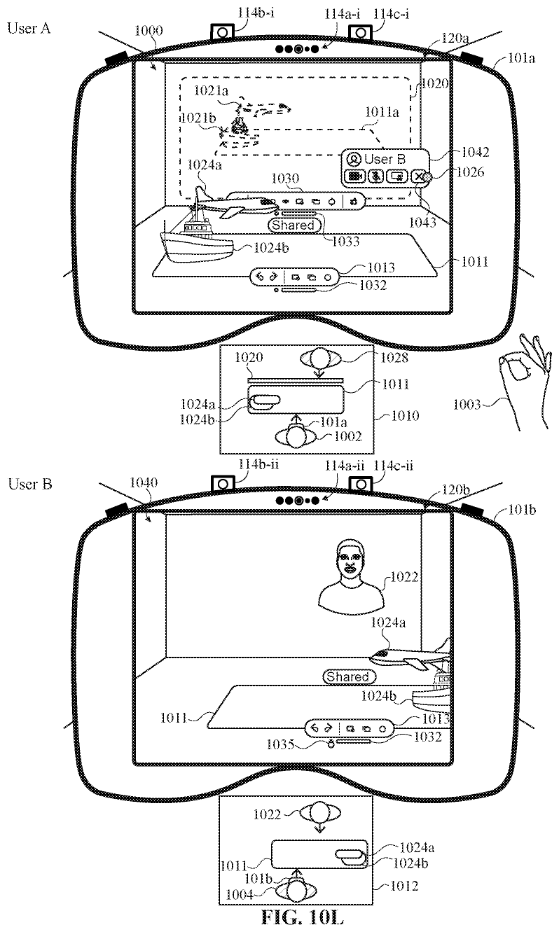

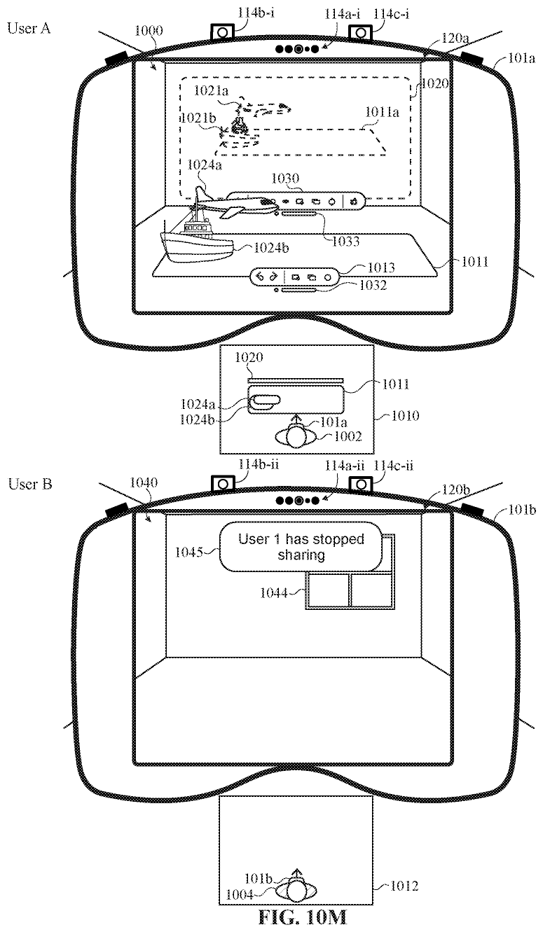

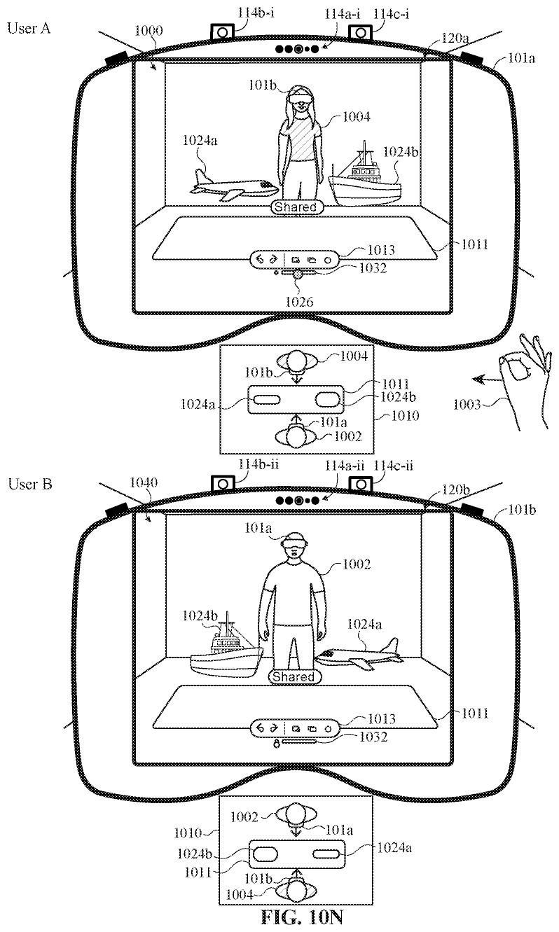

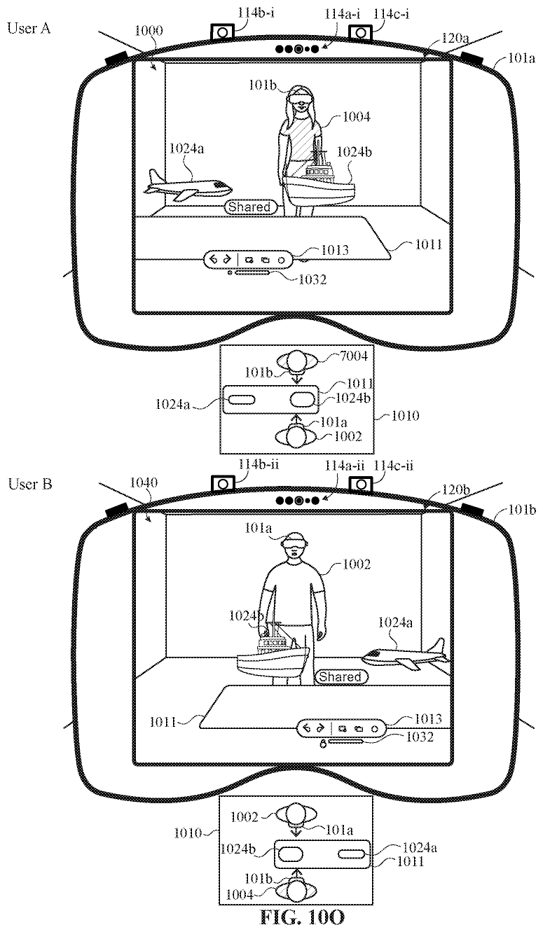

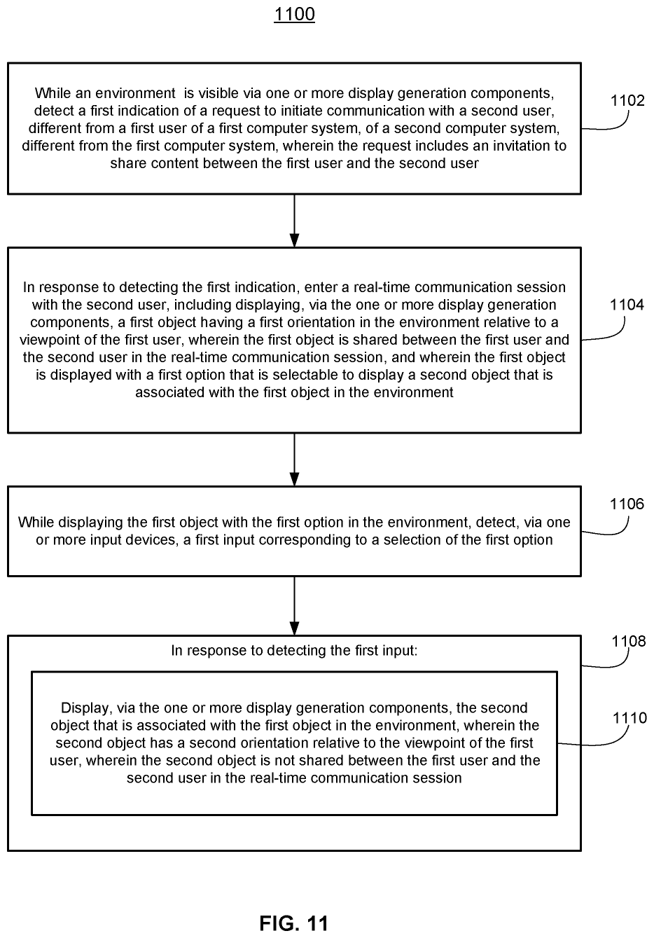

FIGS. 1A-6 provide a description of example computer systems for providing XR experiences to users (such as described below with respect to methods 800, 900 and/or 1100). FIGS. 7A-7AA illustrate examples of a computer system facilitating interactions with virtual assets associated with a virtual object in a three-dimensional environment in accordance with some embodiments. FIG. 8 is a flowchart illustrating an exemplary method of facilitating interactions with one or more virtual assets associated with a vertical virtual object in a three-dimensional environment, including adding the one or more virtual assets for display on a horizontal virtual object in the three-dimensional environment in accordance with some embodiments. The user interfaces in FIGS. 7A-7AA are used to illustrate the processes in FIG. 8. FIG. 9 is a flowchart of methods of facilitating changing a visual appearance of a horizontal virtual object within a vertical virtual object in a three-dimensional environment based on whether the horizontal virtual object and its content are open in the three-dimensional environment in accordance with some embodiments. The user interfaces in FIGS. 7A-7AA are used to illustrate the processes in FIG. 9. FIGS. 10A-100 illustrate examples of a first computer system facilitating shared interactions with virtual assets associated with a virtual object in a three-dimensional environment within a real-time communication session in accordance with some embodiments. FIG. 11 is a flowchart of methods of facilitating shared interactions with virtual assets associated with a virtual object in a three-dimensional environment within a real-time communication session in accordance with some embodiments. The user interfaces in FIGS. 10A-100 are used to illustrate the processes in FIG. 11.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects. Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground. Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an extended reality (e.g., augmented reality, mixed reality, or virtual reality) environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location and a direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments, a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments, a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments, the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

In some embodiments, spatial media includes spatial visual media and/or spatial audio. In some embodiments, a spatial capture is a capture of spatial media. In some embodiments, spatial visual media (also referred to as stereoscopic media) (e.g., a spatial image and/or a spatial video) is media that includes two different images or sets of images, representing two perspectives of the same or overlapping fields-of-view, for concurrent display. A first image representing a first perspective is presented to a first eye of the viewer and a second image representing a second perspective, different from the first perspective, is concurrently presented to a second eye of the viewer. The first image and the second image have the same or overlapping fields-of-view. In some embodiments, a computer system displays the first image via a first display that is positioned for viewing by the first eye of the viewer and concurrently displays the second image via a second display, different from the first display, that is positioned for viewing by the second eye of the viewer. In some embodiments, the first image and the second image, when viewed together, create a depth effect and provide the viewer with depth perception for the contents of the images. In some embodiments, a first video representing a first perspective is presented to a first eye of the viewer and a second video representing a second perspective, different from the first perspective, is concurrently presented to a second eye of the viewer. The first video and the second video have the same or overlapping fields-of-view. In some embodiments, the first video and the second video, when viewed together, create a depth effect and provide the viewer with depth perception for the contents of the videos. In some embodiments, spatial audio experiences in headphones are produced by manipulating sounds in the headphones' two audio channels (e.g., left and right) so that they resemble directional sounds arriving in the ear-canal. For example, the headphones can reproduce a spatial audio signal that simulates a soundscape around the listener (also referred to as the user). An effective spatial sound reproduction can render sounds such that the listener perceives the sound as coming from a location within the soundscape external to the listener's head, just as the listener would experience the sound if encountered in the real world.

The geometry of the listener's ear, and in particular the outer ear (pinna), has a significant effect on the sound that arrives from a sound source to a listener's eardrum. The spatial audio sound experience is possible by taking into account the effect of the listener's pinna, the listener's head, and/or the listener's torso to the sound that enters the listener's ear-canal. The geometry of the user's ear is optionally determined by using a three-dimensional scanning device that produces a three-dimensional model of at least a portion of the visible parts of the user's ear. This geometry is optionally used to produce a filter for producing the spatial audio experience. In some embodiments, spatial audio is audio that has been filtered such that a listener of the audio perceives the audio as coming from one or more directions and/or locations in three-dimensional space (e.g., from above, below, and/or in front of the listener).

An example of such a filter is a Head-Related Transfer Function (HRTF) filter. These filters are used to provide an effect that is similar to how a human ear, head, and torso filter sounds. When the geometry of the ears of a listener is known, a personalized filter (e.g., a personalized HRTF filter) can be produced so that the sound experienced by that listener through headphones (e.g., in-ear headphones, on-ear headphones, and/or over-ear headphones) is more realistic. In some embodiments, two filters are produced-one filter per ear-so that each ear of the listener has a corresponding personalized filter (e.g., personalized HRTF filter), as the ears of the listener can be of different geometry. In some embodiments, an HRTF filter includes some (or all) acoustic information required to describe how sound reflects or diffracts around a listener's head before entering the listener's auditory system. In some embodiments, a personalized HRTF filter is selected from a database of previously determined HRTFs for users having similar anatomical characteristics. In some embodiments, a personalized HRTF filter is generated by numerical modeling based on the geometry of the listener's ear. One or more processors of the computer system optionally apply the personalized HRTF filter for the listener to an audio input signal to generate a spatial input signal for playback by headphones that are connected (e.g., wirelessly or by wire) to the computer system.

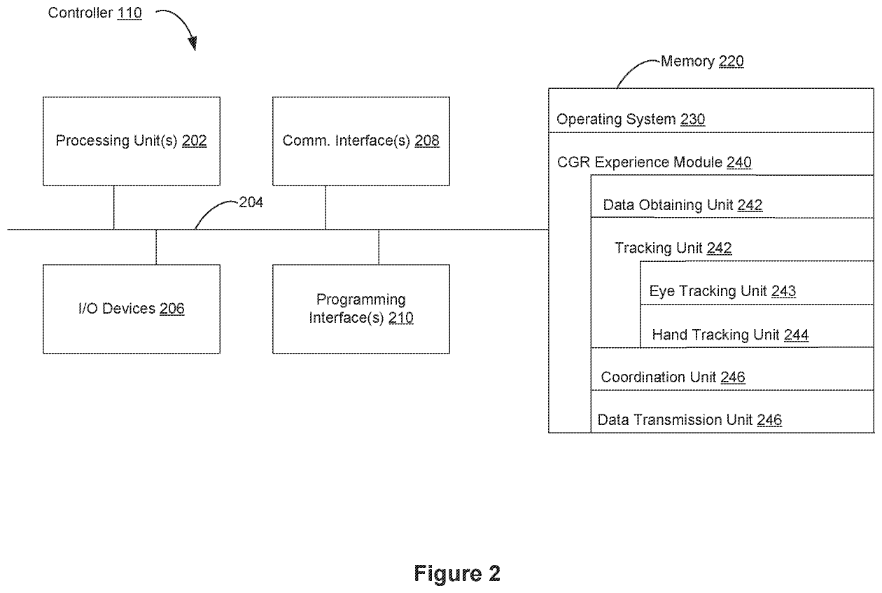

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, organic light-emitting diodes (OLEDs), light-emitting diodes (LEDs), micro-LEDs (μLEDs), liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BlueTooth, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

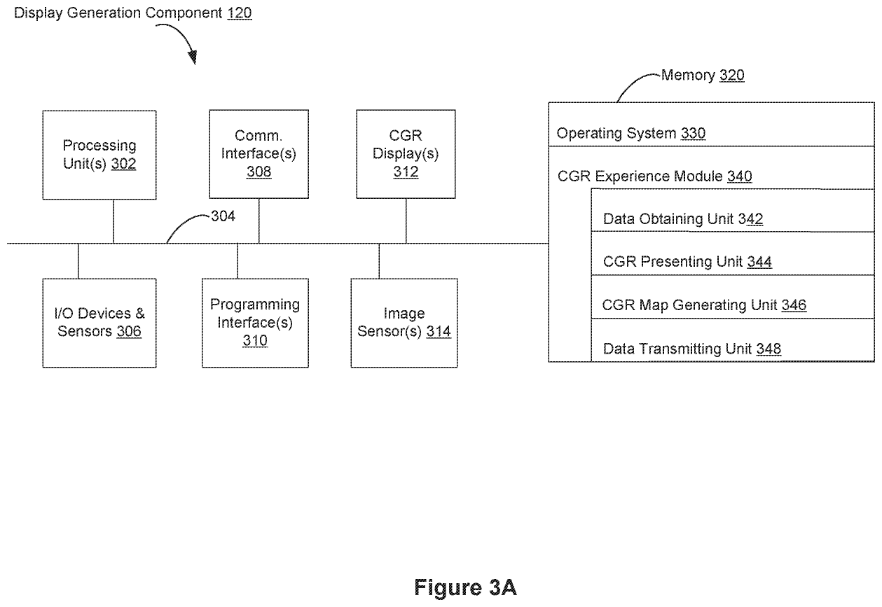

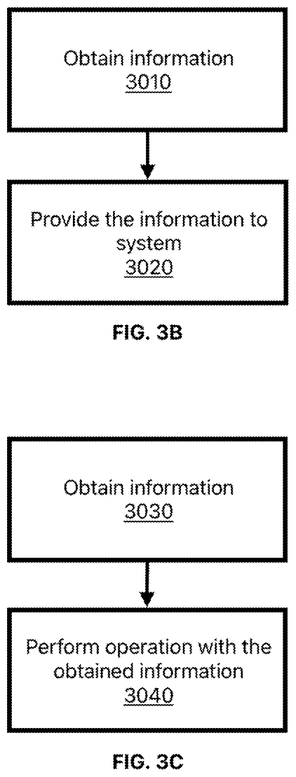

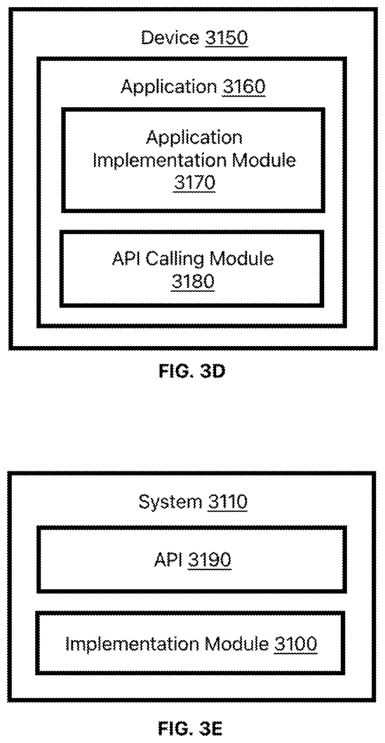

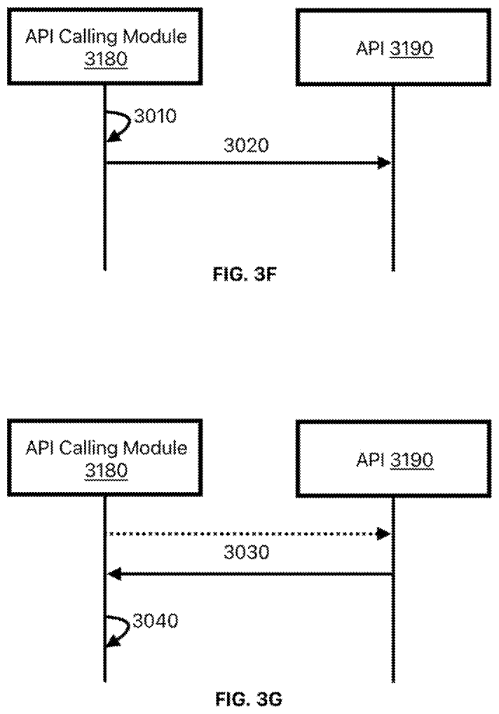

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120. According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 10) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-IF can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of an HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of an HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIG. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a light detection and ranging (LIDAR) sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HMD device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin, for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HMD 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some embodiments, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 11-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some embodiments, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some embodiments, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 10 illustrates an example of an optical module 11.3.2-100 for use in an electronic device such as an HMD, including HMD devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 10 can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BlueTooth, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

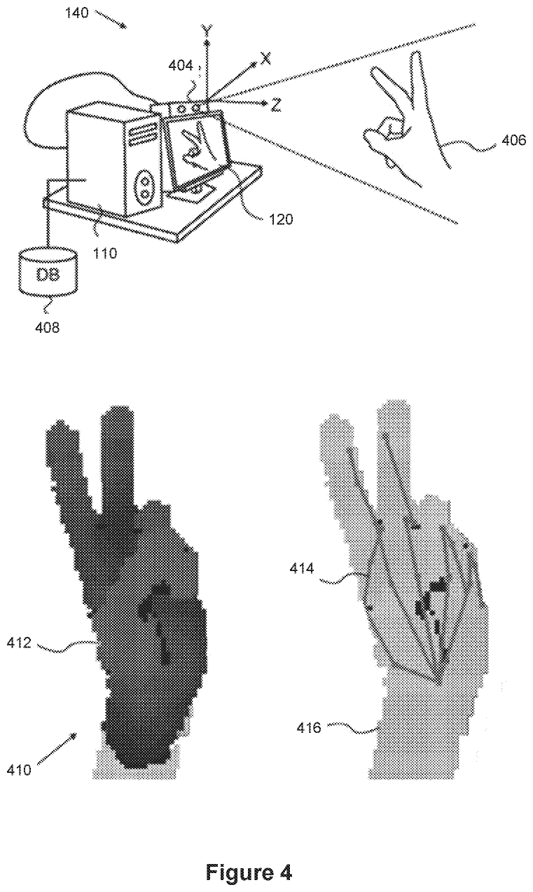

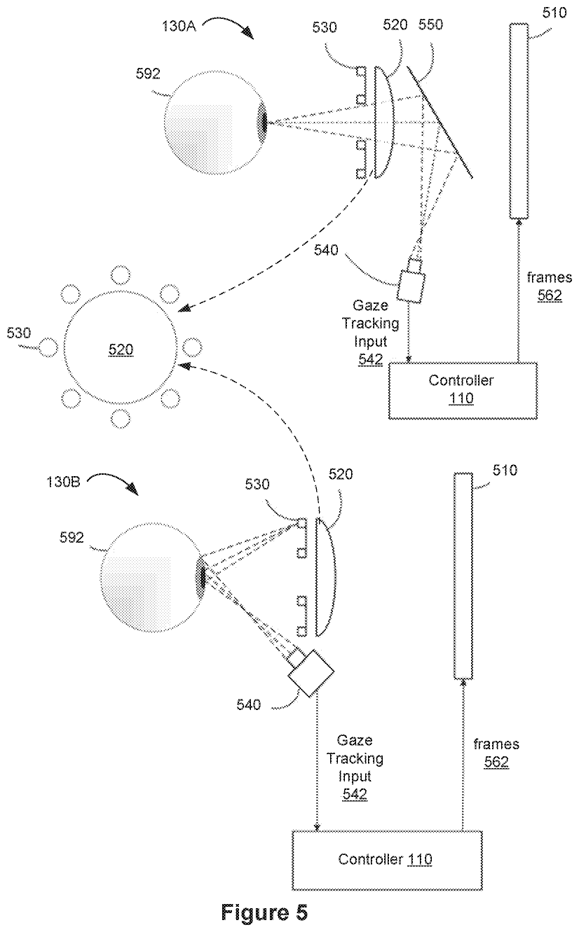

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BlueTooth, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In other embodiments, application 3160 is an application that is provided to device 3150 via an operating system update file (e.g., a first party application or a second party application). In other embodiments, application 3160 is an application that is provided via an application store. In some embodiments, the application store can be an application store that is pre-installed on device 3150 at purchase (e.g., a first party application store). In other embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of the device 3150. In some embodiments, at 3010, information is obtained from at least one software module of the device 3150. In some embodiments, at 3010, information is obtained from at least one hardware component external to the device 3150 (e.g., a peripheral device, an accessory device, a server, etc.). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on the device 3150. In some embodiments, the system (e.g., 3110 shown in FIG. 3E) is an external device (e.g., a server, a peripheral device, an accessory, a personal computing device, etc.) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API calling module to communicate with system 3110 via API 3190 (shown in FIG. 3E).

In some embodiments, API 3190 is a software module (e.g., a collection of computer-readable instructions) that provides an interface that allows a different module (e.g., API calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In other embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, a near-field communication (NFC) API, an ultrawideband (UWB) API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or other hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus be both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected the direct sensor data is frequently processes into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform methods 800, 900 and/or 1100 (FIGS. 8, 9 and/or 11) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and fingertips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to contact one another, that is, optionally, followed by an immediate (e.g., within 0-1 seconds) break in contact from each other. A long pinch gesture that is an air gesture includes movement of two or more fingers of a hand to contact one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to contact one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments, a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments, the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, fingertips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes one or more eye lenses 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each of the eye lenses 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

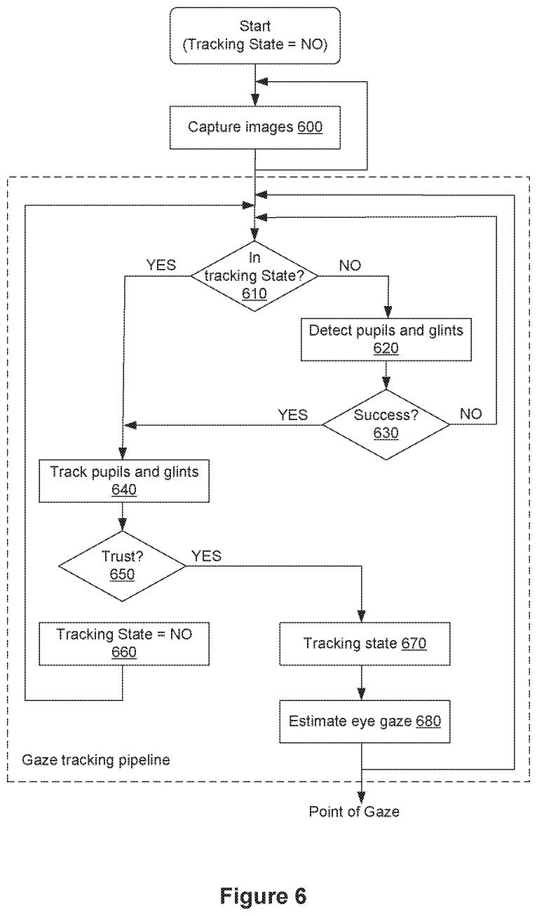

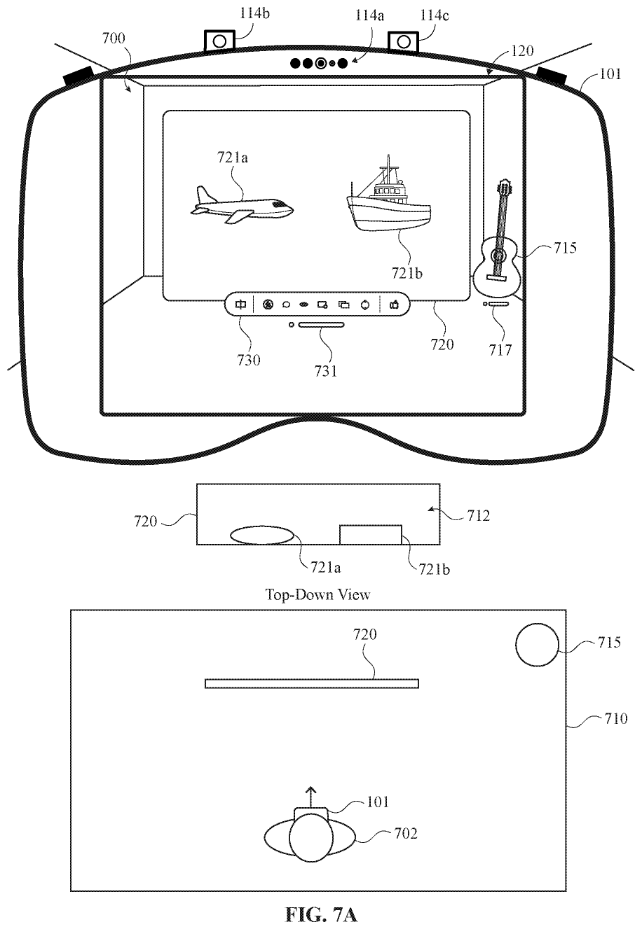

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments, where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments, where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7AA illustrate examples of a computer system facilitating interactions with virtual assets associated with a virtual object in a three-dimensional environment in accordance with some embodiments.

FIG. 7A illustrates a computer system 101 (e.g., an electronic device) displaying, via a display generation component (e.g., display generation component 120 of FIGS. 1 and 3), a three-dimensional environment 700 from a viewpoint of a user 702 in top-down view 710 (e.g., facing the back wall of the physical environment in which computer system 101 is located).

In some embodiments, computer system 101 includes a display generation component 120. In FIG. 7A, the computer system 101 includes one or more internal image sensors 114a oriented towards the face of the user 702 (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Computer system 101 also includes external image sensors 114b and 114c facing outwards from the user to detect and/or capture the physical environment and/or movements of the user's hands.

As shown in FIG. 7A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 700. For example, three-dimensional environment 700 includes representations of the walls, floor, and ceiling of the physical room in which the computer system 101 is located, which are optionally representations of physical walls, floor, and ceiling in the physical environment.

As discussed in more detail below, in FIG. 7A, display generation component 120 is illustrated as displaying content in the three-dimensional environment 700. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIGS. 7A-7U.

Display generation component 120 has a field of view (e.g., a field of view captured by external image sensors 114b and 114c and/or visible to the user via display generation component 120) that corresponds to the content shown in FIG. 7A. Because computer system 101 is optionally a head-mounted device, the field of view of display generation component 120 is optionally the same as or similar to the field of view of the user 702.

As discussed herein, one or more air pinch gestures performed by a user (e.g., with hand 703 below) are detected by one or more input devices of computer system 101 and interpreted as one or more user inputs directed to content displayed by computer system 101. Additionally or alternatively, in some embodiments, the one or more user inputs interpreted by computer system 101 as being directed to content displayed by computer system 101 are detected via one or more hardware input devices (e.g., controllers) rather than via the one or more input devices that are configured to detect air gestures, such as the one or more air pinch gestures, performed by the user 702. Such depiction is intended to be exemplary rather than limiting; the user optionally provides user inputs using different air gestures and/or using other forms of input.

As mentioned above, the computer system 101 is configured to display content in the three-dimensional environment 700 using the display generation component 120. In FIG. 7A, three-dimensional environment 700 includes virtual objects 720 and 715. In some embodiments, the virtual object 720 is a user interface of an application containing content (e.g., virtual assets), such as three-dimensional and/or two-dimensional objects, or any other element displayed by computer system 101 that is not included in the physical environment of display generation component 120. For example, in FIG. 7A, the virtual object 720 is a user interface of a content creation application containing a plurality of virtual assets 721a and 721b (e.g., two-dimensional and/or three-dimensional models, images, and/or objects, such as of an airplane and a ship). In some embodiments, the virtual object 720 is associated with a content aggregation application, a note-taking application, a content brainstorming application, etc. Additional examples of applications are provided below with reference to methods 800 and/or 900. Additionally, in some embodiments, the virtual object 720 includes and/or is displayed with toolbar 730 in the three-dimensional environment 700. In some embodiments, as illustrated in FIG. 7A, the toolbar 730 includes a plurality of selectable options that is selectable to perform corresponding operations directed to the virtual object 720, as discussed in more detail herein later. It should be understood that the content discussed above is exemplary and that, in some embodiments, additional and/or alternative content and/or user interfaces are provided in the three-dimensional environment 700, such as the content described below with reference to methods 800 and/or 900.

In some embodiments, the virtual object 720 includes or is associated with a three-dimensional volume in the three-dimensional environment 700. For example, in FIG. 7A, depth glyph 712 (e.g., illustrating depth from a top-down perspective) illustrates that the virtual object 720 has a three-dimensional volume within which the virtual assets 721a and 721b are displayed in the three-dimensional environment 700. Additionally, in some embodiments, as illustrated in the depth glyph 712, while the virtual assets 721a and 721b are displayed in the virtual object 720 in the three-dimensional environment 700, the virtual assets 721a and 721b are displayed along a front plane of the virtual object 720 in the three-dimensional environment 700. For example, as shown in the depth glyph 712, the virtual assets 721a and 721b are positioned along (e.g., abutting) the front surface of the virtual object 720 from the viewpoint of the user 702 in the three-dimensional environment 700. In some embodiments, the virtual assets 721a and 721b are displayed with a first visual appearance while displayed along the front plane of the virtual object 720 in the three-dimensional environment 700. For example, as described in more detail with reference to method 800, while the virtual assets 721a and 721b are displayed along the front plane of the virtual object 720, the virtual assets 721a and 721b have a first amount of transparency, brightness, saturation, coloration, and/or size in the three-dimensional environment 700.

Additionally, as mentioned above, the three-dimensional environment 700 includes the virtual object 715. In some embodiments, the virtual object 715 corresponds to a three-dimensional object, model, or image that is different from (e.g., separate from) the virtual assets 721 that are included in the virtual object 720. For example, as shown in FIG. 7A, the virtual object 715 corresponds to a three-dimensional model of a guitar that is displayed separately from the virtual object 720, as indicated in the top-down view 710. In some embodiments, as described herein, the virtual object 715 is able to be interacted with independently of the virtual object 720 in the three-dimensional environment 700.

In some embodiments, as shown in FIG. 7A, the virtual objects 720 and 715 are displayed with movement elements 731 and 717 (e.g., grabber bars) in the three-dimensional environment 700. In some embodiments, the movement elements 731 and 717 are selectable to initiate movement of the corresponding virtual object within the three-dimensional environment 700 relative to the viewpoint of the user 702. For example, the movement element 731 that is associated with the virtual object 720 is selectable to initiate movement of the virtual object 720, and the movement element 717 that is associated with the virtual object 715 is selectable to initiate movement of the virtual object 715, within the three-dimensional environment 700.

In some embodiments, virtual objects are displayed in three-dimensional environment 700 at respective sizes relative to the viewpoint of user 702 (e.g., prior to receiving input interacting with the virtual objects, which will be described later, in three-dimensional environment 700). As shown in FIG. 7A, the virtual objects 720 and 715 optionally have first sizes in the three-dimensional environment 700 (e.g., corresponding to and/or based on the front-facing surfaces of the virtual objects 720 and 715 that face the viewpoint of user 702 relative to the viewpoint of user 702). It should be understood that the sizes of the virtual objects in FIG. 7A are merely exemplary and that other sizes are possible.

In some embodiments, virtual objects are displayed in three-dimensional environment 700 at respective locations relative to the viewpoint of user 702 (e.g., prior to receiving input interacting with the virtual objects, which will be described later, in three-dimensional environment 700). As shown in FIG. 7A, the virtual objects 720 and 715 are optionally displayed at first locations in the three-dimensional environment 700 (e.g., the virtual object 720 is displayed directly ahead of the viewpoint of the user 702 and the virtual object 715 is displayed offset to the right of the virtual object 720 and further in depth from the viewpoint of the user 702 than the virtual object 720 relative to the viewpoint of user 702, as shown in the top-down view 710). It should be understood that the locations of the virtual objects in FIG. 7A are merely exemplary and that other locations are possible.

In FIG. 7B, the computer system 101 detects initiation of a movement input provided by the user 702 directed to the virtual asset 721a in the virtual object 720 in the three-dimensional environment 700. For example, as shown in FIG. 7B, the computer system 101 detects hand 703 of the user 702 perform an air pinch and drag gesture (e.g., in which the index finger and thumb of the hand 703 come together to make contact, followed by movement of the hand 703 in the pinch hand shape), optionally while gaze 726 of the user 702 is directed to the virtual asset 721a in the virtual object 720 in the three-dimensional environment 700. In some embodiments, as shown in FIG. 7B, the movement of the hand 703 of the user 702 corresponds to movement of the virtual asset 721a toward the viewpoint of the user 702 in the three-dimensional environment 700.

In some embodiments, as shown in FIG. 7C, in response to and/or while detecting the movement of the hand 703 of the user 702 (e.g., and prior to detecting a release of the air pinch gesture), the computer system 101 moves the virtual asset 721a in accordance with the movement of the hand 703 in the three-dimensional environment 700. For example, as shown in FIG. 7C, the virtual asset 721a is moved toward the viewpoint of the user 702 based on the movement of the hand 703 that is toward the viewpoint of the user 702 in the three-dimensional environment 700. In some embodiments, as illustrated in the depth glyph 712, the movement input directed to the virtual asset 721a causes the virtual asset 721a to be moved outside of the virtual object 720 (e.g., in front of the front surface of the virtual object 720) from the viewpoint of the user 702. Additionally, in some embodiments, as shown in FIG. 7C, when the virtual asset 721a is moved outside of the virtual object 720 in response to the computer system 101 detecting the movement input discussed above, the computer system 101 displays a visual indication of virtual object 711 in the three-dimensional environment 700. For example, as illustrated in FIG. 7C, the computer system 101 displays a visual indication of a horizontal virtual object on which the virtual asset 721a will be displayed once the movement input provided by the hand 703 concludes (e.g., when the computer system 101 detects a release of the air pinch gesture). In some embodiments, the virtual object 711 is also associated with the content creation application with which the virtual object 720 is associated. In FIG. 7C, the computer system 101 continues to detect movement of the hand 703 toward the viewpoint of the user 702 while maintaining the air pinch gesture described above.

In FIG. 7D, the computer system 101 detects a release of the air pinch gesture provided by the hand 703. In some embodiments, as shown in FIG. 7D, in response to detecting the conclusion of the movement input described above, the computer system 101 displays the virtual object 711 in the three-dimensional environment 700. For example, as shown in FIG. 7D, the computer system 101 displays a horizontal virtual object (e.g., a horizontal virtual platter) in the three-dimensional environment 700 on which representation 724a corresponding to the virtual asset 721a is displayed in the three-dimensional environment 700 in response to detecting the release of the air pinch gesture. In some embodiments, as shown in FIG. 7D, the representation 724a corresponding to the virtual asset 721a is displayed at a location relative to the virtual object 711 that is based on the movement of the virtual asset 721a in the three-dimensional environment 700. For example, the computer system 101 displays the representation 724a at a location relative to the virtual object 711 in the three-dimensional environment 700 that is based on the location of the virtual asset 721a in the three-dimensional environment 700 from the viewpoint of the user 702 when the release of the air pinch gesture is detected. Additionally, in some embodiments, as shown in FIG. 7D, the virtual object 711 is displayed with toolbar 713 and movement element 732 in the three-dimensional environment 700. In some embodiments, the toolbar 713 includes a plurality of selectable options that is selectable to perform corresponding operations directed to the virtual object 711. In some embodiments, the selectable options included in the toolbar 713 is different from the selectable options included in the toolbar 730. For example, as shown in FIG. 7D, the toolbar 713 includes fewer selectable options (e.g., a subset of the selectable options) than the toolbar 730 in the three-dimensional environment 700. In some embodiments, as previously described herein, the movement element 732 is selectable to initiate movement of the virtual object 711 (e.g., including the representation 724a) in the three-dimensional environment 700 from the viewpoint of the user 702. In some embodiments, as alluded to above, the virtual object 711 has an orientation in the three-dimensional environment 700 that is different from an orientation of the virtual object 720 relative to the viewpoint of the user 702. For example, as shown in FIG. 7D, the virtual object 711 is horizontally oriented relative to the viewpoint of the user 702 while the virtual object 720 is vertically oriented relative to the viewpoint of the user 702.

In some embodiments, as shown in FIG. 7D, when the representation 724a corresponding to the virtual asset 721a is displayed in the three-dimensional environment relative to the virtual object 711, the computer system 101 displays a visual indication 711a of the virtual object 711 in the virtual object 720 in the three-dimensional environment 700. For example, as illustrated in FIG. 7D, the computer system 101 displays a representation of the horizontal virtual object in the virtual object 720 in the three-dimensional environment 700. Additionally, as shown in FIG. 7D, the computer system 101 optionally updates display of the virtual asset 721a within the virtual object 720 to be relative to the visual indication 711a. For example, in FIG. 7D, the virtual asset 721a is moved to a location in the virtual object 720 that causes the virtual asset 721a to have a spatial relationship with the visual indication 711a that corresponds to (e.g., is the same as) a spatial relationship between the representation 724a and the virtual object 711 in the three-dimensional environment 700. Additionally, in some embodiments, as illustrated in FIG. 7D, when the representation 724a corresponding to the virtual asset 721a is displayed relative to the virtual object 711 in the three-dimensional environment 700, the computer system 101 updates display of the visual appearance of the virtual asset 721a to have a second visual appearance in the three-dimensional environment 700. For example, in FIG. 7D, the computer system 101 displays the virtual asset 721a with a second amount (e.g., less or smaller amount) of brightness, transparency, saturation, coloration, and/or size in the virtual object 720. In some embodiments, as shown in FIG. 7D, while the representation 724a is displayed in the three-dimensional environment 700, the virtual asset 721a and the visual indication 711a are displayed with the second visual appearance described above. In some embodiments, displaying the virtual asset 721a and the visual indication 711a with the second visual appearance includes increasing a depth at which the virtual asset 721a and the visual indication 711a are displayed within the virtual object 720. For example, as illustrated in the depth glyph 712 in FIG. 7D, the virtual asset 721a and the visual indication 711a are displayed farther from the viewpoint of the user 702 within the virtual object 720 relative to the front surface of the virtual object 720 in the three-dimensional environment 700. Additionally, in some embodiments, as shown in FIG. 7D, when the computer system 101 displays the representation 724a in the three-dimensional environment 700, the computer system 101 updates display of a visual appearance of the virtual object 720 in the three-dimensional environment 700. For example, as shown in FIG. 7D and as similarly discussed above, the computer system 101 decreases an amount of brightness, transparency, saturation, coloration, and/or size of the virtual object 720 (e.g., similar to the second visual appearance above). In some embodiments, as shown in FIG. 7D, the computer system 101 forgoes performing any operation directed to the virtual asset 721b in the virtual object 720 when performing the above operations directed to the virtual asset 721a in the virtual object 720 (e.g., because the movement input described above was directed to the virtual asset 721a and not the virtual asset 721b). Additional details regarding the display of the virtual object 711 and the visual indication 711a in the three-dimensional environment 700 are provided with reference to methods 800 and/or 900.

In FIG. 7E, the computer system 101 detects a movement input provided by the hand 703 directed to the virtual asset 721b in the virtual object 720 in the three-dimensional environment 700. For example, as shown in FIG. 7E and as similarly described above, the computer system 101 detects the hand 703 of the user 702 perform an air pinch and drag gesture, optionally while the attention (e.g., including the gaze 726) of the user 702 is directed to the virtual asset 721b in the virtual object 720. In some embodiments, the air pinch of the air pinch and drag gesture is detected for less than a threshold amount of time (e.g., 0.5, 1, 2, 3, 5, and/or 8 seconds) before detecting the movement of the hand 703 of the user 702. In some embodiments, as indicated in FIG. 7E, the movement of the hand 703 corresponds to movement of the virtual asset 721b toward the viewpoint of the user 702 in the three-dimensional environment 700.

In some embodiments, as shown in FIG. 7F, in response to and/or while detecting the movement input provided by the hand 703, the computer system 101 displays representation 724b corresponding to the virtual asset 721b in the three-dimensional environment 700 (e.g., optionally in response to detecting a release of the air pinch gesture, as shown in FIG. 7G). Additionally, in some embodiments, as shown in FIG. 7F, while displaying the representation 724b corresponding to the virtual asset 721b in the three-dimensional environment 700 (e.g., while the user 702 is maintaining the air pinch gesture), the computer system 101 displays visual indication 734 in the three-dimensional environment 700. For example, in FIG. 7F, the computer system 101 displays a visual glow or highlighting effect around a boundary or perimeter (e.g., edges and/or corners) of the virtual object 711 in the three-dimensional environment 700. In some embodiments, the display of the visual indication 734 provides an indication to the user 702 that the virtual object 711 is or corresponds to a valid drop or display target for the representation 724b corresponding to the virtual asset 721b in the three-dimensional environment 700. For example, as discussed in more detail below and as illustrated in FIG. 7G, if the computer system 101 detects a release of the air pinch gesture (e.g., an end of the movement input provided by the hand 703) while the visual indication 734 is displayed in the three-dimensional environment 700, the computer system 101 displays the representation 724b relative to the virtual object 711 (e.g., anchored on or above a surface of the virtual object 711) in the three-dimensional environment 700. In some embodiments, the visual indication 734 remains displayed in the three-dimensional environment 700 while the movement input continues to be detected and/or while the representation 724b continues to be located above the virtual object 711 in accordance with the movement input (e.g., but prior to detecting an end of the movement input).

In some embodiments, as shown in FIG. 7G and as similarly described above, the computer system 101 displays the representation 724b corresponding to the virtual asset 721b relative to the virtual object 711 in the three-dimensional environment 700 in response to detecting an end of the movement input (e.g., a release of the air pinch gesture provided by the hand 703). Additionally, as shown in FIG. 7G, the computer system 101 optionally displays the representation 724b at a location relative to the virtual object 711 that is based on the movement of the hand 703 of the user 702, as similarly discussed above. In some embodiments, as shown in FIG. 7G, when the computer system 101 displays the representation 724b relative to the virtual object 711 in the three-dimensional environment 700, the computer system 101 updates display of the virtual asset 721b in the virtual object 720. For example, the computer system 101b displays the virtual asset 721b with the second visual appearance described above and displays the virtual asset 721b at a location in the virtual object 720 that is relative to the visual indication 711a (e.g., based on the spatial relationship between the representation 724b and the virtual object 711 in the three-dimensional environment 700).

In some embodiments, when the representations 724a and 724b are displayed relative to the virtual object 711 in the three-dimensional environment 700, the virtual assets 721a and 721b become associated with the virtual object 711 and therefore each other. For example, as discussed in more detail below, the virtual asset 721a and the virtual asset 721b are no longer separate and individual virtual assets within the virtual object 720 and are together considered as representing a single virtual asset (e.g., a unit or grouping of virtual assets) within the virtual object 720.

In some embodiments, a virtual object that is separate from (e.g., different from) the virtual assets 721a and 721b are able to be added to the virtual object 720 as a new virtual asset, thereby associating the virtual object with the content creation application of the virtual object 720. For example, in FIG. 7H, the computer system 101 detects an input provided by the user 702 corresponding to a request to add the virtual object 715 to the virtual object 720 as a new virtual asset associated with the content creation application. Particularly, as shown in FIG. 7H, the computer system 101 detects an air pinch and drag gesture directed to the virtual object 715 provided by the hand 703 of the user 702. For example, the computer system 101 detects the hand 703 perform the air pinch and drag gesture while the attention (e.g., including the gaze 726) of the user 702 is directed to the movement element 717 associated with the virtual object 715 in the three-dimensional environment 700. In some embodiments, as shown in FIG. 7G, the movement of the hand 703 of the user corresponds to movement of the virtual object 715 toward the virtual object 720 (e.g., toward the front surface of the virtual object 720) from the viewpoint of the user 702 in the three-dimensional environment 700.

In some embodiments, as shown in FIG. 7I, in response to detecting the movement input directed to the virtual object 715 in the three-dimensional environment 700, the computer system 101 adds the virtual object 715 as virtual asset 721c to the virtual object 720 in the three-dimensional environment 700. For example, as illustrated in the top-down view 710 in FIG. 7I, the computer system 101 ceases display of the virtual object 715 and displays the virtual asset 721c corresponding to the virtual object 715 (e.g., a three-dimensional model of a guitar) in the virtual object 720, thereby associating the content of the virtual object 715 with the content creation application. In some embodiments, the computer system 101 displays the virtual asset 721c at a location in the virtual object 720 from the viewpoint of the user 702 that is based on the movement input provided by the hand 703. For example, the computer system 101 detects a release of the air pinch gesture performed by the hand 703 while the virtual object 715 was positioned at the illustrated location of the virtual asset 721c in FIG. 7I. In some embodiments, as similarly described above, because the virtual asset 721c is not currently open (e.g., displayed) in the three-dimensional environment 700 relative to a horizontal virtual object, such as the virtual object 711, the computer system 101 displays the virtual asset 721c along (e.g., abutting) the front surface or plane of the virtual object 720 from the viewpoint of the user 702, as illustrated by the depth glyph 712 in FIG. 7I.

In FIG. 7I, while displaying the virtual asset 721c in the virtual object 720 in the three-dimensional environment 700, the computer system 101 detects a movement input provided by the hand 703 of the user 702 directed to the virtual asset 721c. For example, as shown in FIG. 7I, the computer system 101 detects an air pinch and drag gesture provided by the hand 703, optionally while the attention (e.g., including the gaze 726) is directed to the virtual asset 721c in the three-dimensional environment 700. In some embodiments, as illustrated in FIG. 7I, the movement of the hand 703 corresponds to movement of the virtual asset 721c toward the viewpoint of the user 702 in the three-dimensional environment 700.

In some embodiments, as shown in FIG. 7J, in response to detecting the movement input provided by the hand 703, the computer system 101 displays representation 724c corresponding to the virtual asset 721c in the three-dimensional environment 700. For example, as shown in FIG. 7J, in response to detecting a release of the air pinch gesture of the hand 703, the computer system 101 displays the representation 724c relative to the virtual object 711 in the three-dimensional environment 700 (e.g., concurrently with the representations 724a and 724b). It is understood that, while detecting the air pinch gesture of the hand 703 (e.g., and prior to detecting the release of the air pinch gesture of the hand 703), the computer system 101 displays the visual indication 734 around the perimeter of the virtual object 711 in the three-dimensional environment 700 as similarly described above. In some embodiments, a location at which the representation 724c is displayed relative to the virtual object 711 is based on the movement input provided by the hand 703 (e.g., based on the location of the virtual asset 721c relative to the virtual object 711 when the release of the air pinch gesture is detected). In some embodiments, as illustrated in FIG. 7J, when the computer system 101 displays the representation 724c relative to the virtual object 711 in the three-dimensional environment 700 in response to detecting the movement input, the computer system 101 updates display of the virtual asset 721c in the virtual object 720. For example, as similarly discussed above, the computer system 101 displays the virtual asset 721c with the second visual appearance (e.g., decreased brightness, opacity, saturation, coloration, and/or size) in the virtual object 720. Additionally, in some embodiments, as indicated in the depth glyph 712, the virtual asset 721c is moved away from the front surface of the virtual object 720 relative to the viewpoint of the user 702. For example, as similarly discussed above, the computer system 101 increases the depth at which the virtual asset 721c is displayed within the virtual object 720 relative to the front surface of the virtual object 720. In some embodiments, as shown in FIG. 7J, when the virtual asset 721c is displayed with the second visual appearance described above, the computer system 101 displays the virtual asset 721c at a location relative to the visual indication 711a in the virtual object 720 that is based on the location of the representation 724c relative to the virtual object 711 in the three-dimensional environment 700 from the viewpoint of the user 702. Accordingly, as illustrated in FIG. 7J, the computer system 101 displays the virtual assets 721a-721c with a spatial relationship relative to the visual indication 711a that corresponds to (e.g., is the same as) a spatial relationship of the representations 724a-724c relative to the virtual object 711 in the three-dimensional environment 700.

In FIG. 7J, the computer system 101 detects a movement input provided by hand 703 directed to the representation 724a corresponding to the virtual asset 721a in the three-dimensional environment 700. For example, as shown in FIG. 7J, the computer system 101 detects an air pinch and drag gesture performed by the hand 703, optionally while the attention (e.g., including the gaze 726) is directed to the representation 724a in the three-dimensional environment 700. In some embodiments, as shown in FIG. 7J, the movement of the hand 703 corresponds to movement of the representation 724a in a rightward direction relative to the viewpoint of the user 702 and with a respective magnitude (e.g., of speed and/or distance).

In some embodiments, as shown in FIG. 7K, in response to detecting the movement input provided by the hand 703 directed to the representation 724a, the computer system 101 moves the representation 724a relative to the virtual object 711 in accordance with the movement input. For example, as shown in FIG. 7K, the computer system 101 repositions the representation 724a on top of the virtual object 711 to be to the right of the representation 724c and below the representation 724b from the viewpoint of the user 702, as illustrated in the top-down view 710, in accordance with the rightward movement of the hand 703. In some embodiments, the movement of the representation 724a is limited to the virtual object 711. For example, in FIG. 7K, the computer system 101 moves and/or repositions the representation 724a in accordance with the movement of the hand 703 based on the location of the virtual object 711 and/or a size of the virtual object 711 (e.g., a surface area of the top plane of the virtual object 711) in the three-dimensional environment 700 from the viewpoint of the user 702, thereby limiting movement of the representation 724a beyond an edge or other boundary of the virtual object 711 (e.g., the right edge of the virtual object 711 from the viewpoint of the user 702). Additionally, in some embodiments, as shown in FIG. 7K, in accordance with a determination that the movement of the hand 703 of the user 702 corresponds to movement of the representation 724a beyond a boundary of the virtual object 711, the computer system 101 displays the visual indication 734 in the three-dimensional environment 700 at a location of the virtual object 711 that corresponds to and/or is based on the (e.g., current) location of the representation 724a. For example, as shown in FIG. 7K, the computer system 101 displays the visual indication 734 along and/or at the portions of the virtual object 711 (e.g., along the right edge or side of the virtual object 711 from the viewpoint of the user 702) corresponding to the location at which the representation 724a has crossed the edge or boundary of the virtual object 711 in the three-dimensional environment 700. In some embodiments, as shown in FIG. 7L, the visual indication 734 has a visual appearance (e.g., a shape, size, form, color, and/or dimensionality) that is based on the portion of the representation 724a that has crossed the boundary of the virtual object 711 in the three-dimensional environment 700. For example, in FIG. 7L, the visual indication 734 is displayed as visually morphing and/or conforming to the pointed nose of the airplane that is the representation 724a from the viewpoint of the user 702. In some embodiments, further movement of a respective representation, such as the representation 724a, beyond an edge or other boundary of the virtual object 711 causes the respective representation to be removed (e.g., deleted) from the virtual object 711, and therefore no longer displayed in the three-dimensional environment 700.

In FIG. 7K, while displaying the visual indication 734, the computer system 101 detects further movement input provided by hand 703 directed to the representation 724a corresponding to the virtual asset 721a in the three-dimensional environment 700. For example, as shown in FIG. 7K, the computer system 101 continues to detect the air pinch and drag gesture performed by the hand 703, optionally while the attention (e.g., including the gaze 726) is directed to the representation 724a in the three-dimensional environment 700. In some embodiments, as shown in FIG. 7K, the further (e.g., additional) movement of the hand 703 corresponds to movement of the representation 724a in a leftward direction relative to the viewpoint of the user 702 and with a respective magnitude (e.g., of speed and/or distance).

In some embodiments, as shown in FIG. 7L, in response to detecting the further movement input provided by the hand 703 directed to the representation 724a, the computer system 101 moves the representation 724a relative to the virtual object 711 in accordance with the further movement input. For example, as shown in FIG. 7L, in response to detecting a release of the air pinch gesture provided by the hand 703, the computer system 101 displays the representation 724a on top of the virtual object 711 to be positioned away from the right boundary (e.g., edge) of the virtual object 711 from the viewpoint of the user 702, as similarly illustrated in the top-down view 710, in accordance with the leftward movement of the hand 703. Additionally, in some embodiments, because the representation 724a is no longer positioned at or beyond a boundary of the virtual object 711, the computer system 101 ceases display of the visual indication 734 in the three-dimensional environment 700, as shown in FIG. 7L.

In some embodiments, as shown in FIG. 7L, when the computer system 101 moves the representation 724a relative to the virtual object 711 in the three-dimensional environment 700 in response to detecting the movement input above, the computer system 101 updates display of the virtual asset 721a in the virtual object 720. For example, as shown in FIG. 7L, the computer system 101 moves the virtual asset 721a relative to the visual indication 711a in the virtual object 720 to reflect (e.g., correspond to) the updated spatial relationship between the representation 724a corresponding to the virtual asset 721a and the virtual object 711 in the three-dimensional environment 700.

In FIG. 7M, the computer system 101 detects a movement input provided by hand 703 directed to the representation 724c corresponding to the virtual asset 721c in the three-dimensional environment 700. For example, as shown in FIG. 7M, the computer system 101 detects an air pinch and drag gesture performed by the hand 703, optionally while the attention (e.g., including the gaze 726) is directed to the representation 724c in the three-dimensional environment 700. In some embodiments, as shown in FIG. 7M, the movement of the hand 703 corresponds to movement of the representation 724c in a leftward direction relative to the viewpoint of the user 702 and with a respective magnitude (e.g., of speed and/or distance).

In some embodiments, as shown in FIG. 7N, in response to detecting the movement input provided by the hand 703 directed to the representation 724c, the computer system 101 moves the representation 724c relative to the virtual object 711 in accordance with the movement input. For example, as shown in FIG. 7N, the computer system 101 repositions the representation 724c on top of the virtual object 711 to be to the left of the representation 724a and the representation 724b from the viewpoint of the user 702 in accordance with the leftward movement of the hand 703. In some embodiments, the movement of the representation 724a is limited to the virtual object 711. In some embodiments, as shown in FIG. 7N and as similarly described above, in accordance with a determination that the movement of the hand 703 of the user 702 corresponds to movement of the representation 724c beyond a boundary of the virtual object 711, the computer system 101 displays the visual indication 734 in the three-dimensional environment 700 at a location of the virtual object 711 that corresponds to and/or is based on the (e.g., current) location of the representation 724c. For example, as shown in FIG. 7N, the computer system 101 displays the visual indication 734 along and/or at the portions of the virtual object 711 (e.g., along the left edge and/or corner of the virtual object 711 from the viewpoint of the user 702) corresponding to the location at which the representation 724c has crossed the edge or boundary of the virtual object 711 in the three-dimensional environment 700. In some embodiments, as shown in FIG. 7N, the visual indication 734 has a visual appearance (e.g., a shape, size, form, color, and/or dimensionality) that is based on the portion of the representation 724c that has crossed the boundary of the virtual object 711 in the three-dimensional environment 700. For example, in FIG. 7N, the visual indication 734 is displayed to visually morph and/or conform to the rounded edges of the guitar that is the representation 724c from the viewpoint of the user 702.

In FIG. 7N, while displaying the visual indication 734, the computer system 101 detects further movement input provided by hand 703 directed to the representation 724c corresponding to the virtual asset 721c in the three-dimensional environment 700. For example, as shown in FIG. 7N, the computer system 101 continues to detect the air pinch and drag gesture performed by the hand 703, optionally while the attention (e.g., including the gaze 726) is directed to the representation 724c in the three-dimensional environment 700. In some embodiments, as shown in FIG. 7N, the further (e.g., additional) movement of the hand 703 corresponds to movement of the representation 724a in a rightward direction relative to the viewpoint of the user 702 and with a respective magnitude (e.g., of speed and/or distance).

In some embodiments, as shown in FIG. 7O, in response to detecting the further movement input provided by the hand 703 directed to the representation 724c, the computer system 101 moves the representation 724c relative to the virtual object 711 in accordance with the further movement input. For example, as shown in FIG. 7O, in response to detecting a release of the air pinch gesture provided by the hand 703, the computer system 101 displays the representation 724c on top of the virtual object 711 to be positioned away from the left boundary (e.g., edge or corner) of the virtual object 711 from the viewpoint of the user 702, as similarly illustrated in the top-down view 710, in accordance with the rightward movement of the hand 703. Additionally, in some embodiments, because the representation 724c is no longer positioned at or beyond a boundary of the virtual object 711, the computer system 101 ceases display of the visual indication 734 in the three-dimensional environment 700, as shown in FIG. 7O.

In FIG. 7O, the computer system 101 detects an input corresponding to a request to cease display of the virtual object 711 in the three-dimensional environment 700. For example, as shown in FIG. 7O, the computer system 101 detects an air pinch gesture provided by the hand 703 while the attention (e.g., including the gaze 726) of the user 702 is directed to a selectable option displayed with the movement element 732 and that is selectable to close the virtual object 711, including the representations 724a-724c, in the three-dimensional environment 700.

In some embodiments, as shown in FIG. 7P, in response to detecting the selection of the selectable option discussed above, the computer system 101 ceases display of the virtual object 711 and the representations 724a-724c in the three-dimensional environment 700. Particularly, in FIG. 7P, the computer system 101 ceases display of the virtual object 711 but does not delete the content (e.g., the representations 721a-721c) associated with the virtual object 711 in the three-dimensional environment 700. In some embodiments, as shown in FIG. 7P, when the computer system 101 ceases display of the virtual object 711 and the representations 724a-724c, the computer system 101 updates display of the visual indication 711a and the virtual assets 721a-721c. As shown in FIG. 7P, the computer system 101 optionally redisplays the visual indication 711a and the virtual assets 721a-721c with the first visual appearance described previously above (e.g., the computer system 101 increases the opacity, brightness, saturation, coloration, and/or size of the visual indication 711a and the virtual assets 721a-721c in the virtual object 720). In some embodiments, as illustrated in the depth glyph 712 in FIG. 7P, when the computer system 101 ceases display of the virtual object 711 and the representations 724a-724c in the three-dimensional environment 700, the computer system 101 updates the depth at which the visual indication 711a and the virtual assets 721a-721c are displayed within the virtual object 720 from the viewpoint of the user 702. For example, as shown in the depth glyph 712 in FIG. 7P, the computer system 101 moves the visual indication 711a and the virtual assets 721a-721c relative to the front surface or plane of the virtual object 720, such that the visual indication 711a and the virtual assets 721a-721c are displayed along the front surface or plane of the virtual object 720 from the viewpoint of the user 702 (e.g., while maintaining the existing spatial relationship between the virtual assets 721a-721c and the visual indication 711a within the virtual object 720). Additionally, in some embodiments, as shown in FIG. 7P, the computer system 101 updates the visual appearance of the virtual object 720. For example, when the virtual object 711 is no longer displayed in the three-dimensional environment 700, the computer system 101 redisplays the virtual object 720 with the first visual appearance discussed previously above.

In some embodiments, virtual assets are able to be moved within the virtual object 720, without changing an actual spatial relationship between their corresponding representations in the three-dimensional environment 700. In FIG. 7Q, the computer system 101 detects an input directed to the visual indication 711a in the virtual object 720. For example, as shown in FIG. 7Q, the computer system 101 detects an air pinch and drag gesture performed by the hand 703 of the user 702, optionally while the attention (e.g., including the gaze 726) of the user 702 is directed toward the visual indication 711a in the virtual object 720. In some embodiments, as shown in FIG. 7Q, in response to detecting the initial air pinch gesture (e.g., prior to detecting the movement of the hand 703 indicated in FIG. 7Q), the computer system 101 displays bounding box 716 in the virtual object 720. Particularly, as shown in FIG. 7Q, the computer system 101 displays the bounding box 716 around (e.g., encapsulating) the visual indication 711a and the virtual assets 721a-721c that are associated with the visual indication 711a. As mentioned previously herein, in some embodiments, when a particular virtual asset is displayed relative to and/or is added to a horizontal virtual object (e.g., virtual object 711) in the three-dimensional environment 700 in response to user input, the virtual asset becomes associated with the horizontal virtual object and any other virtual assets previously added to the horizontal virtual object. In FIG. 7Q, because the virtual assets 721a-721c, which correspond to the representations 724a-724c above, are associated with the visual indication 711a (e.g., due to the representations 724a-724c being added to the virtual object 711 as previously discussed herein), the bounding box 716 surrounds the visual indication 711a and the virtual assets 721a-721c. Accordingly, within the virtual object 720, the visual indication 711a and the virtual assets 721a-721c collectively correspond to a single virtual asset, such as a group or unit of virtual assets, as indicated by the bounding box 716. In some embodiments, as shown in FIG. 7Q, the bounding box 716 includes resize elements 718 (e.g., disposed at the corners of the bounding box 716) in the virtual object 720. In some embodiments, the resize elements 718 are individually selectable to initiate a process to resize (e.g., scale up or down) the visual indication 711a and the representations 721a-721c in the virtual object 720 (e.g., to adjust an amount of available display space within the virtual object 720). For example, an air pinch and drag gesture directed to one or more of the resize elements 718 of the bounding box 716 causes the visual indication 711a and the representations 721a-721c to be (e.g., concurrently) scaled up or down based on a direction and magnitude of movement of the hand of the user 702, and optionally by a same magnitude of scaling. In FIG. 7Q, while the gaze 726 is directed to the visual indication 711a and while the bounding box 716 is displayed in the virtual object 720, the computer system 101 detects movement of the hand 703 of the user 702 in a diagonally leftward direction relative to the viewpoint of the user 702.

In some embodiments, as shown in FIG. 7R, in response to detecting the movement input directed to the visual indication 711a, the computer system 101 (e.g., concurrently) moves the visual indication 711a and the representations 721a-721c within the virtual object 720 in accordance with the movement of the hand 703. For example, as shown in FIG. 7R, the computer system 101 moves the visual indication 711a and the representations 721a-721c diagonally leftward in the virtual object 720 relative to the viewpoint of the user 702 in accordance with the diagonally leftward movement of the hand 703. Additionally, in some embodiments, as shown in FIG. 7R, when the virtual assets 721a-721c are moved with the visual indication 711a within the virtual object 720, the computer system 101 maintains the existing spatial relationship between the virtual assets 721a-721c and the visual indication 711a in the virtual object 720.

In some embodiments, the virtual object 720 includes a plurality of groups of virtual assets. For example, in FIG. 7R, the virtual object 720 includes a second group of virtual assets, including virtual assets 721d and 721e (e.g., corresponding to three-dimensional models of a drum and a unicorn, respectively), which is associated with visual indication 719a (e.g., a second visual indication of a second horizontal virtual object). In some embodiments, the second group of virtual assets has one or more characteristics of the first group of virtual assets (e.g., the virtual assets 721a-721c that are associated with the visual indication 711a) in the virtual object 720. Additionally, in some embodiments, the second group of virtual assets is able to be individually interacted with from the first group of virtual assets in the virtual object 720. It should be understood that, in some embodiments, the second group of virtual assets is displayed in the virtual object 720 concurrently with the virtual assets 721a-721c and/or the visual indication 711a during the example interactions discussed above with reference to FIGS. 7A-7Q. Alternatively, in some embodiments, the second group of virtual assets is displayed in the virtual object 720 (e.g., in response to detecting user input for generating associating the virtual assets 721d and 721e with the visual indication 719a) following the example interactions discussed above with reference to FIGS. 7A-7Q.

In FIG. 7R, the computer system 101 detects a movement input directed to the virtual asset 721e in the virtual object 720. For example, as shown in FIG. 7R, the computer system 101 detects the hand 703 perform an air pinch and drag gesture while the attention (e.g., including the gaze 726) of the user 702 is directed to the virtual asset 721e in the virtual object 720. In some embodiments, as indicated in FIG. 7R, the movement of the hand 703 corresponds to movement of the virtual asset 721e toward the viewpoint of the user 702 in the three-dimensional environment 700.

In some embodiments, as shown in FIG. 7S, in response to detecting the movement input directed to the virtual asset 721e in the virtual object 720, the computer system 101 launches the second group of virtual assets, which includes displaying virtual object 719, representation 724d corresponding to the virtual asset 721d, and representation 724e corresponding to the virtual asset 721e in the three-dimensional environment 700. For example, as similarly mentioned above, because the virtual asset 721e belongs to the second group of virtual assets discussed above (e.g., the virtual asset 721e is associated with the visual indication 719a along with the virtual asset 721d in the virtual object 720), the movement input directed to the virtual asset 721e causes the computer system 101 to concurrently display the representations 724d and 724e with the virtual object 719 in the three-dimensional environment 700. In some embodiments, as shown in FIG. 7S, the representations 724d and 724e are displayed relative to the virtual object 719 in the three-dimensional environment 700 (e.g., above a top surface of the virtual object 719 from the viewpoint of the user 702). Particularly, in some embodiments, as shown in FIG. 7S and as similarly discussed above with reference to the first group of virtual assets, the representations 724d and 724e have a spatial relationship with the virtual object 719 that corresponds to (e.g., is the same as) the spatial relationship between the virtual assets 721d and 721e and the visual indication 719a in the virtual object 720 from the viewpoint of the user 702. Additionally, in some embodiments, as similarly discussed above, when the computer system 101 displays the representations 724d and 724e relative to the virtual object 719 in the three-dimensional environment 700, the computer system 101 updates a visual appearance of the virtual assets 721d and 721e and the visual indication 719a in the virtual object 720 (e.g., displays the virtual assets 721d and 721e and the visual indication 719a with the second visual appearance described above) and increases a depth of the virtual assets 721d and 721e and the visual indication 719a within the virtual object 720. For example, as shown in the depth glyph 712 in FIG. 7S, the computer system 101 moves the virtual assets 721d and 721e and the visual indication 719a away from the front plane of the virtual object 720, thereby increasing the depth of the virtual assets 721d and 721e and the visual indication 719a within the virtual object 720 relative to the viewpoint of the user 702. In some embodiments, as shown in FIG. 7S, when the virtual object 719 is displayed in the three-dimensional environment 700, the computer system 101 displays the virtual object 719 with toolbar 713b (e.g., having one or more characteristics of the toolbar 713 above) and movement element 732b (e.g., having one or more characteristics of the movement element 732b above).

In FIG. 7S, the computer system 101 detects an input provided by the hand 703 corresponding to a request to disassociate the representation 724e from the virtual object 719 in the three-dimensional environment 700. For example, as shown in FIG. 7S, the computer system 101 detects an air pinch and drag gesture performed by the hand 703, optionally while the attention (e.g., including gaze 726) of the user 702 is directed to the representation 724e that is displayed relative to the virtual object 719. In some embodiments, as shown in FIG. 7S, the movement of the hand 703 relative to the viewpoint of the user 702 corresponds to movement of the representation 724e toward the virtual object 720 and away from the viewpoint of the user 702 in the three-dimensional environment 700. In some embodiments, the request to disassociate the representation 724e from the virtual object 719 corresponds to a request to disassociate the virtual asset 721e from the visual indication 719a.

In some embodiments, as shown in FIG. 7T, in response to detecting the input provided by the hand 703, the computer system 101 ceases display of the representation 724e from the virtual object 719 in the three-dimensional environment 700 and disassociates the virtual asset 721e corresponding to the representation 724e from the visual indication 719a in the virtual object 720. For example, as shown in FIG. 7T, the computer system 101 ceases displaying the virtual asset 721e relative to the visual indication 719a in the virtual object 720 and redisplays the virtual asset 721e as a virtual asset that is separate from the second group of virtual assets (e.g., and the first group of virtual assets). Further, as shown in FIG. 7T, when the virtual asset 721e is disassociated from the visual indication 719a in the virtual object 720, the computer system 101 optionally redisplays the virtual asset 721e with the first visual appearance described previously above in the virtual object 720 (e.g., because the representation 724e is no longer displayed relative to the virtual object 719 in the three-dimensional environment 700). Accordingly, as indicated in the depth glyph 712 in FIG. 7T, the virtual asset 721e is redisplayed along the front plane of the virtual object 720 from the viewpoint of the user 702 (e.g., similar to the first group of virtual assets).

In FIG. 7U, the computer system 101 detects a movement input provided by the hand 703 directed to the visual indication 711a in the virtual object 720 in the three-dimensional environment 700. For example, as shown in FIG. 7U, the computer system 101 detects an air pinch and drag gesture performed by the hand 703, optionally while the attention (e.g., including the gaze 726) of the user 702 is directed to the visual indication 711a (optionally a portion that does not include content) in the three-dimensional environment 700. In some embodiments, as indicated in FIG. 7U, the movement of the hand 703 corresponds to movement of the visual indication 711a toward the viewpoint of the user 702 in the three-dimensional environment 700.

In some embodiments, as shown in FIG. 7V, in response to detecting the movement input directed to the visual indication 711a in the virtual object 720, the computer system 101 redisplays the representations 724a-724c relative to the virtual object 711 in the three-dimensional environment 700. For example, as shown in FIG. 7V, the computer system 101 launches the first group of virtual assets while the second group of virtual assets is open in the three-dimensional environment 700, which includes concurrently displaying the representations 724a-724c atop the virtual object 711 with the representation 724d and the virtual object 719. Additionally, as similarly mentioned above, because the visual indication 711a belongs to the first group of virtual assets (e.g., the virtual assets 721a-721c are associated with the visual indication 711a in the virtual object 720), the movement input directed to the visual indication 711a causes the computer system 101 to concurrently display the representations 724a-724c with the virtual object 711 in the three-dimensional environment 700. In some embodiments, the location at which the virtual object 711 is displayed in the three-dimensional environment 700 relative to the viewpoint of the user 702 is based on the movement input provided by the hand 703. Particularly, as similarly discussed herein, the computer system 101 optionally displays the virtual object 711 in the three-dimensional environment 700 at a location of the visual indication 711a at which release of the air pinch gesture of the hand 703 was detected in the three-dimensional environment 700. Additionally, in some embodiments, as shown in FIG. 7V, when the virtual object 711 is displayed in the three-dimensional environment 700, the computer system 101 displays the virtual object 711 with toolbar 713a (e.g., corresponding to the toolbar 713 above) and the movement element 732a (e.g., corresponding to the movement element 732 above). In some embodiments, as similarly discussed above, when the computer system 101 displays the representations 724a-724c relative to the virtual object 711 in the three-dimensional environment 700, the computer system 101 updates display of the virtual assets 721a-721c and the visual indication 711a to have the second visual appearance in the virtual object 720. Additionally, as illustrated in the depth glyph 712 in FIG. 7V, computer system 101 increases the depth at which the virtual assets 721a-721c and the visual indication 711a are displayed within the virtual object 720 from the viewpoint of the user 702, as previously discussed herein.

In FIG. 7V, the computer system 101 detects an input corresponding to a request to move the virtual object 719 in the three-dimensional environment 700. For example, as shown in FIG. 7V, the computer system 101 detects an air pinch and drag gesture performed by the hand 703, optionally while the attention (e.g., including the gaze 726) of the user 702 is directed to the movement element 732b associated with the virtual object 719 in the three-dimensional environment 700. In some embodiments, as indicated in FIG. 7V, the movement of the hand 703 corresponds to movement of the virtual object 719 in a rightward direction relative to the viewpoint of the user 702 in the three-dimensional environment 700.

In some embodiments, as shown in FIG. 7W, in response to detecting the movement input directed to the virtual object 719, the computer system 101 moves the virtual object 719 and the representation 724d in the three-dimensional environment 700 in accordance with the movement of the hand 703. For example, as shown in FIG. 7W, the computer system 101 moves the virtual object 719 and the representation 724d rightward in the three-dimensional environment 700 relative to the viewpoint of the user 702 in accordance with the rightward movement of the hand 703. Additionally, in some embodiments, as shown in FIG. 7W, the computer system 101 maintains the spatial relationship between the representation 724d and the virtual object 719 in the three-dimensional environment 700 from the viewpoint of the user 702 when the virtual object 719 and the representation 724d are concurrently moved in the three-dimensional environment. In some embodiments, as shown in FIG. 7W, when the virtual object 719 and the representation 724d are moved in the three-dimensional environment 700 in response to detecting the movement input discussed above, the computer system 101 forgoes moving the virtual asset 721d corresponding to the representation 724d and the visual indication 719a in the virtual object 720 in accordance with the movement of the hand 703. Accordingly, as illustrated in FIG. 7W, movement of groups of virtual assets within the virtual object 720 is independent from movement of representations of the groups of virtual assets within the three-dimensional environment 700.

In FIG. 7X, the computer system 101 detects an input corresponding to a selection of a respective option 733 of the plurality of selectable options within the toolbar 730 associated with the virtual object 720. For example, as shown in FIG. 7X, the computer system 101 detects the hand 703 perform an air pinch gesture while the attention (e.g., including the gaze 726) of the user 702 is directed to the respective option 733 in the toolbar 730 in the three-dimensional environment 700. In some embodiments, as discussed below, the respective option 733 is selectable to initiate display of the virtual object 720 in an immersive viewing mode in the three-dimensional environment 700.

In some embodiments, as shown in FIG. 7Y, in response to detecting the selection of the respective option 733 in the toolbar 730 associated with the virtual object 720, the computer system 101 transitions to displaying the virtual object 720 in an immersive viewing mode in the three-dimensional environment 700. For example, as illustrated in the top-down view 710 in FIG. 7Y, the computer system 101 increases an immersion level at which the virtual object 720 is displayed in the three-dimensional environment 700, which increases an available amount of display space within the virtual object 720 and/or results in additional virtual assets being displayed/visible within the virtual object 720 (e.g., that were previously not displayed/visible within the virtual object 720 due to the size constraints of the virtual object 720), as shown. As an example, in FIG. 7Y, displaying the virtual object 720 in the immersive viewing mode in the three-dimensional environment 700 causes virtual assets 721f and 721g (e.g., three-dimensional models of a racecar and a chair, respectively) to become displayed/visible within the virtual object 720 (e.g., to the right of the virtual asset 721e from the viewpoint of the user 702) and causes a third group of virtual assets, including virtual assets 721h-721j, associated with visual indication 729a (e.g., a third visual indication of a third horizontal virtual object) to become displayed/visible within the virtual object 720 (e.g., to the left of the visual indication 711a from the viewpoint of the user 702). Additional details regarding the display of the virtual object 720 in the immersive viewing mode are provided below with reference to method 800.

In some embodiments, as shown in FIG. 7Y, because the virtual assets 721f and 721g and the third group of virtual assets associated with the visual indication 729a are not currently open (e.g., displayed) in the three-dimensional environment 700 (e.g., outside of the virtual object 720), the computer system 101 displays the virtual assets 721f and 721g and the third group of virtual assets associated with the visual indication 729a with the first visual appearance discussed previously herein. Additionally, as illustrated in the depth glyph 712 in FIG. 7Y, the virtual assets 721f and 721g and the virtual assets 721h-721j associated with the visual indication 729a are displayed along the front plane or surface of the virtual object 720 from the viewpoint of the user 702. Further, as illustrated in FIG. 7Y, though the virtual assets 721h-721j that are associated with the visual indication 729a correspond to the same type of three-dimensional objects as the virtual assets 721a-721c (e.g., airplane, ship, and guitar) that are associated with the visual indication 711a, the virtual assets 721h-721j have a spatial relationship relative to the visual indication 729a that is different from the spatial relationship of the virtual assets 721a-721c relative to the visual indication 711a. For example, though the virtual assets 721a-721c and the virtual assets 721h-721j represent the same three-dimensional objects, their independent associations with the visual indications 711a and 729a, respectively, allows the virtual assets 721a-721c and the virtual assets 721h-721j to have different spatial relationships with their respective horizontal virtual objects in the virtual object 720, as illustrated in FIG. 7Y. In some embodiments, the virtual assets 721f and 721g and the virtual assets 721h-721j have one or more characteristics of the virtual assets described above. In some embodiments, the visual indication 729a has one or more characteristics of the visual indications described above.

FIGS. 7Z-7AA illustrate examples of generating and displaying a two-dimensional copy of a virtual asset within a user interface in the three-dimensional environment 700 in accordance with some embodiments. In FIG. 7Z, while the computer system 101 is displaying the virtual object 711 (e.g., including the representation 724a corresponding to the virtual asset 721a) that is associated with the virtual object 720 in the three-dimensional environment 700, the computer system 101 displays user interface 736 in the three-dimensional environment 700. In some embodiments, the user interface 736 is associated with a messaging application that is running on the computer system 101. For example, in FIG. 7Z, the user interface 736 corresponds to a messaging user interface 736 that includes a plurality of indications of messages 735 (e.g., text messages, direct messages, an email chain, and/or other forms of communication) and an input region 737 (e.g., a text or other content entry field within the user interface). In some embodiments, the messaging application with which the user interface 736 is associated is different from the content creation application with which the virtual objects 711 and 720 are associated at the computer system 101.

In FIG. 7Z, the computer system 101 detects a movement input directed to the representation 724a corresponding to the virtual asset 721a in the three-dimensional environment 700. For example, as shown in FIG. 7Z, the computer system 101 detects an air pinch and drag gesture performed by the hand 703 of the user 702, optionally while the attention (e.g., gaze 726) of the user 702 is directed to the representation 724a in the three-dimensional environment 700. In some embodiments, the air pinch portion of the air pinch and drag gesture is detected for more than the threshold amount of time discussed above prior to detecting the movement of the hand 703 of the user 702. In some embodiments, the movement input corresponds to and/or includes a request to move the representation 724a toward or to the user interface 736 (e.g., toward a front-facing surface of the user interface 736) from the viewpoint of the user 702. For example, as indicated in FIG. 7Z, the movement input includes movement of the hand 703 leftward relative to the viewpoint of the user 702 from a location corresponding to the virtual object 711 to a location corresponding to the user interface 736 in the three-dimensional environment 700.

In some embodiments, as shown in FIG. 7AA, in response to detecting the movement input directed to the representation 724a, the computer system 101 generates and displays representation 724c (e.g., a two-dimensional representation of the virtual asset 721a) in the user interface 736. For example, as shown in FIG. 7AA, the computer system 101 displays the representation 724c in the input region 737 in the user interface 736 in response to detecting the movement of the representation 724a to the surface of the user interface 736 (optionally to the location of the input region 737) in accordance with the movement of the hand 703. Additionally, in some embodiments, in response to detecting a release of the air pinch gesture (e.g., an end of the movement input provided by the hand 703), the computer system 101 redisplays the representation 724a at its prior location relative to the virtual object 711 in the three-dimensional environment 700 (e.g., the location of the representation 724a prior to detecting the movement input in FIG. 7Z), as shown in FIG. 7AA. In some embodiments, generating the two-dimensional representation of the virtual asset 721a that is displayed as the representation 724c in the user interface 736 includes transmitting data corresponding to the virtual asset 721a (e.g., a digital copy of the virtual asset 721a) and/or sharing the data with the messaging application with which the user interface 736 is associated at the computer system 101.

FIG. 8 is a flowchart illustrating an exemplary method 800 of facilitating interactions with one or more virtual assets associated with a vertical virtual object in a three-dimensional environment, including adding the one or more virtual assets for display on a horizontal virtual object in the three-dimensional environment in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors (e.g., processing units 202) of computer system 101 (e.g., control unit 110 in FIG. 1A). Some operations in method 800 are, optionally, combined and/or the order of some operations is, optionally, changed.

In some embodiments, a method 800 is performed at a first computer system (e.g., computer system 101 in FIG. 7A) in communication with one or more display generation components (e.g., display generation component 120) and one or more input devices (e.g., image sensors 114a-114c). In some embodiments, the computer system is or includes an electronic device, such as a mobile device (e.g., a tablet, a smartphone, a media player, or a wearable device), or a computer. In some embodiments, the one or more display generation components are one or more displays integrated with the computer system (optionally a touch screen display), one or more external displays such as a monitor, projector, television, or one or more hardware components (optionally integrated or external) for projecting a user interface or causing a user interface to be visible to one or more users. In some embodiments, the one or more input devices include an electronic device or component capable of receiving a user input (e.g., capturing a user input or detecting a user input) and transmitting information associated with the user input to the electronic device. Examples of input devices include an image sensor (e.g., a camera), location sensor, hand tracking sensor, eye-tracking sensor, motion sensor (e.g., hand motion sensor) orientation sensor, microphone (and/or other audio sensors), touch screen (optionally integrated or external), remote control device (e.g., external), another mobile device (e.g., separate from the electronic device), a handheld device (e.g., external), and/or a controller.

In some embodiments, while displaying, via the one or more display generation components, a first object (e.g., a first virtual object) including one or more representations of virtual assets (e.g., a three-dimensional model or other virtual object) in an environment (e.g., a three-dimensional environment), the first object having a first orientation relative to a current viewpoint of a user of the computer system, such as virtual object 720 that includes virtual assets 721a and 721b in three-dimensional environment 700 in FIG. 7A, the computer system detects (802), via the one or more input devices, a first input directed to a first representation of a first virtual asset of the one or more representations of virtual assets, such as air pinch and drag input provided by hand 703 directed to the virtual asset 721a as shown in FIG. 7B. In some embodiments, the environment is a three-dimensional environment that is generated, displayed, or otherwise caused to be viewable by the first computer system. For example, the environment is an extended reality (XR) environment, such as a virtual reality (VR) environment, a mixed reality (MR) environment, or an augmented reality (AR) environment. In some embodiments, the environment includes one or more virtual objects (e.g., the first object) and/or representations of real-world objects in a physical environment of a user of the computer system. The environment optionally has one or more characteristics of the environment described with reference to method 900. In some embodiments, the first object (e.g., and the one or more representations of virtual assets) is associated with a respective application (e.g., a content creation application, a content viewing application, and/or a content editing application) that is accessible by the user via the computer system. For example, the first object includes a user interface for displaying, storing, arranging, and/or manipulating (e.g., moving, scaling, and/or rotating) virtual assets. Additionally, or alternatively, for example, the first object includes a user interface for creating content, such as designing and/or arranging a group of virtual objects, such as arranging one or more representations of furniture (e.g., for designing a scene and/or a representation of a physical space that includes the furniture). In some embodiments, the virtual assets include three-dimensional and/or two-dimensional assets, such as images, videos, models and/or other objects (e.g., virtual objects and/or virtual representations of real-world objects). In some embodiments, the first orientation of the first object relative to the current viewpoint of the user corresponds to a vertical orientation in the environment relative to the current viewpoint of the user. For example, the computer system displays first object vertically relative to a ground and/or floor of the environment from the current viewpoint of the user. Alternatively, for example, the computer system displays first object parallel to a vector corresponding to a direction of gravity in the environment. In some embodiments, displaying the first object with the first orientation includes displaying the first object with a respective amount of tilt or angular rotation that causes the front-facing surface (e.g., the front plane described below) of the first object to visually appear to be tilted toward or away from the viewpoint of the user in the environment. The first object optionally has one or more characteristics of the first object described with reference to method 900. In some embodiments, the computer system displays the one or more representations of virtual assets within the first object in the three-dimensional environment. For example, the first object includes a virtual boundary (e.g., the computer system displays the first object as a virtual window having a perimeter), and the computer system displays the one or more representations of virtual assets within the virtual boundary of the first object. For example, the computer system displays that first object as a virtual portal that includes the one or more representations of virtual assets (e.g., the first object includes a view of a three-dimensional space including the one or more representations of virtual assets). For example, the first object includes a (e.g., flat) front plane, and the computer system displays the one or more representations of virtual assets aligned with and/or extending behind the front plane in depth (e.g., backward or away from the front plane) in the environment from the current viewpoint of the user. In some embodiments, the first input includes a selection input directed to the first representation of the first virtual asset. For example, the first input includes attention (e.g., by gaze, hand position, and/or cursor) directed to the first representation of the first virtual asset and optionally a hand gesture (e.g., including movement), such as an air pinch or an air tap (e.g., an air multi-tap, such as a double-tap or triple-tap). In some embodiments, the first input includes an input detected on a hardware input device of the computer system, such as on a controller in communication with the computer system. For example, the first input includes a button press, movement of a joystick, and/or a touch input on a touch-sensitive surface. The first input optionally includes movement of an input element (e.g., a hand and/or controller). For example, while the first representation of the first virtual asset is selected (e.g., the computer system detects the selection input described above and detects continued performance of an air gesture associated with the selection input, such as an air pinch), the computer system detects movement of the input element (e.g., movement of a hand that is performing an air gesture, such as an air pinch). In some embodiments, in response to detecting movement of the input element while the first representation of the first virtual asset is selected, the computer system moves the first representation of the first virtual asset in the environment (e.g., in accordance with the movement of the input element, such that the movement of the input element controls the movement of the first representation of the first virtual asset in the environment).

In some embodiments, in response to detecting the first input, in accordance with a determination that the first input satisfies one or more first criteria (804), such as the movement of the virtual asset 721a exceeding a front plane of the virtual object 720 as indicated in depth glyph 712 in FIG. 7C, the computer system displays (806), via the one or more display generation components, a second object, (e.g., a second virtual object) different from the first object, in the environment, the second object having a second orientation, different from the first orientation, relative to the current viewpoint of the user, such as virtual object 711 in FIG. 7D. In some embodiments, the one or more first criteria include a selection criterion. In some embodiments, the first input satisfies the selection criterion when the first input corresponds to selection of a representation of the one or more representations of virtual assets (e.g., the first input is a selection input directed to a representation of the one or more representations, such as the selection input being directed to the first representation of the first virtual asset described above). In some embodiments, the one or more first criteria include a movement criterion (e.g., in addition to the selection criterion). For example, the first input satisfies the movement criterion when the first input when the computer system detects a selection input (e.g., selection of a representation of the one or more representations of virtual assets, as described above) and movement of an input element (e.g., hand movement while the hand continues to perform an air gesture associated with the selection input, such as an air pinch) that exceeds a threshold amount (e.g., in a respective direction, such as in a direction toward the current viewpoint of the user). For example, during the first input, movement of the first representation of the first virtual asset is controlled by an input element (e.g., a hand of the user and/or a controller), and the movement criterion is satisfied when the computer system moves the first representation of the first virtual asset (in accordance with movement of the input element) to a location in the environment that is outside (e.g., or at least partially outside) of the first object (e.g., in front of the front plane of the first object from the viewpoint of the user). In some embodiments, the computer system determines the one or more first criteria are satisfied while detecting the first input (e.g., while the first representation of the first virtual asset is selected and/or while movement of the first representation of the first virtual asset is controlled by an input element). In some embodiments, the computer system determines the one or more first criteria are satisfied during and/or after detecting an end of the first input (e.g., while and/or after detecting termination of an air gesture, such as an air pinch).

In some embodiments, the second object is associated with the respective application described above. In some embodiments, the computer system does not display the second object in the environment prior to detecting the first input and/or prior to the determination that the one or more first criteria are satisfied (e.g., before detecting the first input, the computer system displays the first object without displaying the second object in the environment). In some embodiments, the second orientation of the second object relative to the current viewpoint of the user corresponds to a horizontal orientation in the environment relative to the current viewpoint of the user. For example, the computer system displays the second object horizontal relative to a ground and/or floor of the environment from the current viewpoint of the user. For example, the computer system displays the second object orthogonal relative to a vector corresponding to gravity (e.g., orthogonal to the first object) in the environment. In some embodiments, the computer system displays the second object in the environment concurrently with the first object (e.g., the computer system displays the second object at the second orientation while displaying the first object at the first orientation). In some embodiments, the computer system displays the second object at a predetermined location in the environment (e.g., the computer system displays the second object at a default location in the environment in accordance with the determination that the one or more first criteria are satisfied). For example, the computer system displays the second object at a center of a field-of-view of the user relative to the current viewpoint of the user. In some embodiments, the computer system displays the second object at a depth (e.g., a distance) that is in front of the front plane of the first object from the current viewpoint of the user (e.g., such that a portion of the virtual boundary of the second object that is farthest from the current viewpoint of the user is in front of or aligned with the front plane of the first object in the environment). In some embodiments, the computer system displays the second object at a height that is below (e.g., and/or aligned with a bottom portion of the virtual boundary of) the first object in the environment from the current viewpoint of the user. The second object optionally has one or more characteristics of the second object described with reference to method 900. In some embodiments, while displaying the first object and the second object concurrently in the environment, the computer system displays a visual indication of the second object (e.g., within the first object) having one or more characteristics of the first visual indication described with reference to method 900.

In some embodiments, the computer system displays (808), via the one or more display generation components, the first representation of the first virtual asset of the one or more representations of virtual assets relative to the second object in the environment, such as the display of representation 724a relative to the virtual object 711 as shown in FIG. 7D. In some embodiments, during the first input, as similarly discussed above, the movement of the first representation of the first virtual asset is controlled by an input element (e.g., hand and/or controller), and the computer system displays the first representation of the first virtual asset at a location in the three-dimensional environment that is based on the movement of the input element detected during the first input (e.g., the computer system moves the first representation of the first virtual asset by a distance, magnitude (e.g., speed), and/or direction that is based on a distance, magnitude (e.g., speed), and/or direction of movement of the input element). For example, the computer system displays the first representation of the first virtual asset at a location that is outside (and/or at least partially outside) of the first object, as described above, and optionally in front of the front plane of the first object from the current viewpoint of the user. In some embodiments, the second object includes a (e.g., flat) top plane and includes a virtual boundary (e.g., as described above with reference to the first object), and displaying the first representation of the first virtual asset relative to the second object includes displaying the first representation of the first virtual asset above the top plane of the second object and inside the virtual boundary of the second object from the current viewpoint of the user. In some embodiments, while the computer system displays the first representation of the first virtual asset relative to the second object, the computer system displays a second representation, different from the first representation, of the first virtual asset within the first object (e.g., as described above with reference to the first representation of the first virtual asset). For example, before detecting the first input, the computer system displays the first representation of the first virtual asset within the first object with a first visual appearance (e.g., with a first amount of opacity, color, brightness, and/or clarity, and/or at a first depth within the first object from the current viewpoint of the user), and during and/or after detecting the end of the first input (e.g., when the computer system determines the one or more first criteria are satisfied), the computer system displays the second representation of the first virtual asset with a second visual appearance, different from the first visual appearance (e.g., with a second amount, different from the first amount, of opacity, color, brightness, and/or clarity, and/or at a second depth, different from the first depth, within the first object from the current viewpoint of the user) in the environment. Displaying content relative to (e.g., above) a horizontal virtual object in a three-dimensional environment in response to selection and/or movement of the content from a vertical virtual object in the three-dimensional environment enables a user to selectively manipulate and/or arrange the content in three-dimensions, which enhances the ability for the user to accurately arrange the content and avoid erroneous inputs directed to the content and/or the vertical virtual object, thereby improving user-device interaction and conserving computing resources associated with correcting erroneous inputs.

In some embodiments, displaying the first object including the one or more representations of the virtual assets in the environment includes displaying, via the one or more display generation components, a view of the one or more representations of the virtual assets within a three-dimensional space associated with the first object, such as the virtual assets 721a and 721b being displayed within a three-dimensional space of the virtual object 720 as illustrated by depth glyph 712 in FIG. 7A. For example, the computer system displays the first object as a portal into the three-dimensional space (e.g., the first object is or includes a virtual window that the three-dimensional space, and the one or more representations of the virtual assets, is visible through from the current viewpoint of the user). In some embodiments, the three-dimensional space is a virtual environment including the one or more representations of the virtual assets. In some embodiments, displaying the first object including the one or more representations of the virtual assets in the environment includes displaying, via the one or more display generation components, the one or more representations of the virtual assets behind (e.g., and/or at least partially aligned with) a front plane of the first object from the current viewpoint of the user (e.g., the front plane of the first object has one or more characteristics of the front plane described above). For example, the computer system displays the three-dimensional space, including the one or more representations of the virtual assets, behind the front plane of the first object from the current viewpoint of the user. In some embodiments, the one or more representations of the virtual assets include a plurality of representations of virtual assets, and the computer system displays the plurality of representations of virtual assets within the three-dimensional space and behind and/or at least partially aligned with the front plane of the first object from the current viewpoint of the user. For example, the computer system displays the plurality of representation of virtual assets aligned with the front plane of the first object such that each representation of a virtual asset of the plurality of representation of virtual assets each visually appear to be the same size (e.g., and/or displayed at the same scale) in the first object from the current viewpoint of the user. In some embodiments, the one or more representations of the virtual assets include a plurality of representations of virtual assets, and the computer system displays the plurality of representations of virtual assets within the three-dimensional space at different depths from the front plane of the first object (e.g., the computer system displays a first respective representation of a virtual asset at a first depth relative to the current viewpoint of the user, and displays a second respective representation of a virtual asset, different from the first respective representation of the virtual asset, at a second depth, different from (e.g., greater or less than), the first depth relative to the current viewpoint of the user). In some embodiments, the first representation of the first virtual asset (and/or the one or more representations of the one or more virtual assets) corresponds to a three-dimensional representation of an object (e.g., a three-dimensional virtual object and/or a virtual representation of a three-dimensional real-world object), and at least a portion (e.g., a side, surface, and/or a point of a surface) of the first representation of the first virtual asset is displayed aligned with (e.g., and/or within a threshold distance of, such as 0.001. 0.005, 0.01, 0.02, 0.05, or 0.1 meters) the front plane of the first object from the current viewpoint of the user. In some embodiments, while the computer system displays the first representation of the first virtual asset relative to the second object in the environment, the computer system displays a visual indication of the second object in the first object (e.g., as described with reference to method 900). In some embodiments, the one or more representations of the virtual assets include one or more second representations of one or more second virtual assets different from the first representation of the first virtual asset, and, while the computer system displays the first representation of the first virtual asset relative to the second object, the computer system displays the visual indication of the second object in the three-dimensional space at a greater distance (e.g., a greater depth from the front plane of the first object) from the current viewpoint of the user than the one or more second representations of the one or more second virtual assets. Displaying a representation of a virtual asset within a three-dimensional space that is associated with a virtual object in a three-dimensional environment provides a user a three-dimensional preview of the virtual asset prior to the user selecting the representation of the virtual asset for further manipulation in the three-dimensional environment, and visually indicates to the user that the representation of the virtual asset is associated with the virtual object (e.g., to differentiate the representation of the virtual asset from different content displayed outside of the virtual object in the environment), thereby improving user-device interaction, reducing errors in interaction, and conserving computing resources associated with correcting erroneous input.

In some embodiments, displaying the first representation of the first virtual asset relative to the second object in the environment includes displaying the first representation of the first virtual asset in the environment above a top plane of the second object from the current viewpoint of the user, such as the display of the representation 724a above a top plane of the virtual object 711 as illustrated in top-down view 710 in FIG. 7D. In some embodiments, the top plane of the second object has one or more characteristics of the top plane described above. In some embodiments, the first representation of the first virtual asset is displayed within a region of the environment defined (e.g., at least partially) by the second object. For example, the region of the environment corresponds to a three-dimensional region of the environment that is above the surface area of the top plane of the second object (e.g., the size and/or volume of the region is determined at least in part by the surface area of the top plane of the second object). The region of the environment is optionally not defined by the first object (e.g., the region of the environment corresponds to a three-dimensional space above the top plane of the second object from the current viewpoint of the user, independent of a current location of the first object in the environment). In some embodiments, the first representation of the first virtual asset is displayed within a region of the environment at least partially defined by the first object and the second object. For example, the region of the environment corresponds to a three-dimensional region of the environment that is above the surface area of the top plane of the second object and in front of the surface area of the front plane of the first object from the current viewpoint of the user (e.g., the computer system displays the first object vertically relative to a ground of the environment (or other reference, such as gravity), the second object horizontally relative to the ground of the environment, and the first representation of the first virtual asset within a three-dimensional space of the environment that is both above the second object and in front of the first object from the current viewpoint of the user). In some embodiments, the computer system displays the first representation of the first virtual asset at a respective distance above the top plane of the second object in the environment. For example, the respective distance is a predefined distance (e.g., the computer system displays the second object at the respective distance above the top plane by default when the one or more first criteria are satisfied). Alternatively, in some embodiments, the respective distance is a user-defined distance (e.g., the computer system displays the second object at a respective distance above the top plane in response to the first input (e.g., based on the movement of the input element detected during the first input prior to and/or when detecting the end of the first input)). Displaying content above a top plane of a horizontal virtual object in a three-dimensional environment in response to selection and/or movement of the content from a vertical virtual object in the three-dimensional environment enables a user to selectively manipulate and/or arrange the content in three-dimensions, which enhances the ability for the user to accurately arrange the content and avoid erroneous inputs directed to the content and/or the vertical virtual object, thereby improving user-device interaction and conserving computing resources associated with correcting erroneous inputs.

In some embodiments, displaying the second object in the environment includes displaying, via the one or more display generation components, the second object concurrently with the first object in the environment, such as the concurrent display of the virtual objects 720 and 711 in the three-dimensional environment 700 as shown in FIG. 7D. In some embodiments, the computer system does not display the second object in the environment prior to the determination that the one or more first criteria are satisfied. In some embodiments, displaying the second object in accordance with the determination that the one or more first criteria are satisfied includes maintaining display of the first object in the three-dimensional environment. In some embodiments, the computer system displays the first object vertically relative to a ground (or other reference such as gravity) of the environment while displaying the second object horizontally relative to the ground of the environment. For example, in accordance with the determination that the one or more first criteria are satisfied, the computer system displays the second object at a height in the environment that is below and/or aligned with a bottom portion (e.g., a bottom of a perimeter, side, and/or edge) of the first object (e.g., such that the second object does not visually obstruct the first object) from the current viewpoint of the user. In some embodiments, in accordance with the determination that the one or more first criteria are satisfied, the computer system displays the second object centered relative to the first object in the environment relative to the current viewpoint of the user (e.g., and/or optionally centered relative to the field-of-view of the user). In some embodiments, the computer system displays the second object with the same size in the environment as the first object (e.g., the second object includes the same surface area as the first object), while displaying the second object and the first object with the different orientations as discussed above. Alternatively, in some embodiments, the computer system displays the second object with a different size in the environment than the second object. In some embodiments, the computer system displays the first object at a location in the environment that is farther from the current viewpoint of the user than at least a portion of the second object. For example, while displaying the second object in the environment, the computer system displays the first object at a location that is behind and/or aligned with a rear portion of the virtual boundary of the second object from the current viewpoint of the user. In some embodiments, the first object and/or the second object are (e.g., independently) selectable and/or movable in the environment in response to user input, as discussed in more detail below. Displaying content relative to (e.g., above) a horizontal virtual object in a three-dimensional environment while concurrently displaying a vertical virtual object in the three-dimensional environment that the content was previously selected and moved from visually indicates to a user that the content may be moved back to the vertical virtual object, thereby reducing errors in interaction and conserving computing resources associated with correcting erroneous inputs.

In some embodiments, while displaying the first representation of the first virtual asset relative to the second object, the computer system displays, via the one or more display generation components, a second representation, different from the first representation, of the first virtual asset in the first object in the environment, such as concurrently displaying the virtual asset 721a in the virtual object 720 and the representation 724a on the virtual object 711 as shown in FIG. 7D. In some embodiments, the computer system displays the second representation of the first virtual asset in the first object in response to detecting the first input (e.g., and in accordance with a determination that the one or more first criteria are satisfied at the end of the first input). In some embodiments, while displaying the first representation of the first virtual asset relative to the second object, the computer system does not display the first representation of the first virtual asset in the first object (e.g., the computer system does not display the first representation of the first virtual asset and second representation of the first virtual asset concurrently within the first object). In some embodiments, while displaying the first representation of the first virtual asset relative to the second object, the computer system displays a visual indication of the second object in the first object (e.g., the visual indication has one or more characteristics of the first visual indication of the second object described with reference to method 900). For example, the second representation of the first representation is included within or is otherwise associated with the visual indication of the second object. In some embodiments, the second representation of the first virtual asset includes one or more visual characteristics different from the first representation of the first virtual asset. For example, the computer system displays the first representation of the first virtual asset with a first visual characteristic (e.g., size, color, saturation, sharpness, brightness, and/or opacity) of a first value and the second representation of the first virtual asset with the first visual characteristic of a second value, different from the first value. In some embodiments, while displaying the first representation of the first virtual asset in the first object (e.g., prior to detecting the first input), the computer system displays the first representation of the first virtual asset at a first location in the first object, and while displaying the second representation of the first virtual asset in the first object (e.g., after detecting the end of the first input), the computer system displays the second representation of the first virtual asset at a second location, different from the first location, in the first object. For example, the first object includes a view of a three-dimensional space (e.g., as described above), and the computer system displays the first representation of the first virtual asset at a different depth within the three-dimensional space than the second representation of the first virtual asset from the current viewpoint of the user. In some embodiments, while the computer system displays the first representation of the first virtual asset in the first object (e.g., prior to detecting the first input), the first representation of the first virtual asset is independently selectable (e.g., in response to a selection and/or movement input described above), and while the computer system displays the second representation of the first virtual asset in the first object (e.g., after detecting the first input), the second representation of the first object is not independently selectable. For example, in response to detecting a selection and/or movement input directed at the first representation of the first virtual asset while displaying the first representation of the first virtual asset within the first object, the computer system moves the first representation of the first virtual asset within the first object without moving other representations of virtual assets and/or visual indications included in the first object (e.g., the first representation of the first virtual asset may be moved independently of other representations and/or visual indications displayed concurrently within the first object). For example, in response to detecting a selection and/or movement input directed at the second representation of the first virtual asset while displaying the second representation of the first virtual asset within the first object, the computer system moves the visual indication of the second object, including (e.g., concurrently and/or together with) the second representation of the first virtual asset, in the first object (e.g., the second representation of the first virtual asset may not be moved within the first object without also moving the visual indication of the second object). In some embodiments, the first representation of the first virtual asset is selectable and/or movable from (e.g., to a location in the environment outside of) the first object (e.g., in response to an input that satisfies the one or more first criteria), and the second representation of the first virtual asset is not selectable and/or movable from the first object. Displaying a representation of content in a vertical virtual object while displaying the content relative to a horizontal virtual object in a three-dimensional environment provides a user a visual indication and/or visual feedback of a current state of interaction with the content relative to the horizontal virtual object, thereby reducing errors in interaction and conserving computing resources associated with erroneous inputs.

In some embodiments, the first input corresponds to a request to move the first representation of the first virtual asset in the environment, and the one or more first criteria include a criterion that is satisfied when a movement of the first representation of the first virtual asset causes at least a portion of the first representation of the first virtual asset to exceed a front plane of the first object from the current viewpoint of the user, such as the movement of the virtual asset 721a exceeding the front plane of the virtual object 720 as shown in the depth glyph 712 in FIG. 7C. For example, the criterion has one or more characteristics of the movement criterion of the one or more first criteria described above. In some embodiments, the front plane of the first object has one or more characteristics of the front plane of the first object described above. In some embodiments, the first input includes selection and movement of the first representation of the first virtual asset (e.g., as described above). For example, while the computer system detects the first input, movement of the first representation of the first virtual asset is controlled by an input element (e.g., hand and/controller), and the criterion is satisfied when movement of the input element causes at least a portion of the first representation of the first virtual asset to move through the front plane of the first object from the current viewpoint of the user (e.g., the criterion is satisfied when the computer system displays, in response to movement of the input element, a portion of the first representation of the first virtual asset outside of the first object). For example, the movement of the first representation of the first virtual asset through the front plane of the first object in the environment is toward to the current viewpoint of the user (e.g., such that the first representation of the first virtual asset moves closer to the current viewpoint of the user in the environment and/or the computer system displays at least a portion of the first representation of the first virtual asset outside of the first object in the environment). The criterion is optionally satisfied when the movement of the first representation of the first virtual asset causes the entire first representation of the first virtual asset to exceed the front plane of the first object from the current viewpoint of the user (e.g., and/or the movement of the first representation of the first virtual asset causes the entire first representation of the first virtual asset to be displayed outside of the first object from the current viewpoint of the user), rather than requiring solely a portion of the first representation of the first virtual asset extending outside of the first object. In some embodiments, the movement of the first representation of the first virtual asset includes movement in a direction toward the current viewpoint of the user (e.g., the movement of the input element causes the computer system to move the first representation of the first virtual asset to a location in the environment closer to the current viewpoint of the user). For example, the movement criterion is satisfied when the movement of the first representation of the first virtual asset exceeds a threshold amount (e.g., 0.005, 0.01, 0.02, 0.05, 0.1, or 0.5 m) in the direction toward the current viewpoint of the user. Displaying content relative to (e.g., above) a horizontal virtual object in a three-dimensional environment in response to an input directed to the content that satisfies a movement criterion prevents display of the horizontal virtual object when a user does not intend to manipulate and/or arrange the content in three-dimensions, thereby reducing errors in interaction and conserving computing resources.

In some embodiments, in accordance with a determination that the first input does not satisfy the one or more first criteria, the computer system forgoes displaying the second object in the environment (e.g., and maintaining display of the first representation of the first virtual asset in the first object and/or moving the first representation of the first virtual asset in the first object), such as the virtual object 711 not being displayed in the three-dimensional environment 700 in FIG. 7B until the virtual asset 721a exceeds the front plane of the virtual object 720 in FIG. 7C. In some embodiments, the first input does not satisfy the one or more first criteria because the movement of the first representation of the first virtual asset (e.g., that is controlled by movement of an input element, such as a hand or controller) does not cause at least a portion (e.g., and/or the entirety) of the first representation of the first virtual asset to exceed the front plane of the first object from the current viewpoint of the user (e.g., as described above). For example, while detecting the first input, the computer system moves the first representation of the first virtual asset within the first object (e.g., within the three-dimensional space of the first object described above) in accordance with movement of an input element without moving the first representation of the first virtual asset outside of the first object (e.g., without moving at least a portion of the first representation of the first virtual asset through the front plane of the first object). Forgoing displaying content relative to (e.g., above) a horizontal virtual object in a three-dimensional environment when input directed to the content does not satisfy one or more criteria prevents display of the horizontal virtual object in the environment when a user does not intend to manipulate and/or arrange the content in three-dimensions, thereby reducing errors in interaction and conserving computing resources.

In some embodiments, displaying the second object in the environment includes, while detecting the first input (e.g., while detecting movement of an input element and/or prior to detecting termination of the first input), and while the one or more first criteria are satisfied, displaying the second object in the environment with a first visual appearance, such as the virtual object 711 having a first visual appearance as indicated by dashed outline as illustrated in FIG. 7C. In some embodiments, the one or more first criteria are satisfied while the computer system continues to detect selection of the first representation of the first virtual asset via an input element, such as a hand and/or controller (e.g., the computer system determines the one or more first criteria are satisfied while movement of the first representation of the first virtual asset is controlled by the input element in the environment). For example, the one or more first criteria are satisfied while the computer system continues to detect the user performing an air gesture with their hand (e.g., an air pinch) while optionally moving their hand. For example, while the computer system detects selection of the first representation of the first virtual asset, the computer system detects movement of an input element corresponding to movement of the first representation of the first virtual asset in the environment that causes at least a portion of the first representation of the first virtual asset to exceed a front plane of the first object (e.g., as described above). In some embodiments, while detecting the first input, the computer system continuously determines if the one or more first criteria are satisfied. In some embodiments, while detecting the first input, in accordance with a determination that the one or more first criteria are no longer satisfied (e.g., at least a portion of the first representation of the first virtual asset no longer exceeds a front plane of the first object), the computer system ceases display of the second object in the environment. In some embodiments, displaying the second object in the environment with the first visual appearance includes displaying the second object with a first level of visual prominence relative to the environment. For example, displaying the second object with the first level of visual prominence includes displaying the second object with a first amount of opacity, color, saturation, brightness, and/or sharpness in the environment. In some embodiments, displaying the second object with the first visual appearance in the environment includes displaying an outline or other visual indication of the virtual boundary (e.g., perimeter) of the second object in the environment while optionally displaying the remaining (e.g., interior) surface area of the second object as at least partially transparent (e.g., 25, 50, 75, or 95 percent of fully transparent).

In some embodiments, in response to detecting an end of the first input (e.g., in response to detecting termination of an air gesture performed by the user of the computer system, such as detecting termination of an air pinch) while the one or more first criteria are satisfied, the computer system displays the second object in the environment with a second visual appearance, different from the first visual appearance, such as the virtual object 711 having the second visual appearance as indicated by solid outline as illustrated in FIG. 7D. In some embodiments, displaying the second object in the environment with the second visual appearance includes displaying the second object with a second level of visual prominence, greater than the first level of visual prominence, relative to the environment. For example, displaying the second object with the second level of visual prominence includes displaying the second object with a second amount, greater than the first amount, of opacity, color, saturation, brightness, and/or sharpness in the environment. In some embodiments, in accordance with a determination that the one or more first criteria are satisfied at a first time period (e.g., the first input satisfies the one or more criterion described above, such as the movement criterion), the computer system displays the second object in the environment with the first visual appearance, and in accordance with a determination that one or more second criteria, different from the one or more first criteria, are satisfied at a second time period, after the first time period, the computer system displays the second object in the environment with the second visual appearance. For example, the one or more first criteria include a criterion that is satisfied when a movement of the first representation of the first virtual asset while the first representation of the first virtual asset is selected (e.g., while the computer system detects an air gesture, such as an air pinch, performed by a hand of the user) causes at least a portion (e.g., and/or the entirety) of the first representation of the first virtual asset to exceed a front plane of the first object from the current viewpoint of the user (e.g., as described above), and the one or more second criteria include a criterion that is satisfied when the computer system detects an end of the first input (e.g., the computer system detects termination of the air gesture) while at least a portion (e.g., and/or the entirety) of the first representation of the first virtual asset exceeds the front plane of the first object from the current viewpoint of the user. Displaying a virtual object with a first visual appearance in a three-dimensional environment when one or more criteria are satisfied while detecting an input and with a second visual appearance, different from the first visual appearance, when detecting an end of the input while the one or more criteria are satisfied provides a visual indication that the virtual object will be displayed in the environment in response to ending the input (e.g., providing a predictable result to ending the input), thereby reducing errors in interaction and conserving computing resources associated with correcting erroneous inputs.

In some embodiments, while displaying the second object at a first location in the environment, and while the first representation of the first virtual asset has a first spatial relationship with (e.g., a location and/or orientation relative to) the second object, such as a spatial relationship between representation 724d and virtual object 719 in FIG. 7R, the computer system detects, via the one or more input devices, a second input corresponding to a request to move the second object to a second location, different from the first location, in the environment, such as the air pinch and drag input provided by the hand 703 (e.g., including gaze of the user) directed to the movement element 732b associated with virtual object 719 as shown in FIG. 7V. In some embodiments, displaying the first representation of the first virtual asset and the second object with the first spatial relationship includes displaying the first representation of the first virtual asset at a location in the environment that is above a top plane of the second object from the current viewpoint of the user (e.g., as described above). For example, the first spatial relationship includes an orientation and/or location of the first representation of the first virtual asset relative to the top plane of the second object. In some embodiments, the second input has one or more characteristics of the first input described above. For example, the second input includes a selection input (e.g., having one or more characteristics of a selection input described above) directed to the second object and/or to a virtual element displayed concurrently with the second object (e.g., the virtual element is selectable to move the second object in the environment, such as a grabber bar displayed beneath and/or in front of the second object in the environment from the current viewpoint of the user). In some embodiments, detecting the second input includes detecting movement of an input element (e.g., via a controller and/or hand) while the second object is selected (e.g., movement of a hand is detected while an air gesture, such as an air pinch, is performed by the hand). For example, while detecting the second input, the computer system moves the second object in accordance with the movement of the input element (e.g., the input element controls the second object such that the direction and/or velocity of movement of the second object corresponds to the direction, magnitude, and/or velocity of movement of the input element).

In some embodiments, in response to (e.g., and/or while) detecting the second input, the computer system moves the second object to the second location in accordance with the second input, such as the movement of the virtual object 719 in accordance with the movement of the hand 703 as shown in FIG. 7S, while maintaining the first spatial relationship between the first representation of the first virtual asset and the second object in the environment, such as maintaining the spatial relationship between the representation 724d and the virtual object 719 as shown in FIG. 7W. In some embodiments, the movement of the second object from the first location in the environment to the second location in the environment corresponds to movement of an input element detected during the second input (e.g., as described above). For example, the computer system moves the second object in the environment while detecting the second input (e.g., while detecting the movement of the input element while the second object is selected). In some embodiments, maintaining the first spatial relationship between the first representation of the first virtual asset and the second object in the environment includes moving the first representation of the first virtual asset with the second object in response to detecting the second input (e.g., moving the first representation of the first virtual asset by the same direction, magnitude (e.g., of distance), and/or speed as the second object in the environment). For example, maintaining the first spatial relationship between the first representation of the first virtual asset and the second object includes maintaining the location and/or orientation of the first representation of the first virtual asset relative to the second object while the computer system moves the second object from the first location to the second location in the environment. Moving the second object from the first location to the second location in the environment optionally includes maintaining the second orientation of the second object in the environment (e.g., the computer system enables lateral and/or horizontal movement of the second object and optionally does not enable changing the orientation (e.g., rotation) of the second object in the environment). Displaying content relative to (e.g., above) a horizontal virtual object in a three-dimensional environment such that the content can be manipulated and/or arranged in three-dimensions while maintaining a spatial relationship between the content and the horizontal virtual object when moving the horizontal virtual object maintains the user's intended three-dimensional arrangement of the content, which reduces errors in interaction and conserves computing resources associated with inputs to correct changes in the arrangement of the content.

In some embodiments, the first object is displayed at a third location (e.g., and at the first orientation), different from the first location, in the environment while the second object is displayed at the first location (e.g., and at the second orientation) in the environment, such as the location of the virtual object 720 and the different location of the virtual object 719 in the three-dimensional environment 700 as illustrated in top-down view 710 in FIG. 7V. For example, displaying the first object at the third location in the environment includes displaying the first object above and/or behind at least a portion of the second object in the environment from the current viewpoint of the user.

In some embodiments, while moving the second object to the second location in response to detecting the second input, the computer system maintains display, via the one or more display generation components, of the first object at the third location in the environment, such as maintaining the location of the virtual object 720 in the three-dimensional environment 700 after the movement of the virtual object 719 as illustrated in the top-down view 710 in FIG. 7W. In some embodiments, in response to detecting the second input (e.g., in response to detecting movement of an input element while the second object is selected), the computer system forgoes moving the first object in the environment. In some embodiments, while moving the second object (and the first representation of the first virtual asset) in the environment in accordance with movement of an input element, the computer system maintains display of the first object at the third location in the environment. For example, the computer system moves the second object independently of the first object in the environment in response to detecting the second input. In some embodiments, while concurrently displaying the first object and the second object in the environment, the computer system detects a third input corresponding to a request to move the first object in the environment. In some embodiments, in response to detecting the third input, the computer system moves the first object in the environment in accordance with the input and maintains display of the second object without moving the second object in the environment in accordance with the input (e.g., the first object may be moved independently of the second object in the environment). Maintaining a location of a vertical virtual object in a three-dimensional environment while moving a horizontal virtual object and content that is displayed relative to (e.g., above) the horizontal virtual object provides a user greater freedom to manipulate and/or arrange the content in three-dimensions in the three-dimensional environment without being restricted by the location of the vertical virtual object, which enhances the ability for the user to accurately arrange the content as intended, thereby improving user-device interaction and conserving computing resources associated with correcting erroneous inputs.

In some embodiments, while displaying the first representation of the first virtual asset relative to the second object, wherein the first representation of the first virtual asset has a first spatial relationship with (e.g., a first location and/or first orientation relative to) the second object in the environment, such as the spatial relationship between the representation 724a and the virtual object 711 in FIG. 7J, the computer system detects, via the one or more input devices, a second input corresponding to a request to move the first representation of the first virtual asset in the environment, such as the air pinch and drag gesture provided by the hand 703 (e.g., including gaze of the user) directed to the representation 724a in the three-dimensional environment 700 as shown in FIG. 7J. In some embodiments, displaying the first representation of the first virtual asset with the first spatial relationship with the second object includes displaying the first representation of the first virtual asset at a location that is above a top plane of the second object in the environment from the current viewpoint of the user (e.g., as described above). In some embodiments, the second input has one or more characteristics of the second input described above. For example, the second input includes a selection input (e.g., having one or more characteristics of the selection input described above) directed to the first representation of the first virtual asset and/or a virtual element that the computer system displays concurrently with the first representation of the first virtual asset (e.g., the virtual element is selectable to move the first representation of the first virtual asset in the environment). In some embodiments, detecting the second input includes detecting movement of an input element (e.g., hand and/or controller), as described above. For example, while detecting the second input, the computer system moves the first representation of the first virtual asset in the environment in accordance with the movement of the input element.

In some embodiments, in response to (e.g., and/or while) detecting the second input, the computer system moves the first representation of the first virtual asset relative to the second object (e.g., and forgoing moving the second object) such that the first representation of the first virtual asset has a second spatial relationship, different from the first spatial relationship, with (e.g., the first virtual asset has a second location and/or second orientation, different from the first location and/or first orientation, relative to) the second object in the environment, such as the movement of the representation 724a relative to the virtual object 711 as shown in FIG. 7L. In some embodiments, moving the first representation of the first virtual asset relative to the second object includes moving the first representation of the first virtual asset in the environment while maintaining the location of the second object in the environment. For example, moving the first representation of the first virtual asset relative to the second object includes changing a location and/or orientation of the first representation of the first virtual asset relative to the second object in the environment (e.g., while the computer system displays the second object above a top plane of the second object from the current viewpoint of the user). In some embodiments, moving the first representation of the first virtual asset relative to the second object includes moving the first representation of the first virtual asset within a three-dimensional space of the environment defined by the second object. For example, the three-dimensional space is a volume of the environment that includes one or more dimensions defined by the surface area of the top plane of the second object (e.g., a length and/or width of the volume corresponds to the surface area of the second object). For example, the three-dimensional space of the environment corresponds to a volume of the environment that is above the top plane of the second object from the current viewpoint of the user. In some embodiments, the movement of the first representation of the first virtual asset relative to the second object includes movement within the three-dimensional space defined by the second object and does not include movement of the first representation of the first virtual asset to a location outside of the three-dimensional space defined by the second object (e.g., the movement of the first representation of the first virtual asset does not correspond to movement to a location that is outside of a volume of the environment that is defined by (e.g., above and within) the virtual perimeter of the top plane of the second object from the current viewpoint of the user). For example, in accordance with a determination that the second input corresponds to a request to move the first representation of the first virtual asset to a location outside of the three-dimensional space of the environment defined by the surface area of the top plane of the second object, the computer system forgoes moving the first representation of the first virtual asset to the location outside of the three-dimensional space (e.g., and maintains display of the first representation of the first virtual asset within the three-dimensional space and/or above the surface area of the second object in the environment from the current viewpoint of the user). Moving content that is displayed relative to (e.g., above) a horizontal virtual object in a three-dimensional environment in response to user input enables a user to selectively manipulate and/or arrange the content in three-dimensions, which enhances the ability for the user to accurately arrange the content and avoids erroneous inputs directed to the content, thereby improving user-device interaction and conserving computing resources associated with correcting erroneous inputs.

In some embodiments, moving the first representation of the first virtual asset relative to the second object in response to (e.g., and/or while) detecting the second input includes, in accordance with a determination that movement of the first representation of the first virtual asset relative to the second object corresponds to movement of the first representation of the first virtual asset to a boundary associated with the second object (e.g., movement of the representation 724a to a boundary of the virtual object 711 in FIG. 7K), displaying, via the one or more display generation components, a visual effect corresponding to the boundary associated with the second object in the environment, such as the display of the visual indication 734 in the three-dimensional environment 700 as shown in FIG. 7K. For example, the computer system detects and/or determines that the second input above, such as the movement of the hand of the user while maintaining the air pinch gesture, corresponds to and/or causes the computer system to move the first representation of the first virtual asset to within a threshold distance (e.g., 0.05, 0.1, 0.2, 0.3, 0.5, 1, 1.5, 2, 3, 5, 10, or 20 cm) of a boundary of the second object in the three-dimensional environment from the viewpoint of the user. In some embodiments, the computer system detects and/or determines that the second input includes an air pinch gesture that is performed for less than a threshold amount of time (e.g., 0.5, 1, 1.5, 2, 3, 5, 8, or 10 seconds). In some embodiments, as similarly described above, the computer system moves the first representation of the first virtual asset while detecting the second input (e.g., while detecting the movement of the hand of the user). In some embodiments, the boundary associated with the second object corresponds to and/or is defined by the three-dimensional space discussed above. For example, as described above, the three-dimensional space is a volume of the environment that includes one or more dimensions defined by the surface area of the top plane of the second object (e.g., a length and/or width of the volume corresponds to the surface area of the second object). In some embodiments, the three-dimensional space of the environment corresponds to a volume of the environment that is above the top plane of the second object from the current viewpoint of the user. As such, the boundary associated with the second object is a (e.g., non-visible) edge and/or corner of the three-dimensional space of the second object, or other (e.g., non-visible) surface of the three-dimensional space of the second object (e.g., such as the top plane of the second object or an upper ceiling or plane of the three-dimensional space above the top plane of the second object).

In some embodiments, as discussed above, the computer system limits the movement of the first representation of the first virtual asset to remain within the three-dimensional space of the second object (e.g., to not exceed the boundary associated with the second object in the environment). Accordingly, in some embodiments, the computer system moves the first representation of the first virtual asset toward (e.g., and/or within the threshold distance of) the boundary associated with the second object but limits any movement of the first representation of the first virtual asset beyond the boundary in the environment. In some embodiments, when the first representation of the first virtual asset is moved to the boundary associated with the second object, the computer system displays a visual effect corresponding to the boundary in the environment, which provides a visual indication that the movement of the first representation of the first virtual asset has reached a limit of movement. In some embodiments, the visual effect corresponding to the boundary includes a glow effect, a highlighting effect, a ray or orbing effect, and/or other visual treatment that is added to the boundary in the environment. In some embodiments, the visual effect is displayed at a location along the boundary that corresponds to the portion of the boundary with which the first representation of the first virtual asset intersects and/or is proximate to (e.g., within the threshold distance of). For example, if the first representation of the first virtual asset is moved to a corner of the second object in the three-dimensional environment, the computer system displays the visual effect at and/or along the corner of the second object in the three-dimensional environment (e.g., and without moving the first representation of the first virtual asset beyond the corner of the second object). Similarly, if the first representation of the first virtual asset is moved to an edge or side of the second object in the environment, the computer system optionally displays the visual effect at and/or along the edge or side of the second object in the three-dimensional environment (e.g., and without moving the first representation of the first virtual asset beyond the edge or side of the second object). In some embodiments, a duration of the display of the visual effect in the environment is based on detection of the second object by the computer system. For example, the computer system maintains display of the visual effect corresponding to the boundary associated with the second object while the first representation of the first virtual asset remains located at the boundary and while the computer system continues to detect the air pinch gesture provided by the hand of the user. Accordingly, in some embodiments, if the computer system detects termination of the second input (e.g., a release of the air pinch gesture, such that the hand of the user is no longer in the pinch hand shape), the computer system ceases display of the visual effect corresponding to the boundary associated with the second object (e.g., irrespective of whether the first representation of the first virtual asset is still positioned at the boundary when termination of the second input is detected). Similarly, in some embodiments, while continuing to detect the second input, if the computer system determines that the movement of the first representation of the first virtual asset corresponds to movement away from the boundary associated with the second object (e.g., more than the threshold distance from the boundary), the computer system ceases display of the visual effect when the first representation of the first virtual asset is moved away from the boundary in the environment in accordance with the second input. Displaying a visual effect corresponding to a boundary of a horizontal virtual object when moving content that is displayed relative to (e.g., above) the horizontal virtual object to the boundary of the horizontal virtual object in a three-dimensional environment in response to user input provides visual feedback to the user regarding movement limits of the content relative to the horizontal virtual object, which enhances the ability for the user to accurately arrange the content and avoids erroneous inputs directed to the content, thereby improving user-device interaction and conserving computing resources associated with correcting erroneous inputs.

In some embodiments, the visual effect corresponding to the boundary has one or more first visual characteristics that are based on one or more second visual characteristics of the first representation of the first virtual asset in the environment, such as the visual indication 734 having visual characteristics that are based on the visual characteristics of the representation 724a as described with reference to FIG. 7K. For example, a visual appearance of the visual effect corresponding to the boundary is adapted to a visual appearance of the first representation of the first virtual asset in the three-dimensional environment. Particularly, in some embodiments, the computer system adapts one or more first visual characteristics of the visual effect, such as a shape and/or form of the visual effect, a color of the visual effect, a size of the visual effect, and/or an intensity or brightness of the visual effect, to one or more second visual characteristics of the first representation of the first virtual asset, such as a shape and/or dimensionality of the first representation, a color of the first representation, a size of the first representation, and/or a brightness of the first representation, in the three-dimensional environment. For example, if the first representation of the first virtual asset is a rectangular virtual object (e.g., or is a virtual object having sharp and defined corners and edges), the visual effect corresponding to the boundary is displayed as being linear or planar to compliment the sharp edges and corners of the rectangular virtual object. Alternatively, in some embodiments, if the first representation of the first virtual asset is a spherical virtual object (e.g., or is a virtual object having smooth and/or rounded corners and/or edges), the visual effect corresponding to the boundary is displayed as being nonlinear and/or rounded to compliment the smooth and rounded edges and/or corners of the spherical virtual object. As another example, if the first representation of the first virtual asset is an irregularly shaped virtual object (e.g., is a virtual object having a combination of sharp and well-defined corners and rounded and/or smooth edges), the visual effect corresponding to the boundary is displayed as being irregularly shaped to compliment the combination of sharp and smooth surfaces and/or edges of the irregularly shaped virtual object. In some embodiments, the one or more first visual characteristics of the visual effect corresponding to the boundary are configured to be dynamically adjusted as the particular portions of the first representation of the first virtual asset that are intersecting and/or proximate to the boundary change (e.g., in response to user input). For example, while displaying the visual effect corresponding to the boundary associated with the second object in the environment, if the computer system detects further movement and/or rotation of the first representation of the first virtual asset relative to the second object and that causes a different portion of the first representation of the first virtual asset to be positioned at the boundary and/or at a different portion of the boundary, such that the one or more second visual characteristics of the first representation at the boundary are updated, the computer system updates the visual appearance of the visual effect based on the different portion of the first representation (e.g., to have a different color, to be more smooth or more linear, to be brighter, and/or to be smaller in size). Displaying a visual effect corresponding to a boundary of a horizontal virtual object and that is visually based on visual characteristics of content that is displayed relative to (e.g., above) the horizontal virtual object at the boundary of the horizontal virtual object in a three-dimensional environment in response to user input provides visual feedback to the user regarding movement limits of the content relative to the horizontal virtual object, which enhances the ability for the user to accurately arrange the content and avoids erroneous inputs directed to the content, thereby improving user-device interaction and conserving computing resources associated with correcting erroneous inputs.

In some embodiments, the second object is associated with one or more boundaries in the environment (e.g., defined by a three-dimensional space or volume of the second object, as discussed above), and moving the first representation of the first virtual asset relative to the second object in response to (e.g., and/or while) detecting the second input includes, in accordance with a determination that the second input includes an air pinch gesture (e.g., performed by the hand of the user) that satisfies one or more timing criteria and that the movement of the first representation of the first virtual asset corresponds to movement of the first representation of the first virtual asset beyond a respective boundary of the one or more boundaries (e.g., the movement input directed to the representation 724a performed by the hand 703 that includes an air pinch gesture for more than a threshold amount of time in FIG. 7Z), moving the first representation of the first virtual asset beyond the respective boundary in the environment in accordance with the second input, such as the movement of the representation 724a beyond the boundary of the virtual object 711 as described with reference to FIG. 7AA. For example, the one or more timing criteria include a criterion that is satisfied when, at the time the computer system detects the user perform the air pinch gesture, the user holds and/or maintains the air pinch gesture for at least a threshold amount of time (e.g., 0.5, 1, 1.5, 2, 3, 5, 8, or 10 seconds), and optionally prior to detecting any movement of the hand of the user in space relative to the viewpoint of the user. In some embodiments, the one or more timing criteria include a criterion that is satisfied when, at the time the computer system detects the user perform the air pinch gesture, the attention (e.g., gaze) of the user remains directed toward the first representation of the first virtual asset while the air pinch gesture is maintained for the threshold amount of time above. In some embodiments, after detecting the air pinch gesture performed by the hand of the user and that is maintained for at least the threshold amount of time (e.g., thereby satisfying the one or more timing criteria), the computer system detects movement of the hand of the user, optionally while the hand of the user continues to remain in the air pinch hand shape. In some embodiments, as previously described herein above, the movement of the hand of the user corresponds to movement of the first representation of the first virtual asset relative to the second object in the environment and toward a respective boundary associated with the second object in the environment. For example, as similarly described above, the computer system detects movement of the first representation of the first virtual asset to within a threshold distance (e.g., 0.05, 0.1, 0.2, 0.3, 0.5, 1, 1.5, 2, 3, 5, 10, or 20 cm) of the respective boundary associated with the second object in the three-dimensional environment, after the one or more timing criteria have been satisfied. In some embodiments, the respective boundary of the one or more boundaries associated with the second object has one or more characteristics of the boundary associated with the second object described above. In some embodiments, because the one or more timing criteria are satisfied when and/or while the second input is detected, the computer system forgoes restricting and/or limiting the movement of the first representation of the first virtual asset to being within the one or more boundaries (e.g., the three-dimensional space or volume) associated with the second object in the environment. As such, the computer system optionally allows the user to move the first representation of the first virtual asset beyond the one or more boundaries, including the respective boundary, associated with the second object, and thus forgoes displaying a visual effect corresponding to the boundary (e.g., as described above) in the environment. For example, because the computer system forgoes limiting the movement of the first representation of the first virtual asset to being within the three-dimensional space or volume defining the one or more boundaries of the second object, the computer system does not display a visual indication of the one or more boundaries when and/or as the first representation of the first virtual asset is moved into and/or beyond the one or more boundaries in the three-dimensional environment. In some embodiments, moving the first representation of the first virtual asset beyond the respective boundary requires that the computer system continue to detect the second input (e.g., the air pinch gesture being performed by the user of the computer system). For example, moving the first representation of the first virtual asset beyond the respective boundary enables the user to add the first representation of the first virtual asset (e.g., a version or copy of the first virtual asset) to another virtual object, such as the first object, or user interface in the three-dimensional environment, as discussed in more detail below. However, in some embodiments, if the first representation of the first virtual asset is located at a position that is outside of the one or more boundaries associated with the second object, and the computer system detects termination of (e.g., release of) the second input, without and/or prior to detecting movement of the first representation of the first virtual asset to another virtual object in the environment, the computer system redisplays the first representation of the first virtual asset at is prior position relative to the second object (e.g., prior to detecting the second input described above). Thus, as outlined above, the computer system provides for two different inputs (e.g., an air pinch and drag gesture versus a long air pinch and drag gesture) that enables the user to perform two different, but similar operations at the computer system, notably moving a representation of a virtual asset relative to the horizontal virtual object (e.g., the second object) while keeping the representation of the virtual asset restricted to the horizontal virtual object or freely moving the representation of the virtual asset beyond the boundaries of the horizontal virtual board, as desired. Allowing for movement of content that is displayed relative to (e.g., above) a horizontal virtual object to a location that is beyond a boundary of the horizontal virtual object in a three-dimensional environment in response to user input that satisfies one or more timing criteria reduces the number of inputs required to move the content beyond the boundary of the horizontal virtual object, which enhances the ability for the user to accurately arrange the content or perform further operations involving the content, thereby improving user-device interaction and conserving computing resources associated with correcting erroneous inputs.

In some embodiments, while displaying the first representation of the first virtual asset relative to the second object in the environment, the computer system detects, via the one or more input devices, a second input directed to a second representation of a second virtual asset, different from the first representation of the first virtual asset, such as the air pinch and drag gesture performed by the hand 703 (e.g., including gaze of the user) directed to virtual asset 721b in the virtual object 720 as shown in FIG. 7E. In some embodiments, the second representation of the second virtual asset has one or more characteristics of the first representation of the first virtual asset described above. In some embodiments, the second representation of the second virtual asset is a representation of the one or more representations of virtual assets included in the first object. For example, prior to the computer system detecting the second input, the computer system is displaying the second representation of the second virtual asset within the first object in the environment (e.g., as described above). In some embodiments, the second representation of the second virtual asset is a representation of a virtual asset the computer system displays outside of the first object and the second object in the environment (e.g., the second representation of the second virtual asset is not included within the first object and/or is not displayed relative to (e.g., over the top plane of) the second object in the environment from the current viewpoint of the user). For example, the computer system displays the first representation of the first virtual asset within a region of the environment defined at least partially by the second object (e.g., as described above), and the computer system displays the second representation of the second virtual asset outside of the region of the environment (e.g., the computer system displays the second representation of the second virtual asset in a respective object displayed at the first orientation and/or relative to a respective object displayed at the second orientation in the environment). In some embodiments, the second input has one or more characteristics of the first input described above. For example, the second input corresponds to a selection and movement input (e.g., as described above) directed to the second representation of the second virtual asset (e.g., while the computer system displays the second representation of the second virtual asset within the first object or while the computer system displays the second representation of the second virtual asset at a location separate from the first object and the second object). For example, the second input corresponds to a request to move the second representation of the second virtual asset from a location separate from (e.g., outside of) the first object and the second object (e.g., from a respective object different from the first object and the second object) to the first object and/or the second object. In some embodiments, the second input corresponds to a request to move the second representation of the second virtual asset from the first object to a three-dimensional space above a top plane of the second object (e.g., the second input has one or more characteristics of the first input described above). In some embodiments, prior to displaying the second representation of the second virtual asset relative to the second object in the environment, the computer system requires movement of the second representation of the second virtual asset to the first object. For example, prior to detecting the second input, the computer system detects a third input corresponding to a request to move the second representation of the second virtual asset from a location separate from the first object and second object in the environment to within the first object (e.g., such that prior to detecting the second input, the computer system displays the second representation of the second virtual asset in the first object in the environment).

In some embodiments, in response to detecting the second input, in accordance with a determination that the second input satisfies one or more second criteria, the computer system displays, via the one or more display generation components, the second representation of the second virtual asset relative to the second object in the environment, such as displaying representation 724b relative to the virtual object 711 in the three-dimensional environment 700 as shown in FIG. 7G. In some embodiments, displaying the second representation of the second virtual asset relative to the second object has one or more characteristics of displaying the first representation of the first virtual asset relative to the second object described above. In some embodiments, displaying the second representation of the second virtual asset relative to the second object includes displaying the second representation of the second virtual asset in a region of the environment defined by the second object (e.g., as described above) concurrently with the first representation of the first virtual asset. In some embodiments, the one or more second criteria have one or more characteristics of the one or more first criteria described above. For example, the one or more second criteria include a selection criterion and/or movement criterion (e.g., as described above). In some embodiments, the one or more second criteria include a criterion that is satisfied when the second representation of the second virtual asset is included in the first object in the environment (e.g., prior to detection of the second input). For example, the criterion is not satisfied when the second input corresponds to a request to move the second representation of the second virtual asset to the three-dimensional space above the top plane of the second object from a location that is not within the first object in the environment. In some embodiments, in accordance with a determination that the second input does not satisfy the one or more second criteria, the computer system forgoes displaying the second representation of the second virtual asset relative to the second object (e.g., and maintains display of the second representation of the second virtual asset within the first object and/or outside of the region of the environment defined at least partially by the second object). Displaying a second representation relative to (e.g., above) a horizontal virtual object in a three-dimensional environment while a first representation is displayed relative to the horizontal virtual object enables a user to selectively manipulate and/or arrange the first and second representation relative to one another in three-dimensions, which enhances the ability for the user to accurately arrange the representations and avoid erroneous inputs directed to the representations, thereby improving user-device interaction and conserving computing resources associated with correcting erroneous inputs.

In some embodiments, in response to detecting an end of the first input, and while displaying the second object in the environment (e.g., and while displaying the first representation of the first virtual asset relative to the second object), the computer system displays, in the first object, a first visual indication of the second object, such as display of visual indication 711a in virtual object 720 as shown in FIG. 7D, wherein the first visual indication has a first visual appearance in the environment (e.g., and includes a second representation of the first virtual asset), such as the visual appearance of the visual indication 711a indicated by dashed outline in the virtual object 720 as shown in FIG. 7D. In some embodiments, displaying the first visual indication of the second object in the first object has one or more characteristics of displaying the first visual indication of the second object in the first object described with reference to method 900. In some embodiments, displaying the first visual indication with the first visual appearance in the environment has one or more characteristics of displaying the first visual indication with the first visual appearance in the environment described with reference to method 900. Displaying a visual indication in a three-dimensional environment of a horizontal virtual object that content is displayed relative to (e.g., above) within a vertical virtual object provides the user with visual feedback regarding interaction with the content associated with the horizontal virtual object, which reduces errors in interactions and conserves computing resources associated with correcting erroneous inputs.

In some embodiments, while displaying the second object in the environment (e.g., at the second orientation), and while displaying the first visual indication having the first visual appearance in the first object, the computer system detects, via the one or more input devices, a second input corresponding to a request to cease display of the second object in the environment, such as selection of close option displayed with movement element 732 provided by the hand 703 as shown in FIG. 7O. In some embodiments, the second input corresponding to the request to cease display of the second object in the environment has one or more characteristics of the second input corresponding to the request to cease display of the second object in the environment as described with reference to method 900.

In some embodiments, in response to detecting the second input, the computer system ceases display, via the one or more display generation components, of the second object in the environment, such as ceasing display of the virtual object 711 in the three-dimensional environment 700 as shown in FIG. 7P. In some embodiments, ceasing display of the second object in the environment has one or more characteristics of ceasing display of the second object in response to detecting the second input as described with reference to method 900.

In some embodiments, the computer system updates display of the first visual indication of the second object in the first object to have a second visual appearance, different from the first visual appearance, in the environment, such as the visual appearance of the visual indication 711a indicated by solid outline in the virtual object 720 as shown in FIG. 7P. In some embodiments, updating display of the first visual indication of the second object in the first object to have the second visual appearance has one or more characteristics of updating the display of the first visual indication of the second object in the first object to have the second visual appearance as described with reference to method 900. Changing a visual appearance of a visual indication of a horizontal virtual object that content is arranged relative to (e.g., above) in a three-dimensional environment within a vertical virtual object based on whether the horizontal object is actively displayed (e.g., outside of the vertical virtual object) in the three-dimensional environment provides the user with a visual indication of the state of interaction with the content associated with the horizontal virtual object, thereby avoiding erroneous inputs and improving user-device interaction.

In some embodiments, while (e.g., and/or prior to) detecting the second input, the first representation of the first virtual asset is displayed with a first spatial relationship with the second object in the environment, such as the spatial relationship between the representation 724a and the virtual object 711 in the three-dimensional environment 700 as shown in FIG. 7O. For example, the computer system displays the first representation of the first virtual asset at a first location and/or first orientation relative to the second object in the environment (e.g., while the computer system displays the first representation of the first virtual asset in a region of the environment above a top plane of the second object from the current viewpoint of the user), as similarly described above.

In some embodiments, after detecting the second input and while displaying the first visual indication of the second object having the second visual appearance in the first object, the computer system detects, via the one or more input devices, a third input directed to the first visual indication of the second object, such as the air pinch and drag gesture provided by the hand 703 directed to the visual indication 711a in the virtual object 720 as shown in FIG. 7U. In some embodiments, the third input has one or more characteristics of the first input described above. For example, the third input includes selection and/or movement of the first visual indication of the second object (e.g., the computer system detects a request to select and/or move the first visual indication of the second object in the environment performed via an input element, such as a controller and/or hand).

In some embodiments, in accordance with a determination that the third input satisfies the one or more first criteria (e.g., including the criterion described above), the computer system displays, via the one or more display generation components, the second object in the environment, such as display of the virtual object 711 in the three-dimensional environment 700 as shown in FIG. 7V. In some embodiments, displaying the second object in the environment has one or more characteristics of displaying the second object in the environment described above with reference to the first input. In some embodiments, in accordance with the determination that the third input satisfies the one or more first criteria, the computer system displays the first visual indication of the second object with the first visual appearance in the first object, as described above (e.g., the computer system displays the first visual indication of the second object with the first visual appearance while concurrently displaying the second object in the environment). In some embodiments, displaying the first visual indication of the second object with the first visual appearance in the first object includes displaying a second representation, different from the first representation, of the first virtual asset in the first object (e.g., having one or more characteristics of the second representation of the first virtual asset described above).

In some embodiments, the computer system displays, via the one or more display generation components, the first representation of the first virtual asset with the first spatial relationship with the second object in the environment, such as the spatial relationship between the representation 724a and the virtual object 711 being maintained in the three-dimensional environment 700 as shown in FIG. 7V. In some embodiments, displaying the first representation of the first virtual asset with the first spatial relationship with the second object includes displaying the first representation of the first virtual asset relative to the second object as described above (e.g., in a region of the environment that is above a top plane of the second object from the current viewpoint of the user). In some embodiments, in accordance with the determination that the third input satisfies the one or more first criteria, the computer system displays the first representation of the first virtual asset at the first location and/or first orientation relative to the second object in the environment (e.g., the computer system displays the first representation of the first virtual asset at the same location and/or orientation relative to the second object in the environment that the first representation of the first virtual asset was displayed at while and/or prior to detecting the second input). In some embodiments, in accordance with a determination that the third input does not satisfy the one or more first criteria, the computer system forgoes displaying the second object in the environment (e.g., and maintains display of the first visual indication of the second object with the second visual appearance in the first object). Displaying content relative to (e.g., above) a horizontal virtual object in response to user input directed to the content in a three-dimensional environment with the same spatial relationship with the horizontal virtual object that the content was previously displayed with enables a user to save three-dimensional arrangements of the content, thereby improving user-device interaction and conserving computing resources associated with unnecessary inputs for re-arranging the content.

In some embodiments, while displaying the first representation of the first virtual asset in the first object, the first representation of the first virtual asset corresponds to a visual indication of a plurality of virtual objects having a first spatial arrangement, such as the virtual object 720 including a group of virtual assets including virtual assets 721d and 721e and visual indication 719a as shown in FIG. 7R, wherein the virtual assets 721d and 721e have a first spatial arrangement with the visual indication 719a. In some embodiments, the visual indication of the plurality of virtual objects has one or more characteristics of the first visual indication of the second object having the second visual appearance described with reference to method 900. In some embodiments, the plurality of virtual objects is or includes virtual representations of real-world objects (e.g., furniture) and/or representations of computer-generated elements (e.g., characters, avatars, and/or virtual personas). In some embodiments, the computer system previously displayed the plurality of virtual objects relative to the second object in the environment. For example, prior to detecting the first input, the computer system displays the plurality of virtual objects relative to the second object in the environment (e.g., having one or more characteristics of displaying the first representation of the first virtual asset relative to the second object as described above). For example, while the computer system displays the plurality of virtual objects relative to the second object with the first spatial arrangement (e.g., a shared spatial arrangement between the plurality of virtual objects, such as a distance between the virtual objects and/or the position of each virtual object of the plurality of virtual objects relative to the second object), the computer system detects an input corresponding to a request to cease display of the second object in the environment (e.g., having one or more characteristics of the second input corresponding to the request to cease display of the second object described with reference to method 900). For example, in response to detecting the input corresponding to the request to cease display of the second object in the environment, the computer system ceases to display the second object in the environment and displays the visual indication of the plurality of virtual objects in the first object. Alternatively, for example, the computer system displays the visual indication of the plurality of virtual objects in the first object with a first visual appearance (e.g., at a first location in the first object, and/or with a first value of color, size, brightness, sharpness, and/or opacity) while displaying the plurality of virtual objects relative to the second object, and in response to detecting the input corresponding to the request to cease display of the second object in the environment, the computer system ceases display of the second object in the environment and displays the visual indication of the plurality of virtual objects in the first object with a second visual appearance, different from the first visual appearance (e.g., at a second location, different from the first location, and/or with a second value of color, size, brightness, sharpness, and/or opacity, different from the first value). In some embodiments, the first spatial arrangement of the plurality of virtual objects is user-defined. For example, while the computer system previously displayed the plurality of virtual objects relative to the second object in the environment, the computer system arranged (e.g., moved) one or more virtual objects of the plurality of virtual objects into the first spatial arrangement in response to user input (e.g., in response to detecting selection and/or movement inputs directed to one or more virtual objects of the plurality of virtual objects).

In some embodiments, displaying the first representation of the first virtual asset relative to the second object includes displaying the plurality of virtual objects in the environment relative to the second object, the plurality of virtual objects having the first spatial arrangement, such as displaying representations 724d and 724e with the same first spatial arrangement with the virtual object 719 in the three-dimensional environment 700 as shown in FIG. 7S. In some embodiments, the computer system displays the plurality of virtual objects with the same shared spatial arrangement that the computer system previously displayed the plurality of virtual objects with relative to the second object in the environment (e.g., when the second object was previously displayed in the environment). For example, the computer system displays each virtual object of the plurality of virtual objects at the same position in the environment relative to the second object as they were previously displayed (e.g., prior to the computer system detecting the input corresponding to the request to cease display of the second object described above). In some embodiments, the computer system displays the plurality of virtual objects in the first spatial arrangement while displaying the plurality of virtual objects in a region of the environment above the top plane of the second object from the current viewpoint of the user. In some embodiments, while the computer system displays the plurality of virtual objects relative to the second object in the environment, the plurality of virtual objects is individually selectable and/or movable in response to user input (e.g., such that the computer system changes the spatial arrangement of the plurality of virtual objects in response to the user input). Displaying a plurality of virtual objects in a respective spatial arrangement relative to (e.g., above) a horizontal virtual object in a three-dimensional environment in response to user input directed to a visual indication of the plurality of virtual objects having the respective spatial arrangement enables the user to further visualize the respective spatial arrangement of the plurality of virtual objects in three-dimensions, which enhances the ability for the user to accurately arrange the plurality of virtual objects and avoids erroneous inputs, thereby improving user-device interaction and conserving computing resources associated with correcting erroneous inputs.

In some embodiments, while displaying the plurality of virtual objects in the environment relative to the second object in accordance with the determination that the first input satisfies the one or more first criteria in response to detecting the first input, the computer system detects, via the one or more input devices, a second input directed to a first virtual object of the plurality of virtual objects, such as the air pinch and drag gesture provided by the hand 703 directed to the representation 724e in the three-dimensional environment 700 in FIG. 7S. In some embodiments, the second input includes selection and/or movement of the first virtual object. For example, detecting the second input includes detecting attention (e.g., by gaze, cursor, and/or hand position) directed to the first virtual object and/or an air gesture (e.g., an air pinch) performed with a hand. For example, detecting the second input includes detecting a hardware input (e.g., via a button, trigger, and/or joystick) of a controller. In some embodiments, while the first virtual object is selected (e.g., while the computer system detects the second input, including a user performing an air pinch with a hand, or actuation of a hardware input device of a controller), the computer system detects movement of an input element (e.g., the hand and/or controller). For example, while the computer system detects the second input (e.g., while the first virtual object is selected), the computer system moves the first virtual object in the environment in accordance with the movement of the input element.

In some embodiments, in response to detecting the second input, in accordance with a determination that the second input satisfies one or more second criteria, such as the representation 724e being moved through the front plane of the virtual object 720 in the three-dimensional environment 700 as indicated by the depth glyph 712 in FIG. 7T, the computer system ceases display, via the one or more display generation components, of the first virtual object relative to the second object in the environment, such as ceasing display of the representation 724e relative to the virtual object 719 in the three-dimensional environment 700 as shown in FIG. 7T. In some embodiments, the one or more second criteria include a selection criterion (e.g., having one or more characteristics of the selection criterion described above). In some embodiments, the one or more second criteria include a movement criterion (e.g., having one or more characteristics of the movement criterion described above) optionally in addition to the selection criterion. In some embodiments, the one or more second criteria are satisfied when movement of the first virtual object in the environment causes at least a portion of the first virtual object to exceed and/or move through the front plane of the first object (e.g., into the first object) in the environment from the current viewpoint of the user. For example, during the second input, the computer system moves the first virtual object in accordance with movement of an input element (e.g., hand and/or controller) in a direction away from a current viewpoint of the user (e.g., from above the top plane of the second object toward the front plane of the first object from the current viewpoint of the user). In some embodiments, the one or more second criteria are satisfied when movement of the first virtual object in the environment causes the computer system to display the entire first virtual object within the first virtual object (e.g., within the view of the three-dimensional space associated with the first object described above). For example, the computer system does not display the first virtual object in a region of the environment above a top plane of the second object. For example, the computer system does not display the first virtual object outside of the first object in the environment.

In some embodiments, the computer system displays, via the one or more display generation components, a representation of the first virtual object in the first object, such as displaying virtual asset 721e in the virtual object 720 as shown in FIG. 7T. In some embodiments, displaying the representation of the first virtual object in the first object includes one or more characteristics of displaying the one or more representations of virtual assets in the first object as described above. In some embodiments, displaying the representation of the first virtual object in the first object includes displaying the representation of the first virtual object at a location within the first object that is based on movement of an input element during the second input. For example, while and/or after moving the representation of the first virtual object to the first object during the second input, the computer system detects an end of the second input, and in accordance with a determination that the computer system is displaying the representation of the first virtual object at a first location in the first object when the end of the second input is detected, displaying the representation of the first virtual object in the first object includes displaying the representation of the first virtual object at the first location in the first object. In some embodiments, in accordance with a determination that the second input does not satisfy the one or more second criteria, the computer system maintains display of the first virtual object relative to the second object in the environment and forgoes displaying the representation of the first virtual object in the first object. For example, the computer system maintains display of the first virtual object relative to the second object in the environment. In some embodiments, while displaying the plurality of virtual objects relative to the second object with the first spatial arrangement in the environment, the computer system displays a visual indication of the second object that includes a representation of the plurality of virtual objects, and displaying the representation of the first virtual object in the first object in accordance with the determination that the second input satisfies the one or more second criteria includes removing a respective representation of the first virtual object (e.g., included in the representation of the plurality of virtual objects) from the visual indication of the second object and displaying the representation of the first virtual object at a different location from the visual indication of the second object in the first virtual object (e.g., within the three-dimensional space associated with the first virtual object, as described above). Ceasing to display content relative to (e.g., above) a horizontal virtual object in a three-dimensional environment and displaying a representation of the content in a vertical virtual object in response to user input directed to the content that satisfies one or more criteria prevents the user from unintentionally ceasing to display the content relative to the horizontal virtual object and provides visual feedback of the operation, thereby improving user-device interaction, reducing errors in interaction, and conserving computing resources associated with correcting unintentional inputs.

In some embodiments, displaying the first object in the environment includes displaying the first object with a first virtual toolbar, such as toolbar 730 associated with the virtual object 720 in FIG. 7A, the first virtual toolbar including a first set of selectable options that is selectable to perform one or more first operations. In some embodiments, the first virtual toolbar is a virtual element the computer system displays concurrently with the first object in the environment. In some embodiments, the computer system displays the first virtual toolbar in the environment independent of whether the second object is displayed in the environment (e.g., the computer system displays the first virtual toolbar in the environment prior to detecting the first input and in accordance with the determination that the one or more first criteria are satisfied). In some embodiments, the first set of selectable options is selectable in response to a selection input (e.g., having one or more characteristics of a selection input described above). In some embodiments, the first set of selectable options includes an option that is selectable to change a size and/or scale of the current view of the one or more representations of virtual assets included in the first object (e.g., the option is selectable to zoom in and/or out of the current view of the one or more representations of virtual assets, optionally by a same amount or degree). In some embodiments, the first set of selectable options includes an option that is selectable to annotate (e.g., add a note or other user-defined label or marker to) the first object (e.g., and/or the one or more representations of the virtual assets included in the first object). In some embodiments, the first set of selectable options includes an option that is selectable to undo a previous movement and/or arrangement of a representation of the one or more representations of the virtual assets (e.g., to move a representation of a virtual asset back to a previously displayed position within the first object). In some embodiments, the first set of selectable options includes an option that is selectable to add one or more representations of virtual assets in the first object (e.g., by displaying a user interface for selecting one or more virtual assets to add to the first object). In some embodiments, the first set of selectable options includes an option to create and/or display a note user interface element within the first object (e.g., the note user interface element may be annotated in response to user interaction). In some embodiments, the first set of selectable options includes an option that is selectable to display a settings menu. For example, the settings menu is associated with the respective application that is associated with the first object and/or the second object (e.g., having one or more characteristics of the respective application described above). In some embodiments, the first set of selectable options includes an option that is selectable to change an amount of immersion of the first object in the environment (e.g., having one or more characteristics of the first selectable option of the first set of selectable options described below).

In some embodiments, displaying the second object in the environment includes displaying the second object with a second virtual toolbar (e.g., different from the first virtual toolbar), such as toolbar 713 associated with the virtual object 711 in FIG. 7D, the second virtual toolbar including a second set of selectable options, different from the first set of selectable options, that is selectable to perform one or more second operations (e.g., different from the one or more first operations). In some embodiments, second virtual toolbar has one or more characteristics of the first virtual toolbar. For example, the second virtual toolbar is a virtual element the computer system displays concurrently with the second object in the environment. In some embodiments, the computer system does not display the second virtual toolbar in the environment when the second object is not displayed in the environment. In some embodiments, the second set of selectable options includes one or more selectable options included in the first set of selectable options. For example, the first set of selectable options includes an option to undo a previous movement and/or arrangement of a representation of the one or more representations of virtual assets (e.g., as described above), and the second set of selectable options includes an option that is selectable to undo a previous movement and/or arrangement of one or more representations of virtual assets displayed relative to the second object in the environment. For example, the first set of selectable options includes an option that is selectable to create and/or display a note user interface element within the first object, and the second set of selectable options includes an option that is selectable to create and/or display a note user interface element in the environment relative to (e.g., above the top plane of) the second object. In some embodiments, the first virtual toolbar includes a greater number of selectable options than the second virtual toolbar (e.g., the one or more first operations include operations not included in the one or more second operations). For example, the first virtual toolbar includes an option that is selectable to annotate the first object (e.g., and/or the one or more representations of the virtual assets included in the first object), and the second virtual toolbar does not include an option to annotate the second object (e.g., and/or one or more representations of virtual assets displayed relative to the second object). For example, the first virtual toolbar includes an option to zoom in and/or out of a current view of the one or more representations of virtual assets in the first object, and the second virtual toolbar does not include an option to zoom in and/or zoom out of a current view of one or more representations of virtual assets displayed relative to the second object. For example, the first virtual toolbar includes an option to change a level of immersion of the first object in the environment (e.g., as described below), and the second virtual toolbar does not include an option to change a level of immersion of the second object in the environment. Displaying a first virtual toolbar associated with a first object in a three-dimensional environment that includes a first set of selectable options for interacting with the first object and a second virtual toolbar associated with a second object in the three-dimensional environment that includes a second set of selectable options for interacting with the second object visually indicates to a user the different operations that can be performed in association with each object, thereby improving user-device interaction, reducing errors in interaction, and conserving computing resources associated with erroneous inputs.

In some embodiments, while displaying the first object with a first level of immersion in the environment (e.g., with a first size, depth, and/or curvature), such as the level of immersion of the virtual object 720 illustrated in FIG. 7X, the computer system detects, via the one or more input devices, a second input directed to a first selectable option of the first set of selectable options, such as a selection of option 733 in the toolbar 730 provided by the hand 703 as shown in FIG. 7X. In some embodiments, the first selectable option is selectable to change a level of immersion of the first object in the environment. In some embodiments, a particular level of immersion of the first object corresponds to the angular range of the environment that is occupied by the first object (e.g., 9 degrees, 15 degrees, 30 degrees, 45 degrees, 60 degrees, 80 degrees, 100 degrees, 120 degrees, 160 degrees, 240 degrees, 275 degrees, 360 degrees, or another angular distance between opposite edges (e.g., a left and a right edge) of the first object from a location corresponding to the current viewpoint of the user), optionally independent of whether an edge of the first object is visible from a current viewpoint of the user. In some embodiments, a particular level of immersion corresponds to minimum immersion, low immersion, medium immersion, high immersion, or maximum immersion (e.g., 60 degrees of content displayed at low immersion, 120 degrees of content displayed at medium immersion, 180 degrees of content displayed at high immersion, or 360 degrees of content displayed at maximum immersion). In some embodiments, the maximum level of immersion corresponds to an angular range of the environment that is occupied by the first object that is a value less than 360 degrees, such as 180 degrees. In some embodiments, the level of immersion of the first object corresponds to a respective amount of field of view that the first object consumes. For example, when the computer system displays the first object at the first level of immersion, the first object occupies a first amount of the field of view of the user of the computer system. In some embodiments, displaying the first object with the first level of immersion includes displaying the first object as substantially flat (e.g., with no curvature) in the environment. In some embodiments, displaying the first object with the first level of immersion includes displaying the first object such that the entire first object is within the field of view of the user (e.g., the virtual boundary and/or edges of the first object are visible from the current viewpoint of the user). In some embodiments, displaying the first object with the first level of immersion includes displaying the first object at minimum and/or low immersion. In some embodiments, the second input is a selection input directed to the first selectable option. For example, detecting the second input includes detecting attention (e.g., by gaze, cursor, and/or hand position) directed to the first selectable option and optionally an air gesture (e.g., an air pinch performed by a hand) and/or a hardware input provided through a controller.

In some embodiments, in response to detecting the second input, the computer system displays, via the one or more display generation components, the first object with a second level of immersion, greater than the first level of immersion, in the environment (e.g., with a second size, depth, and/or curvature, greater than the first size, depth, and/or curvature), such as the increased level of immersion of the virtual object 720 in the three-dimensional environment 700 as shown in FIG. 7Y. In some embodiments, displaying the first object with the second level of immersion in response to detecting the second input includes increasing the angular range of the environment that is occupied by the first object compared to displaying the first object with the first level of immersion. In some embodiments, displaying the first object with the second level of immersion includes displaying the first object such that only a portion of (e.g., not the entire) first object is within the field of view of the user. In some embodiments, displaying the first object with the second level of immersion includes displaying the first object at a fixed level of immersion, such as maximum and/or high immersion. In some embodiments, while displaying the first object with the first level of immersion, a first set of representations of virtual assets is visible in the first object (e.g., within a view of a three-dimensional space associated with the first object, as described above) from the current viewpoint of the user, and while displaying the first object with the second level of immersion, the first set of representations of virtual assets and a second set of representations of virtual assets (e.g., in addition to and/or including the first set of representations of virtual assets) is visible in the first object (e.g., within the view of the three-dimensional space associated with the first object) from the current viewpoint of the user. For example, displaying the first object with the second level of immersion includes revealing one or more additional representations of virtual assets within the first object in the environment. In some embodiments, in accordance with the determination that the one or more first criteria are satisfied, the computer system displays the second object in the environment independent of the current level of immersion of the first object in the environment (e.g., independent of whether the computer system displays the first object with the first level of immersion or the second level of immersion). In some embodiments, the second set of selectable options included in the second virtual toolbar (e.g., that the computer system displays with the second object) does not include a selectable option for changing a level of immersion of the second object in the environment (e.g., the computer system does not permit the modification of the level of immersion of the second object in the environment). In some embodiments, while displaying the first object with the second level of immersion, the computer system detects a third input directed to the first selectable option of the first virtual toolbar. In some embodiments, in response to detecting the third input, the computer system redisplays, via the one or more display generation components, the first object with the first level of immersion in the environment. Increasing a level of immersion of a vertical virtual object in an environment that includes representations of virtual assets that are selectable to display relative to (e.g., above) a horizontal virtual object in an environment enables a user to selectively view the representations of virtual assets with greater detail (e.g., with a greater size and/or depth) and informs the user in deciding which representations of virtual assets to select for further manipulation and/or arrangement in three-dimensions relative to the horizontal virtual object, which improves user-device interaction and reduces errors in interaction.

In some embodiments, while displaying the second object in the environment, and while displaying a visual indication of one or more virtual objects in the first object, the computer system detects, via the one or more input devices, a second input directed to the visual indication of the one or more virtual objects, such as the air pinch and drag gesture provided by the hand 703 (e.g., including gaze of the user) directed to the visual indication 711a in the virtual object 720 as shown in FIG. 7U. In some embodiments, the visual indication of the one or more virtual objects has one or more characteristics of the visual indication of the plurality of virtual objects described above and/or the first visual indication of the second object having the second visual appearance described with reference to method 900. In some embodiments, the computer system displays the first representation of the first virtual asset (and optionally one or more additional representations of virtual assets) relative to the second object in the environment while detecting the second input. In some embodiments, the second input has one or more characteristics of the first input described above (e.g., the second input includes selection and/or movement of the visual indication of the one or more virtual objects).

In some embodiments, in response to detecting the second input, in accordance with a determination that the second input satisfies the one or more first criteria, the computer system displays, via the one or more display generation components, a third object in the environment having the second orientation relative to the current viewpoint of the user, wherein the third object is displayed in the environment concurrently with the second object (e.g., at different, optionally non-overlapping locations), such as concurrently displaying the virtual objects 711 and 719 in the three-dimensional environment 700 as shown in FIG. 7V. In some embodiments, the third object has one or more characteristics of the second object described above. For example, the third object includes the same size and/or dimensions as the second object (e.g., and/or with the same visual characteristics, such as color, brightness, saturation, and/or opacity). In some embodiments, the computer system concurrently displays the second object and the third object horizontally relative to a ground of the environment (or other reference, such as gravity). In some embodiments, displaying the third object in the environment includes displaying the one or more virtual objects relative to the third object in the environment. For example, displaying the one or more virtual objects relative to the third object in the environment includes one or more characteristics of displaying the first representation of the first virtual asset relative to the second object in the environment as described above (e.g., displaying the one or more virtual objects relative to the third object in the environment includes displaying the one or more virtual objects above a surface area of a top plane of the third object from the current viewpoint of the user). In some embodiments, the computer system displays the second object and the third object concurrently at respective locations in front of the first object from the current viewpoint of the user (e.g., the computer system displays a rear portion of the second object and/or third object in front and/or aligned with a front plane of the first object from the current viewpoint of the user). In some embodiments, the computer system displays the second object and the third object concurrently at respective locations below (e.g., and/or aligned with a bottom portion of) the first object from the current viewpoint of the user (e.g., the computer system displays a top plane of the second object and/or third object below and/or aligned with a bottom portion of the first object from the current viewpoint of the user).

In some embodiments, while displaying the second object and the third object in the environment, the computer system detects, via the one or more input devices, a third input corresponding to user interaction with a respective object (e.g., the second object or the third object) in the environment, such as the air pinch and drag gesture provided by the hand 703 directed to the movement element 732b associated with the virtual object 719 in the three-dimensional environment 700 as shown in FIG. 7V. For example, the third input corresponds to a request to move the respective object in the environment. For example, the third input corresponds to a request to manipulate and/or arrange one or more representations of virtual assets displayed relative to the respective object. For example, the third input corresponds to a request to add a representation of a virtual asset to be displayed relative to the respective object (e.g., the third input corresponds to selection and/or movement of a representation of a virtual asset from the first object that satisfies the one or more first criteria). For example, the third input corresponds to a request to cease displaying a representation of a virtual asset relative to the respective object in the environment (e.g., the third input corresponds to selection and/or movement of a representation of a virtual asset toward the first object that satisfies the one or more second criteria described above). For example, the third input corresponds to a request to cease display of the second object in the environment (e.g., having one or more characteristics of the second input corresponding to the request to cease display of the second object described above).

In some embodiments, in response to detecting the third input, in accordance with a determination that the third input corresponds to user interaction with the second object, the computer system performs an operation in association with the second object (e.g., moving the second object, manipulating one or more representations of virtual assets displayed relative to the second object, adding a representation of a virtual asset to be displayed relative to the second object, ceasing to display a representation of a virtual asset relative to the second object, and/or ceasing to display the second object) and forgoes performing the operation in association with the third object, such as the movement of the virtual object 719 in the three-dimensional environment 700 without moving the virtual object 711 as shown in FIG. 7W. For example, the user of the computer system is able to interact with the second object (e.g., and/or one or more representations of virtual assets associated with the second object, such as the one or more virtual objects, the computer system displays relative to the second object) in the environment independent of interacting with the third object in the environment (e.g., without interacting with the third object, such as moving the third object and/or manipulating the one or more virtual objects displayed relative to the third object in the environment).

In some embodiments, in accordance with a determination that the third input corresponds to user interaction with the third object, the computer system performs the operation in association with the third object (e.g., moving the third object, manipulating one or more representations of virtual assets displayed relative to the third object, adding a representation of a virtual asset to be displayed relative to the third object, ceasing to display a representation of a virtual asset relative to the third object, and/or ceasing to display the third object) and forgoes performing the operation in association with the second object, as similarly discussed above with reference to the movement of the virtual object 719 in FIG. 7W. For example, the user of the computer system is able to interact with the third object (e.g., and/or one or more representations of virtual assets the computer system displays relative to the third object) in the environment independent of interacting with the second object in the environment (e.g., without interacting with the second object, such as moving the second object and/or manipulating the one or more representations of virtual assets displayed relative to the second object in the environment). Displaying first content relative to (e.g., above) a first horizontal object in a three-dimensional environment and second content, different from the first content, relative to (e.g., above) a second horizontal object in the three-dimensional environment in response to user input, and enabling the user to independently interact with the first horizontal object and the second horizontal object, provides the user the ability to concurrently view different arrangements of content in three-dimensions and to compare and/or contrast different arrangements of content in real-time (e.g., to compare different furniture layouts of a model room of a house), thereby improving user-device interaction and reducing errors in interaction.

In some embodiments, the environment further includes a user interface (e.g., a virtual window) associated with a first application running on the computer system, such as user interface 736 in FIG. 7Z. For example, prior to and/or while the computer system is displaying the first object in the three-dimensional environment, the computer system is displaying the user interface in the three-dimensional environment. In some embodiments, the user interface is and/or includes a user interface of a messaging application, such as an email application, a text messages application, a social media application, or other direct messaging application. In some embodiments, the user interface is and/or includes a user interface of a files application, such as a repository of files, documents, images, video, and/or other data. In some embodiments, the user interface is and/or includes a user interface of a web-browsing application or other internet-based application. In some embodiments, the first application running on the computer system is different from the application with which the first object and/or the second object are associated with. For example, the first application is different from and/or is separate from the content creation application with which the first object and/or the second object are associated with in the three-dimensional environment. In some embodiments, the user interface is displayed at a different location in the environment from the first object and/or the second object.

In some embodiments, while concurrently displaying the first representation of the first virtual asset relative to the second object and the user interface associated with the first application in the environment, the computer system detects, via the one or more input devices, a second input corresponding to a request to move the first representation of the first virtual asset in the environment, wherein the second input includes an air pinch gesture satisfying one or more timing criteria (e.g., the one or more timing criteria described above), such as the movement input directed to the representation 724a provided by the hand 703 of the user 702 in FIG. 7Z. For example, the computer system is displaying the user interface and the first object in the three-dimensional environment when the second object is displayed in the three-dimensional environment. In some embodiments, the second input includes an air gesture performed by a hand of the user of the computer system, such as an air pinch and drag gesture, directed to the first representation of the first virtual asset that is displayed relative to (e.g., above) the horizontal virtual object in the environment. In some embodiments, the computer system detects the air pinch and drag gesture while the attention (e.g., including gaze) of the user is directed to the first representation of the first virtual asset in the environment. In some embodiments, detecting the second input includes detecting an air pinch gesture for at least a threshold amount of time (e.g., thereby satisfying the one or more timing criteria), as similarly described above. In some embodiments, detecting the second input includes detecting movement of the hand of the user in space relative to the viewpoint of the user, optionally while the hand of the user remains in the pinch hand shape.

In some embodiments, in response to detecting the second input, in accordance with a determination that the request to move the first representation of the first virtual asset in the environment corresponds to movement of the first representation of the first virtual asset to the user interface in the environment, such as the movement of the representation 724a toward the user interface 736 in FIG. 7Z, the computer system moves the first representation of the first virtual asset toward the user interface in the environment in accordance with the second input. For example, the computer system detects and/or determines that the second input above, such as the movement of the hand of the user while maintaining the air pinch gesture, corresponds to and/or causes the computer system to move the first representation of the first virtual asset to within a threshold distance (e.g., 0.05, 0.1, 0.2, 0.3, 0.5, 1, 1.5, 2, 3, 5, 10, or 20 cm) of the user interface in the three-dimensional environment from the viewpoint of the user. In some embodiments, as similarly described above, the computer system moves the first representation of the first virtual asset while detecting the second input (e.g., while detecting the movement of the hand of the user). In some embodiments, the movement of the first representation of the first virtual asset causes the first representation of the first virtual asset to be moved beyond a boundary associated with the second object (e.g., the three-dimensional space or volume of the second object as discussed above). For example, as described above, because the second input satisfies the one or more timing criteria, the computer system forgoes limiting and/or restricting the movement of the first representation of the first virtual asset to being within the boundary (e.g., the three-dimensional space or volume) associated with the second object in the environment. Accordingly, in some embodiments, in response to detecting the second input above, the computer system moves the first representation of the first virtual asset from the location of the second object in the environment to the location of the user interface in the environment.

In some embodiments, the computer system displays, via the one or more display generation components, a second representation (e.g., separate from the first representation) of the first virtual asset in the user interface in the environment, such as displaying representation 724c in the user interface 736 as shown in FIG. 7AA. For example, the computer system creates and/or generates a copy (e.g., a duplicate, second instance, reconstruction, and/or digital twin) of the first virtual asset that becomes associated with the first application on the computer system. In some embodiments, associating the copy of the first virtual asset with the first application includes providing data corresponding to the first virtual asset to the first application on the computer system, such as facilitating communication of data corresponding to the first virtual asset from the content creation application described above to the first application. In some embodiments, the second representation of the first virtual asset has one or more characteristics of the first representation of the first virtual asset. For example, the second representation of the first virtual asset is a two-dimensional representation of the three-dimensional first virtual asset. In some embodiments, the second representation of the first virtual asset is a three-dimensional representation of the two-dimensional first virtual asset. In some embodiments, the second representation of the first virtual asset is displayed at a respective location within the user interface in the environment. In some embodiments, the respective location within the user interface is based on the movement of the first representation of the first virtual asset relative to the user interface in response to the second input, such as the location of and/or on the user interface in which the first representation of the first virtual asset is moved to. In some embodiments, the respective location within the user interface is a predefined and/or predetermined location of the user interface, such as based on the first application. For example, if the user interface is a messaging user interface (e.g., email or text messaging user interface), the respective location at which the second representation of the first virtual asset is displayed corresponds to an entry region or other receptacle of the messaging user interface (e.g., text-entry region, file drop zone, or other data input region). In some embodiments, when the second representation of the first virtual asset is displayed in the user interface, the computer system maintains display of and/or redisplays the first representation of the first virtual asset relative to the second object in the environment. For example, after the computer system generates and displays a copy of the first virtual asset in the user interface, and optionally in response to detecting termination of the second input described above (e.g., a release of the air pinch gesture), the computer system redisplays the first representation of the first virtual asset at its prior location on and/or above the second object in the three-dimensional environment (e.g., the location prior to the computer system detecting the second input). In some embodiments, after the computer system displays the second representation of the first virtual asset in the user interface, if the computer system continues detecting the second input (e.g., continues to detect the air pinch gesture performed by the hand of the user), the computer system maintains display of the first representation of the first virtual asset at a location in the environment that is based on and/or corresponds to a location of the hand of the user from the viewpoint of the user (optionally a location outside of and/or different from the second object in the environment). Facilitating movement of first content relative to (e.g., above and/or away from) a horizontal virtual object in a three-dimensional environment to a user interface in the three-dimensional environment in response to user input, and enabling the user to add the first content to the user interface in accordance with the movement, provides the user the ability to create a copy of the first content that is saved within the user interface, which reduces the number of inputs required to generate and save copies of content associated with the horizontal virtual object in the three-dimensional environment, thereby improving user-device interaction.

It should be understood that the particular order in which the operations in method 800 have been described is merely exemplary and is not intended to indicate that the described order is the only order in which the operations could be performed. One of ordinary skill in the art would recognize various ways to reorder the operations described herein. In some embodiments, aspects/operations of method 800 may be interchanged, substituted, and/or added between these methods. For example, various object manipulation techniques and/or object movement techniques of method 800 is optionally interchanged, substituted, and/or added between these methods. For brevity, these details are not repeated here.

FIG. 9 is a flowchart illustrating an exemplary method 900 of facilitating changing a visual appearance of a horizontal virtual object within a vertical virtual object in a three-dimensional environment based on whether the horizontal virtual object and its content are open in the three-dimensional environment in accordance with some embodiments. In some embodiments, the method 900 is performed at a computer system (e.g., computer system 101 in FIG. 1 such as a tablet, smartphone, wearable computer, or head mounted device) including a display generation component (e.g., display generation component 120 in FIGS. 1, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 900 is governed by instructions that are stored in a non-transitory computer-readable storage medium and that are executed by one or more processors of a computer system, such as the one or more processing units 202 (e.g., processors) of computer system 101 (e.g., controller 110 in FIG. 1A). Some operations in method 900 are, optionally, combined and/or the order of some operations is, optionally, changed.

In some embodiments, method 900 is performed at a computer system (e.g., computer system 101 in FIG. 7A) in communication with one or more display generation components (e.g., display generation component 120) and one or more input devices (e.g., image sensors 114a-114c). For example, the computer system is or corresponds to a mobile device (e.g., a tablet, a smartphone, a media player, or a wearable device), or a computer or other electronic device. In some embodiments, the computer system has one or more characteristics of the computer system in method 800. In some embodiments, the one or more display generation components have one or more characteristics of the one or more display generation components in method 800. In some embodiments, the one or more input devices have one or more characteristics of the one or more input devices in method 800.

In some embodiments, while displaying, via the one or more display generation components, a first object (e.g., a virtual object) having a first orientation in an environment (e.g., a three-dimensional environment) relative to a viewpoint of a user of the computer system, (wherein the first object includes a first representation of a first virtual asset, such as a three-dimensional model or other virtual object), such as virtual object 720 having a vertical orientation in the three-dimensional environment 700 as shown in FIG. 7A, the computer system detects (902), via the one or more input devices, a first input corresponding to a request to display a second object (e.g., a request to create and/or generate the second object or a request to open or launch the second object) that is associated with the first object in the environment, such as an air pinch and drag gesture provided by hand 703 directed to virtual asset 721a in the virtual object 720 as shown in FIG. 7B. In some embodiments, the three-dimensional environment has one or more characteristics of the three-dimensional environment described with reference to method 800. In some embodiments, the first orientation of the first object corresponds to a vertical orientation relative to the viewpoint of the user, as similarly described with reference to method 800. For example, a front-facing surface of the first object is and/or appears to be flat relative to the viewpoint of the user in the three-dimensional environment and/or relative to a floor or ground or another surface in the three-dimensional environment. In some embodiments, the first object has the first orientation relative to gravity. In some embodiments, displaying the first object with the first orientation includes displaying the first object with a respective amount of tilt or angular rotation that causes the front-facing surface of the first object to visually appear to be tilted toward or away from the viewpoint of the user in the environment. In some embodiments, the first object is associated with a content creation application that is running on the computer system. For example, as similarly described with reference to method 800, the first object (e.g., a vertical board or surface) includes a plurality of virtual assets corresponding to content, such as three-dimensional and/or two-dimensional virtual objects, including three-dimensional and/or two-dimensional images, models, shapes, and/or other predefined or existing virtual assets. In some embodiments, the first object includes representations of the plurality of virtual assets that are able to be interacted with in the environment to create content (e.g., groups of two-dimensional and/or three-dimensional assets, such as within a scene of content). In some embodiments, as discussed in more detail below, the first object includes one or more visual indications of the second object that are associated with one or more of the plurality of virtual assets in the first object in the environment. For example, as discussed in more detail below, creating a group of virtual assets corresponding to content in the three-dimensional environment includes associating the group of virtual assets with the second object, which is visually represented in the first object. In some embodiments, the first input corresponding to the request to display a second object that is associated with the first object in the environment includes interaction with a first representation of a first (e.g., three-dimensional) virtual asset in the first object. For example, the first input includes a movement input directed to the first representation in the first object, such as an air pinch and drag gesture (e.g., toward the viewpoint of the user in the environment) performed by a hand of the user, optionally while attention (e.g., including gaze) of the user is directed to the first representation in the environment, as described in more detail below. In some embodiments, the first input includes a selection input directed to the first representation of the first virtual asset and/or a visual indication of the second object that is displayed in the first object. For example, as described in more detail below, the first input includes an air pinch gesture or air tap gesture (e.g., a multi-pinch or multi-tap air gesture) performed by a hand of the user, optionally while the attention of the user is directed to the first representation of the first virtual asset or the visual indication of the second object in the environment. In some embodiments, the first input has one or more characteristics of the inputs in method 800.

In some embodiments, in response to detecting the first input (904), the computer system displays (906), via the one or more display generation components, the second object (e.g., a virtual object) that is associated with the first object in the environment, wherein the second object has a second orientation (e.g., different from the first orientation) relative to the viewpoint of the user, such as displaying virtual object 711 having a horizontal orientation in the three-dimensional environment 700 as shown in FIG. 7D. For example, in response to detecting the first input, the computer system displays a virtual object having a horizontal orientation (e.g., a three-dimensional horizontal virtual platter or plane) in the three-dimensional environment relative to the viewpoint of the user. In some embodiments, the computer system maintains display of the first object in the environment when the second object is displayed in the environment. In some embodiments, as similarly described with reference to method 800, the second object serves as a virtual horizontal surface on which the content (e.g., the three-dimensional and/or two-dimensional virtual assets) associated with the first object and/or content from other sources (e.g., other applications, other virtual windows and user interfaces displayed in the environment, and/or other repositories of images, models, and/or virtual objects) are able to be positioned relative to the viewpoint of the user and/or relative to each other in the three-dimensional environment. In some embodiments, the second object is displayed at a location in the environment relative to the viewpoint of the user based on the first input. For example, as mentioned above, the first input includes a movement input directed to a first representation of a first virtual (e.g., three-dimensional) asset that is displayed in the first object in the environment (e.g., movement of the first representation toward the viewpoint of the user in the environment). Accordingly, in some embodiments, the second object is displayed at a location in the environment that is below the first representation of the first virtual asset relative to the viewpoint of the user based on the movement of the first representation in the environment. In some embodiments, the second object is displayed at a predetermined location in the environment relative to the viewpoint of the user (optionally irrespective of the first input). For example, the second object is displayed at a location that is spatially in front of the first object from the viewpoint of the user and centered on a portion of the first object (e.g., a bottom edge or side of the first object) in the environment from the viewpoint of the user. In some embodiments, as alluded to above, displaying the second object in the environment includes displaying content (e.g., a two-dimensional or three-dimensional image, model, or other asset) with the second object in the environment, such as above and/or on a top surface of the second object from the viewpoint of the user. In some embodiments, displaying the second object in the environment has one or more characteristics of displaying horizontally oriented (e.g., spatial) objects as described with reference to method 800.

In some embodiments, the computer system displays (908), in the first object, a first visual indication of the second object, wherein the first visual indication has a first visual appearance in the environment, such as display of visual indication 711a having a first visual appearance indicated by dashed outline in the virtual object 720 as shown in FIG. 7D. For example, when the second object is displayed in the three-dimensional environment, a visual indication or representation of the second object is displayed in the first object (e.g., which was previously not displayed in the first object prior to detecting the first input discussed above). In some embodiments, the first visual indication of the second object is displayed at a predetermined location within the first object, such as at a center location in the first object and/or at an available location (e.g., unoccupied by other visual indications of horizontal surfaces and/or other representations of virtual assets) in the first object, from the viewpoint of the user. In some embodiments, displaying the first visual indication of the second object with the first visual appearance includes displaying the first visual indication with a first level of opacity. For example, when the second object is displayed in the three-dimensional environment in response to detecting the first input, the first visual indication of the second object in the first object has a first amount of translucency that enables content and/or portions of the environment (e.g., including portions of a physical environment of the computer system) that are spatially located behind the first visual indication to be at least partially visible through the first visual indication from the viewpoint of the user. Additionally, in some embodiments, displaying the first visual indication of the second object with the first visual appearance includes displaying the first visual indication with a first amount of brightness, a first amount of saturation, and/or with a first coloration. In some embodiments, if the first visual indication of the second object is already displayed in the first object when the first input is detected (e.g., the first input corresponds to a request to open or launch a scene or grouping of content that is associated with (e.g., anchored to and/or displayed on) the second object), the computer system updates display of the first visual indication of the second object to have the first visual appearance (e.g., from a second visual appearance as discussed below). In some embodiments, the first visual indication of the second object is displayed with the first visual appearance while (e.g., for a duration that) the second object is displayed in the environment.

In some embodiments, while displaying the second object in the environment and while displaying the first visual indication of the second object having the first visual appearance in the first object, the computer system detects (910), via the one or more input devices, a second input corresponding to a request to cease display of the second object in the environment, such as selection of a close option displayed with movement element 732 associated with the virtual object 711 provided by the hand 703 as shown in FIG. 7O. For example, the computer system detects an input corresponding to a request to close the scene or grouping of content (e.g., the virtual asset) that is associated with the second object (e.g., displayed atop the second object) in the three-dimensional environment. In some embodiments, detecting the second input includes detecting interaction with (e.g., selection of) an option for ceasing display of the second object in the environment. For example, the second object is displayed with a menu or toolbar of controls and/or options that are selectable to perform corresponding operations directed to the second object and/or the content associated with the second object, including an option that is selectable to close the second object in the three-dimensional environment. In some embodiments, the second input includes a movement input provided by the user directed to the second object in the environment. For example, the second object includes or is displayed with a movement element (e.g., a grabber bar) that is selectable (e.g., via an air gesture performed by the hand of the user) to initiate movement of the second object relative to the viewpoint of the user in the three-dimensional environment. Particularly, in some embodiments, the movement input corresponds to movement of the second object (including the content associated with the second object) toward the first object in the environment relative to the viewpoint of the user. In some embodiments, the second input does not correspond to a request to delete the second object and/or the content (e.g., virtual assets) associated with the second object in the environment. In some embodiments, the second input has one or more characteristics of the inputs described with reference to method 800.

In some embodiments, in response to detecting the second input (912), the computer system ceases (914) display, via the one or more display generation components, of the second object in the environment, such as ceasing display of the virtual object 711 in the three-dimensional environment 700 as shown in FIG. 7P. For example, in response to detecting the second input, the computer system closes the second object, including the content associated with the second object, in the three-dimensional environment. In some embodiments, the computer system maintains display of the first object in the environment when the second object ceases to be displayed in the environment. In some embodiments, as discussed in more detail below, the computer system maintains display of the first visual indication of the second object in the first object when ceasing display of the second object in the environment.

In some embodiments, the computer system updates (916) display of the first visual indication of the second object in the first object to have a second visual appearance, different from the first visual appearance, in the environment, such as updating the visual appearance of the visual indication 711a as indicated by solid outline in the virtual object 720 as shown in FIG. 7P. For example, when the second object ceases to be displayed in the three-dimensional environment, the computer system changes an opacity, brightness, saturation, and/or coloration of the first visual indication of the second object in the first object in the three-dimensional environment. In some embodiments, updating display of the first visual indication to have the second visual appearance includes increasing the opacity of the first visual indication in the first object, increasing the brightness of the first visual indication in the first object, decreasing the saturation of the first visual indication, and/or changing the color of the first visual indication in the first object. In some embodiments, updating display of the first visual indication of the second object to have the second visual appearance in the first object provides an indication to the user that the content (e.g., the virtual assets) associated with the second object is no longer open (e.g., displayed) and/or is no longer being interacted with (e.g., repositioned, scaled, resized, rotated, or otherwise edited) in the environment. Additionally, in some embodiments, updating display of the first visual indication of the second object to have the second visual appearance in the first object provides an indication to the user that the prior interactions and/or updates to the content (e.g., the virtual assets) associated with the second object in the environment have been saved by the content creation application with which the first object and the second object are associated. Changing a visual appearance of a visual indication of a horizontal virtual object on which content is arranged in a three-dimensional environment within a vertical virtual object based on whether the horizontal object is open (e.g., actively displayed) in the three-dimensional environment provides the user with a visual indication of a state of interaction with the content associated with the horizontal object and/or provides the user with a visual indication of the specific content that is associated with the horizontal object relative to other content included in the vertical object, which helps avoid erroneous input directed to the content in the vertical object, thereby improving user-device interaction.

In some embodiments, detecting the first input includes detecting a user input including movement directed to a first representation of a first virtual asset included in the first object, such as the air pinch and drag gesture performed by the hand 703 directed to the virtual asset 721a in the virtual object 720 as shown in FIG. 7B. For example, as similarly described above, the computer system detects an air gesture performed by a hand of the user of the computer system that is directed to the first representation of the first virtual asset in the first object in the three-dimensional environment. In some embodiments, the user input provided by the user corresponds to a request to move the first representation of the first virtual asset toward the viewpoint of the user in the three-dimensional environment. For example, the computer system detects an air pinch gesture provided by the hand of the user, followed by movement of the hand of the user in space toward the viewpoint of the user, which causes the computer system to display the second object in the three-dimensional environment. In some embodiments, the computer system moves the first representation of the first virtual asset in accordance with the movement of the hand of the user. For example, the computer system moves the first representation of the first virtual asset toward the viewpoint of the user in the three-dimensional environment in accordance with and/or based on a magnitude (e.g., of speed and/or distance) of the movement of the hand of the user. In some embodiments, the user input has one or more characteristics of the inputs described in method 800. In some embodiments, as similarly discussed above, following the movement of the first representation of the first virtual asset, the first virtual asset (e.g., a second representation of the first virtual asset) becomes associated with the second object in the three-dimensional environment. For example, the computer system displays the first virtual asset on the second object in the three-dimensional environment in response to detecting the first input. Changing a visual appearance of a visual indication of a horizontal virtual object on which content is arranged in a three-dimensional environment within a vertical virtual object in response to detecting an input corresponding to a request to display content on the horizontal object in the three-dimensional environment provides the user with a visual indication of a state of interaction with the content associated with the horizontal object and/or provides the user with a visual indication of the specific content that is associated with the horizontal object relative to other content included in the vertical object, which helps avoid erroneous input directed to the content in the vertical object and/or provides visual feedback regarding the input provided for launching the horizontal virtual object in the three-dimensional environment, thereby improving user-device interaction.

In some embodiments, while displaying the second object in the environment and while displaying the first visual indication of the second object having the first visual appearance in the first object, the first representation of the first virtual asset is displayed with the first visual appearance in the environment, such as the virtual asset 721 having the visual appearance indicated by dashed outline in the virtual object 720 as shown in FIG. 7D. For example, the computer system decreases the opacity of the first representation of the first virtual asset in the first object, decreasing the brightness of the first representation of the first virtual asset in the first object, increasing the saturation of the first representation of the first virtual asset in the first object, and/or changing the color of the first representation of the first virtual asset in the first object in the three-dimensional environment. In some embodiments, the computer system concurrently displays the first visual indication of the second object and the first representation of the first virtual asset with the first visual appearance in the first object in response to detecting the first input. Alternatively, in some embodiments, the first visual indication of the second object and the first representation of the first virtual asset are displayed with a same visual characteristic while being displayed with different visual appearances. For example, the first visual indication of the second object and the first representation of the first virtual asset are displayed with a same or similar amount of opacity while the second object is displayed in the environment, but are displayed with different amounts of brightness, saturation, and/or coloration. In some embodiments, as similarly described above with reference to the first visual indication of the second object, in response to detecting the second input, the computer system updates display of the first representation of the first virtual asset in the first object to have the second visual appearance. In some embodiments, as described in more detail below, the computer system displays the first representation of the first virtual asset with the first visual indication of the second object in the first object in the environment. Changing the visual appearances of a visual indication of a horizontal virtual object and a virtual asset that is positioned on the horizontal virtual object in a three-dimensional environment within a vertical virtual object in response to detecting an input corresponding to a request to launch the horizontal object in the three-dimensional environment provides the user with a visual indication of a state of interaction with the virtual asset associated with the horizontal object and/or provides the user with a visual indication of the specific virtual asset that is associated with the horizontal object relative to other virtual assets included in the vertical object, which helps avoid erroneous input directed to the virtual assets in the vertical object, thereby improving user-device interaction.

In some embodiments, when the first input is detected, the first representation of the first virtual asset is displayed at a first location in the first object from the viewpoint of the user, such as the location of the virtual asset 721a in the virtual object 720 as shown in FIG. 7A. For example, prior to and/or when detecting the first input, the computer system displays the first representation of the first virtual asset at a first location in the first object from the viewpoint of the user. In some embodiments, the first location corresponds to a default location within the first object. In some embodiments, the first location corresponds to a user-defined location within the first object. For example, prior to detecting the first input, the computer system has detected input provided by the user positioning the first representation of the first virtual asset at the first location in the first object, such as an input (e.g., an air pinch and drag gesture) moving the first representation of the first virtual asset to the first location in the first object.

In some embodiments, displaying the second object in the environment in response to detecting the first input includes displaying a second representation of the first virtual asset at a respective location relative to the second object in the environment, such as displaying representation 724a relative to the virtual object 711 in the three-dimensional environment 700 as shown in FIG. 7D, the second representation of the first virtual asset and the second object having a first spatial arrangement relative to the viewpoint of the user, such as the spatial relationship between the representation 724a and the virtual object 711 in FIG. 7D. For example, as described above, the first input includes and/or corresponds to movement of the first representation of the first virtual asset into the three-dimensional environment. In some embodiments, the second representation of the first virtual asset corresponds to a copy or duplicate of the first virtual asset that is displayed with the second object in the environment. For example, the computer system maintains display of the first representation of the first virtual asset (e.g., having the first visual appearance) in the first object when the second representation of the first virtual asset is displayed on the second object in the three-dimensional environment. In some embodiments, the respective location at which the second representation of the first virtual asset is displayed in the environment is based on the first input. For example, the computer system determines the respective location based on the movement of the hand of the user, such as the location in the three-dimensional environment at which the movement of the hand ceased in space (e.g., upon detecting a release of the air pinch gesture). In some embodiments, the respective location corresponds to a location above the second object in the environment from the viewpoint of the user and/or on a top surface of the second object in the environment from the viewpoint of the user. In some embodiments, the second representation of the second object is displayed with the second visual appearance described previously above at the respective location in the environment.

In some embodiments, displaying the first visual indication of the second object in the first object in response to detecting the first input includes displaying the first representation of the first virtual asset at a second location, different from the first location, that is relative to the first visual indication in the first object, such as the location of the virtual asset 721a changing within the virtual object 720 as illustrated in depth glyph 712 in FIG. 7D, the first representation of the first virtual asset and the first visual indication of the second object having the first spatial arrangement relative to the viewpoint of the user, such as the spatial relationship between the virtual asset 721a and the visual indication 711a within the virtual object 720 shown in FIG. 7D. For example, when the first input is detected, the first object does not include the first visual indication of the second object, and in response to detecting the first input, the computer system displays the first visual indication of the second object in the first object and moves the first representation of the first virtual asset to the second location in the first object. In some embodiments, the second location in the first object that is relative to the first visual indication of the second object corresponds to the respective location in the environment that is relative to the second object. For example, the first representation of the first virtual asset and the first visual indication of the second object share the same spatial arrangement in the first object as the second representation of the first virtual asset and the second object in the three-dimensional environment. In some embodiments, the second location in the first object has a depth within the first object from the viewpoint of the user that is greater than the depth of the first location in the first object from the viewpoint of the user. For example, from the viewpoint of the user, the first representation of the first virtual asset visually appears to move backward within the first object (e.g., away from the viewpoint of the user) in the three-dimensional environment. Accordingly, in some embodiments, the first visual indication of the first object is displayed at a depth within the first object that is similar to the depth at which the first representation of the first virtual asset is displayed within the first object in response to detecting the first input. Additional details regarding the depth of the first object in the environment are provided in method 800. Changing the visual appearances of a visual indication of a horizontal virtual object and a virtual asset that is positioned on the horizontal virtual object in a three-dimensional environment, including updating the location of the virtual asset relative to the visual indication of the horizontal virtual object, within the vertical virtual object in response to detecting an input associating the virtual asset with the horizontal object in the three-dimensional environment provides the user with a visual indication of a state of interaction with the virtual asset associated with the horizontal object and/or provides the user with a visual indication of the specific virtual asset that is associated with the horizontal object relative to other virtual assets included in the vertical object, which helps avoid erroneous input directed to the virtual assets in the vertical object, thereby improving user-device interaction.

In some embodiments, when the first input is detected (e.g., and/or prior to the first input being detected), the first object includes the first visual indication of the second object, such as the virtual object 720 including the visual indication 711a as shown in FIG. 7P. For example, the second object has already been created (e.g., previously displayed in the three-dimensional environment) prior to detecting the first input, which causes the first visual indication of the second object to be displayed in the first object. In some embodiments, when the first input is detected, the first visual indication of the second object has the second visual appearance discussed above in the first object. For example, the computer system is displaying the first visual indication of the second object with the second visual appearance to visually indicate to the user that the second object (e.g., and its associated content and/or virtual assets) is currently not open (e.g., displayed) in the three-dimensional environment.

In some embodiments, detecting the first input includes detecting a user input including selection directed to the first visual indication of the second object in the first object, such as the air pinch and drag gesture performed by the hand 703 directed to the visual indication 711a as shown in FIG. 7U. For example, as similarly described above, the computer system detects an air gesture performed by a hand of the user directed to the first visual indication of the second object in the first object in the three-dimensional environment. In some embodiments, the user input corresponds to a multi-tap or multi-pinch (e.g., a double or triple air tap or air pinch) performed by the hand of the user directed to the first visual indication of the second object in the first object. In some embodiments, the user input corresponds to an air pinch and drag gesture directed to the first visual indication of the second object in the first object. For example, the computer system detects an air pinch gesture directed to the first visual indication of the second object, followed by movement of the hand of the user in space toward the viewpoint of the user while maintaining the air pinch gesture. In some embodiments, while detecting the first input, the computer system moves the first visual indication of the second object in the three-dimensional environment in accordance with the movement of the hand of the user. For example, the computer system moves the first visual indication of the second object toward the viewpoint of the user based on a magnitude (e.g., of speed and/or distance) of the movement of the hand of the user in space. In some embodiments, the user input has one or more characteristics of the inputs discussed in method 800. Changing a visual appearance of a visual indication of a horizontal virtual object on which content is arranged in a three-dimensional environment within a vertical virtual object in the three-dimensional environment in response to detecting a selection of the visual indication of the horizontal virtual object in the vertical virtual object provides the user with a visual indication of a state of interaction with the content associated with the horizontal object and/or provides the user with a visual indication of the specific content that is associated with the horizontal object relative to other content included in the vertical object, which helps avoid erroneous input directed to the content in the vertical object and/or provides visual feedback regarding the input provided for launching the horizontal virtual object in the three-dimensional environment, thereby improving user-device interaction.

In some embodiments, the first orientation (e.g., a vertical orientation) of the first object is different from (e.g., opposite of) the second orientation (e.g., a horizontal orientation) of the second object in the environment relative to the viewpoint of the user (e.g., and/or relative to a ground or other surface of the environment and/or relative to gravity, as similarly discussed above), such as the orientation of the virtual object 711 being different from the orientation of the virtual object 720 in FIG. 7D. Changing a visual appearance of a visual indication of a horizontal virtual object on which content is arranged in a three-dimensional environment within a vertical virtual object based on whether the horizontal object is open (e.g., actively displayed) in the three-dimensional environment provides the user with a visual indication of a state of interaction with the content associated with the horizontal object and/or provides the user with a visual indication of the specific content that is associated with the horizontal object relative to other content included in the vertical object, which helps avoid erroneous input directed to the content in the vertical object, thereby improving user-device interaction.

In some embodiments, the first object includes one or more representations of one or more virtual assets when the first input is detected (e.g., including a first representation of a first virtual asset as described previously above), such as the virtual assets 721a and 721b in the virtual object 720 in FIG. 7A. In some embodiments, the one or more representations of the one or more virtual assets are displayed in the first object prior to the first input being detected. In some embodiments, when the first input is detected, the computer system is concurrently displaying the one or more representations and the first visual indication of the second object in the first object. In some embodiments, one or more of the one or more virtual assets are associated with the second object. For example, the content that is displayed with the second object in the three-dimensional environment includes one or more of the one or more virtual assets, such as the first virtual asset discussed above.

In some embodiments, the first visual indication of the second object is displayed with a first representation of a first virtual asset of the one or more representations of the one or more virtual assets in the first object, such as the virtual asset 721a being displayed relative to the visual indication 711a in the virtual object 720 as shown in FIG. 7D. For example, as mentioned above, the first virtual asset is associated with the second object in the three-dimensional environment. Accordingly, in some embodiments, when the second object is displayed in the environment, the first virtual asset is displayed with (e.g., on a top surface of) the second object in the environment. In some embodiments, the first representation of the first virtual asset is displayed above the first visual indication of the second object in the first object at a location relative to the first visual indication of the second object that is based on a location in the environment the first virtual asset is displayed relative to the second object, as previously discussed herein. In some embodiments, the computer system displays the first representation of the first virtual asset relative to the first visual indication of the second object in the first object, without displaying others of the one or more representations of the one or more virtual assets relative to the first visual indication of the second object in the first object. For example, the other virtual assets visually indicated in the first object are not associated with the second object. Displaying a representation of a virtual asset that is associated with the horizontal virtual object relative to the visual indication of the horizontal virtual object within the vertical virtual object in the three-dimensional environment in response to detecting an input associating the virtual asset with the horizontal object in the three-dimensional environment provides the user with a visual indication of a state of interaction with the virtual asset associated with the horizontal object and/or provides the user with a visual indication of the specific virtual asset that is associated with the horizontal object relative to other virtual assets included in the vertical object, which helps avoid erroneous input directed to the virtual assets in the vertical object, thereby improving user-device interaction.

In some embodiments, the first virtual asset is associated with the second object when the first input is detected (e.g., the content of the first virtual asset is associated with the second object, without others of the one or more virtual assets being associated with the second object, as similarly described above), such as illustrated by the virtual asset 721a being displayed relative to the visual indication 711a in the virtual object 720 when the air pinch and drag gesture performed by the hand 703 (e.g., including the gaze of the user) is detected in FIG. 7U. Displaying a representation of a virtual asset that is associated with the horizontal virtual object relative to the visual indication of the horizontal virtual object within the vertical virtual object in the three-dimensional environment in response to detecting an input associating the virtual asset with the horizontal object in the three-dimensional environment provides the user with a visual indication of a state of interaction with the virtual asset associated with the horizontal object and/or provides the user with a visual indication of the specific virtual asset that is associated with the horizontal object relative to other virtual assets included in the vertical object, which helps avoid erroneous input directed to the virtual assets in the vertical object, thereby improving user-device interaction.

In some embodiments, the second object has a first size in the environment and the first visual indication of the second object has a second size, different from the first size (e.g., independent of the first size of the second object in the environment), in the first object from the viewpoint of the user, such as the size of the virtual object 711 being different from the size of the visual indication 711a in the virtual object 720 as shown in FIG. 7D. For example, the first size of the second object in the three-dimensional environment is selected/determined by the computer system, rather than the user of the computer system, while the second size of the first visual indication of the second object is selected/determined based on the user of the computer system. In some embodiments, the first size of the second object corresponds to a default and/or predetermined size that is set by the computer system. For example, the second object is unable to be scaled in the three-dimensional environment. However, in some embodiments, the content associated with the second object (e.g., the virtual assets associated with the second object, as previously discussed herein) is able to be scaled relative to the second object in the environment (e.g., without changing the size of the second object itself in the environment). On the other hand, in some embodiments, the second size of the first visual indication of the second object is determined by user interaction directed to the first visual indication in the first object. For example, the first visual indication of the second object is able to be scaled within the first object without causing the size of the second object to be updated in the environment. Displaying the visual indication of the horizontal virtual object with a size within the vertical virtual object that is independent of a size of the horizontal virtual object in the three-dimensional environment enables the available display space of the vertical virtual object to be maximized without unnecessarily constraining the display space of the horizontal virtual object that is displayed in the three-dimensional environment, which avoids the need for input adjusting the size of the visual indication of the horizontal virtual object and/or the horizontal virtual object, thereby improving user-device interaction.

In some embodiments, the first object includes one or more representations of one or more virtual assets, including a first representation of a first virtual asset, when the first input is detected (e.g., as similarly described with reference to the virtual assets above), such as the virtual assets 721a and 721b in the virtual object 720 in FIG. 7A. In some embodiments, the first representation of the first virtual asset is concurrently displayed in the first object with the first visual indication of the second object in response to detecting the first input, as similarly described herein.

In some embodiments, the first virtual asset is associated with the second object (e.g., as similarly described with reference to the first virtual asset above), such as the virtual asset 721a being displayed relative to the visual indication 711a in the virtual object 720 in FIG. 7D.

In some embodiments, the second object includes a second representation of the first virtual asset while the second object is displayed in the environment, such as the virtual object 711 including representation 724a in the three-dimensional environment 700 as shown in FIG. 7D. For example, when the second object is displayed in the three-dimensional environment in response to detecting the first input discussed above, the computer system displays the first virtual asset with (e.g., above or on a top surface of) the second object in the three-dimensional environment (e.g., because the first virtual asset is associated with the second object). In some embodiments, the second representation of the first virtual asset corresponds to a copy or duplicate of the first representation of the first virtual asset, as similarly discussed above. In some embodiments, the second representation of the first virtual asset is displayed with the second visual representation in the environment, while the first representation of the first virtual asset is displayed with the first visual representation in the first object as similarly discussed above. In some embodiments, the second representation of the first virtual asset is displayed at a respective location and with a respective size and/or orientation relative to the second object in the environment while the second object is displayed.

In some embodiments, a first size of the first representation of the first virtual asset relative to the first visual indication of the second object in the first object is based on (e.g., corresponds to and/or is proportional to) a second size of the second representation of the first virtual asset relative to the second object in the environment, such as the size of the virtual asset 721a relative to the visual indication 711a in the virtual object 720 corresponding to the size of the representation 724a relative to the virtual object 711 in the three-dimensional environment 700 as shown in FIG. 7D. For example, the first representation of the first virtual asset is displayed at a respective location and with a respective size and/or orientation relative to the first visual indication of the second object in the first object. In some embodiments, the second size of the second representation of the first virtual asset in the environment is different from (e.g., larger than) the first size of the first representation of the first virtual asset in the first object from the viewpoint of the user. In some embodiments, the size of the first representation of the first virtual asset relative to the first visual indication of the second object is determined based on the size of the second representation of the first virtual asset relative to the second object in the environment from the viewpoint of the user. For example, if the computer system detects an input (e.g., one or more air pinch gestures) provided by the user corresponding to a request to rescale (e.g., increase or decrease the size of) the second representation of the first virtual asset by a particular amount, which causes the size of the second representation of the first virtual asset to change relative to the second object in the environment, the computer system updates the size of the first representation of the first virtual asset relative to the first visual indication of the second object by a corresponding and/or proportional amount in the first object. Similarly, in some embodiments, the location and/or orientation of the first representation of the first virtual asset relative to the first visual indication of the second object in the first object is based on (e.g., corresponds to) the location and/or orientation of the second representation of the first virtual asset relative to the second object in the environment from the viewpoint of the user. Displaying a representation of a virtual asset that is associated with the horizontal virtual object at a location that is relative to the visual indication of the horizontal virtual object within the vertical virtual object in the three-dimensional environment based on a location of the virtual asset relative to the horizontal object in the three-dimensional environment provides the user with a visual indication of a state of interaction with the virtual asset associated with the horizontal object and/or provides the user with a visual indication of the specific virtual asset that is associated with the horizontal object relative to other virtual assets included in the vertical object, which helps avoid erroneous input directed to the virtual assets in the vertical object, thereby improving user-device interaction.

In some embodiments, the first object is further associated with a third object that is a same type of object (e.g., and/or has the same orientation) as the second object, such as the virtual object 720 being associated with the virtual object 711 and the virtual object 719 in the three-dimensional environment 700 as shown in FIG. 7S. For example, the first object includes a plurality of horizontal virtual objects, including the second object and the third object, which is associated with the same content creation application as the first object in the three-dimensional environment. In some embodiments, the third object has already been generated and/or is already displayed in the environment when the first input is detected. In some embodiments, the third object is generated and/or displayed in the environment after the second object has been generated and/or displayed in the environment (e.g., in response to detecting the first input). In some embodiments, the third object is associated with content that is different from the content associated with the second object in the environment. For example, the third object is associated with one or more first virtual assets and the second object is associated with one or more second virtual assets, different from the one or more first virtual assets.

In some embodiments, the first object further includes a second visual indication of the third object, such as visual indication 719a in the virtual object 720 as shown in FIG. 7S. For example, the computer system concurrently displays the first visual indication of the second object and the second visual indication of the third object in the first object in the three-dimensional environment. In some embodiments, the first visual indication of the second object and the second visual indication of the third object are displayed at different locations within the first object from the viewpoint of the user. In some embodiments, the second visual indication of the third object has one or more characteristics of the first visual indication of the second object described herein. For example, the computer system displays the second visual indication of the third object with the first visual appearance while the third object is displayed in the three-dimensional environment and displays the second visual indication of the third object with the second visual appearance while the third object is not displayed in the three-dimensional environment. In some embodiments, as similarly discussed herein with reference to the second object, in accordance with a determination that the third object is associated with one or more virtual assets in the environment, the second visual indication of the third object includes and/or is displayed with one or more representation of the one or more virtual assets in the first object. Changing a visual appearance of a visual indication of a first horizontal virtual object of a plurality of horizontal virtual objects in the three-dimensional environment within the vertical virtual object based on whether the first horizontal object is open (e.g., actively displayed) in the three-dimensional environment provides the user with a visual indication of a state of interaction with the content associated with the first horizontal object and/or provides the user with a visual indication of the specific content that is associated with the first horizontal object relative to other content and the other horizontal virtual objects included in the vertical object, which helps avoid erroneous input directed to the content in the vertical object, thereby improving user-device interaction.

In some embodiments, the second visual indication of the third object is displayed with the second visual appearance in the first object when the first input is detected (e.g., the third object is not open and/or displayed in the three-dimensional environment when the first input discussed above is detected), such as the visual indication 719a having the visual appearance indicated by solid outline in the virtual object 720 in FIG. 7R. In some embodiments, while displaying the first visual indication of the second object having the first visual appearance in the first object in response to detecting the first input (e.g., while the second object is open in the three-dimensional environment), the computer system maintains display, via the one or more display generation components, of the second visual indication of the third object with the second visual appearance in the first object, such as the visual indication 711a maintaining the visual appearance indicated by the solid outline while the visual indication 719a is updated to have the visual appearance indicated by dashed outline in the virtual object 720 as shown in FIG. 70. For example, when the computer system opens and/or displays the second object in the three-dimensional environment in response to detecting the first input, which causes the first visual indication of the second object to be displayed with the first visual appearance as described previously above, the computer system maintains display of the second visual indication of the third object with the second visual appearance in the first object. In some embodiments, the computer system maintains display of the second visual indication of the third object with the second visual appearance because the third object is not opened and/or displayed in the environment in response to detecting the first input. Changing the visual appearance of a visual indication of the first horizontal virtual object of a plurality of horizontal virtual objects, without changing the visual appearance of visual indications of the other horizontal virtual objects, within the vertical virtual when the first horizontal object is open (e.g., actively displayed) in the three-dimensional environment provides the user with a visual indication of the specific horizontal virtual object that is currently open in the three-dimensional environment and/or provides the user with a visual indication of the specific content that is associated with the first horizontal object relative to other content and the other horizontal virtual objects included in the vertical object, which helps avoid erroneous input directed to the content in the vertical object, thereby improving user-device interaction.

In some embodiments, the computer system detects, via the one or more input devices, a third input corresponding to a request to delete the second object that is associated with the first object, such as if an input is provided in FIG. 7R corresponding to a request to delete the virtual object 719 associated with the visual indication 719a. For example, while the second object is displayed in the three-dimensional environment, the computer system detects an input corresponding to a request to delete the second object, including its associated content (e.g., virtual assets), from the content creation application that is associated with the first object, the second object, and the third object. In some embodiments, detecting the third input includes detecting a selection (e.g., via an air gesture) of an option that is selectable to delete the second object from the content creation application. In some embodiments, detecting the third input includes detecting a sequence of inputs directed to the content associated with the second object in the three-dimensional environment, such as a sequence of inputs corresponding to a request to individually delete the virtual assets displayed with the second object in the three-dimensional environment. In some embodiments, detecting the third input includes detecting a user input directed to the first visual indication of the second object in the first object. For example, the computer system detects a long press (e.g., via an air gesture) of the first visual indication of the second object in the first object, followed by selection of a selectable option for deleting the second object from the content creation application. In some embodiments, the third input has one or more characteristics of the inputs discussed in method 800.

In some embodiments, in response to detecting the third input, the computer system ceases display of the first visual indication of the second object in the first object, as similarly illustrated by the visual indication 719a not being displayed in the virtual object 720 as shown in FIG. 7Q. In some embodiments, if the second object is open and/or displayed in the three-dimensional environment when the third input is detected, the computer system also ceases display of the second object in the three-dimensional environment in response to detecting the third input.

In some embodiments, the computer system maintains display of the second visual indication of the third object in the first object, as similarly illustrated by the visual indication 711a being displayed in the virtual object 720 as shown in FIG. 7Q. For example, the computer system deletes the second object (e.g., and its associated content) from the content creation application without deleting the other horizontal virtual objects, including the third object, from the content creation application. Accordingly, the computer system optionally maintains display of the second visual indication of the third object in the first object and/or maintains display of the third object in the three-dimensional environment (e.g., if the third object is open in the three-dimensional environment when the third input is detected) in response to detecting the third input. Removing a visual indication of a first horizontal virtual object of a plurality of horizontal virtual objects in the three-dimensional environment within the vertical virtual object in response to detecting an input deleting the first horizontal object in the three-dimensional environment provides the user with a visual indication that the first horizontal object has been deleted and/or provides the user with a visual indication that specific content is no longer associated with the first horizontal object relative to the other horizontal virtual objects included in the vertical object, thereby improving user-device interaction.

In some embodiments, while displaying the first object in the environment (e.g., after detecting the second input discussed above), the computer system detects, via the one or more input devices, a third input corresponding to a request to redisplay the second object in the environment, such as the air pinch and drag gesture directed to the visual indication 711a in the virtual object 720 as shown in FIG. 7U. In some embodiments, the third input has one or more characteristics of the first input discussed above corresponding to the request to display the second object in the environment. For example, the computer system detects an air pinch gesture corresponding to a selection of the first visual indication of the second object in the first object provided by the user of the computer system, such as an air pinch and drag gesture or a multi-tap gesture performed by the hand of the user, optionally while the attention (e.g., including gaze) of the user is directed to the first visual indication of the second object in the first object.

In some embodiments, in response to detecting the third input, the computer system redisplays, via the one or more display generation components, the second object in the environment, such as displaying the virtual object 711 in the three-dimensional environment 700 as shown in FIG. 7V. In some embodiments, as similarly discussed above, in accordance with a determination that the second object is associated with content (e.g., one or more virtual assets), the computer system displays the content with the second object (e.g., on or above a top surface of the second object) in the environment when the second object is redisplayed in the environment.

In some embodiments, the computer system updates display of the first visual indication of the second object in the first object to have the first visual appearance in the environment, such as the visual indication 711a having the visual appearance indicated by the dashed outline in the virtual object 720 as shown in FIG. 7V. For example, as previously described herein, when the second object is redisplayed in the three-dimensional environment, the computer system changes an opacity, brightness, saturation, and/or coloration of the first visual indication of the second object in the first object in the three-dimensional environment to indicate that the second object is now open and/or displayed in the three-dimensional environment. Changing the visual appearance of the visual indication of the horizontal virtual object within the vertical virtual object when the horizontal object is reopened in the three-dimensional environment provides the user with a visual indication of a state of interaction with the content associated with the horizontal object and/or provides the user with a visual indication of the specific content that is associated with the horizontal object relative to other content included in the vertical object, which helps avoid erroneous input directed to the content in the vertical object, thereby improving user-device interaction.

In some embodiments, while displaying the second object in the environment and while displaying the first visual indication of the second object having the first visual appearance in the first object (e.g., in response to detecting the first input discussed above), the computer system detects, via the one or more input devices, a third input directed to the first visual indication of the second object, such as the air pinch and drag gesture provided by the hand 703 directed to movement element 732b associated with the virtual object 719 in the three-dimensional environment 700 as shown in FIG. 7V. For example, the computer system detects a user input corresponding to interaction with the first visual indication of the second object in the first object. In some embodiments, the third input corresponds to a request to move the first visual indication of the second object, including any representations of virtual assets associated with the second object, within the first object. For example, the computer system detects an air pinch and drag gesture directed to the first visual indication of the second object that includes movement laterally relative to the first object in the three-dimensional environment (e.g., as opposed to movement toward the viewpoint of the user in the three-dimensional environment). In some embodiments, the third input corresponds to a request to scale (e.g., increase or decrease a size of) the first visual indication of the second object, including any representations of virtual assets associated with the second object, within the first object. For example, the computer system detects a two-handed air pinch gesture directed to the first visual indication of the second object that includes movement of the hands relative to each other (e.g., movement of the hands away from each other or toward each other while maintaining the pinch hand shape).

In some embodiments, in response to detecting the third input, the computer system performs a respective operation directed to the first visual indication of the second object in the first object in accordance with the third input, without performing the respective operation directed to the second object in the environment, such as moving the virtual object 719 in the three-dimensional environment 700 in accordance with the movement of the hand 703 without moving the visual indication 719a in the virtual object 720 as shown in FIG. 7W. For example, the computer system performs an interaction directed to the first visual indication of the second object in the first object in accordance with the third input without performing the same or similar interaction directed to the second object that is currently displayed in the three-dimensional environment. In some embodiments, performing the respective operation directed to the first visual indication of the second object in the first object includes moving the first visual indication of the second object, including any representations of virtual assets associated with the second object, based on and/or in accordance with the movement of the hand of the user discussed above. In some embodiments, performing the respective operation directed to the first visual indication of the second object in the first object includes scaling the first visual indication of the second object, including any representations of virtual assets associated with the second object, based on and/or in accordance with the movement of the hands of the user discussed above. In some embodiments, the computer system forgoes performing any operation directed to the second object in the environment in response to detecting the third input that is directed to the first visual indication of the second object in the environment. For example, the computer system forgoes moving and/or scaling the second object and/or the virtual assets displayed on the second object in the three-dimensional environment in response to detecting the third input discussed above. Performing interactions directed to the visual indication of the horizontal virtual object within the vertical virtual object independently of interactions directed to the horizontal virtual object in the three-dimensional environment enables the visual indication of the horizontal virtual object to be interacted with, such as moved and/or scaled, within the vertical virtual object without affecting the display of the horizontal virtual object in the three-dimensional environment, which helps avoid erroneous input directed to the horizontal virtual object, thereby improving user-device interaction.

It should be understood that the particular order in which the operations in method 900 have been described is merely exemplary and is not intended to indicate that the described order is the only order in which the operations could be performed. It should be understood that the particular order in which the operations in methods 800 and/or 900 have been described is merely exemplary and is not intended to indicate that the described order is the only order in which the operations could be performed. One of ordinary skill in the art would recognize various ways to reorder the operations described herein. In some embodiments, aspects/operations of methods 800, and/or 900 may be interchanged, substituted, and/or added between these methods. For example, the three-dimensional environment in methods 800 and/or 900, the virtual content and/or virtual objects in methods 800 and/or 900, and/or the interactions with virtual content and/or the virtual objects in methods 800 and/or 900 are optionally interchanged, substituted, and/or added between these methods. For brevity, these details are not repeated here.

FIGS. 10A-10O illustrate examples of a first computer system facilitating shared interactions with virtual assets associated with a virtual object in a three-dimensional environment within a real-time communication session in accordance with some embodiments.

FIG. 10A illustrates a first computer system 101a (e.g., a first electronic device) displaying, via a display generation component 120a (e.g., display generation component 120 of FIGS. 1 and 3), a first three-dimensional environment 1000 from a viewpoint of a first user 1002 (e.g., User A) in top-down view 1010 (e.g., facing the back wall of the first physical environment in which the first computer system 101a is located). Additionally, FIG. 10A illustrates a second computer system 101b (e.g., a second electronic device) displaying, via a display generation component 120b, a second three-dimensional environment 1040 from a viewpoint of a second user 1004 (e.g., User B) in top-down 1012 (e.g., facing the back wall of the second physical environment in which the second computer system 101b is located).

In some embodiments, first computer system 101a includes a display generation component 120a. In FIG. 10A, the first computer system 101a includes one or more internal image sensors 114a-i oriented towards the face of the first user 1002 (e.g., eye tracking cameras 540 described with reference to FIG. 5). In some embodiments, internal image sensors 114a-i are used for eye tracking (e.g., detecting a gaze of the first user). Internal image sensors 114a-i are optionally arranged on the left and right portions of display generation component 120a to enable eye tracking of the first user's left and right eyes. First computer system 101a also includes external image sensors 114b-i and 114c-i facing outwards from the first user to detect and/or capture the physical environment and/or movements of the first user's hands. Similarly, in some embodiments, second computer system 101b includes a display generation component 120b. In FIG. 10A, the second computer system 101b includes one or more internal image sensors 114a-ii oriented towards the face of the second user 1004 (e.g., eye tracking cameras 540 described with reference to FIG. 5). In some embodiments, internal image sensors 114a-ii are used for eye tracking (e.g., detecting a gaze of the second user). Internal image sensors 114a-ii are optionally arranged on the left and right portions of display generation component 120b to enable eye tracking of the second user's left and right eyes. Second computer system 101b also includes external image sensors 114b-ii and 114c-ii facing outwards from the second user to detect and/or capture the physical environment and/or movements of the second user's hands.

As shown in FIG. 10A, first computer system 101a captures one or more images of the first physical environment around first computer system 101a (e.g., operating environment 100), including one or more objects in the first physical environment around first computer system 101a. In some embodiments, first computer system 101a displays representations of the first physical environment in first three-dimensional environment 1000. For example, first three-dimensional environment 1000 includes representations of the walls, floor, and ceiling of the physical room in which the first computer system 101a is located, which are optionally representations of physical walls, floor, and ceiling in the first physical environment. Similarly, second computer system 101b captures one or more images of the second physical environment around second computer system 101b (e.g., operating environment 100), including one or more objects in the second physical environment around second computer system 101b, including window 1044. In some embodiments, second computer system 101b displays representations of the second physical environment in second three-dimensional environment 1040. For example, second three-dimensional environment 1040 includes representations of the window 1044 and the walls, floor, and ceiling of the physical room in which the first computer system 101a is located, which are optionally representations of physical walls, floor, and ceiling in the second physical environment. In the example of FIG. 10A, the first physical environment is different from the second physical environment (e.g., the first computer system 101a and the second computer system 101b are located in different and/or separate physical spaces, such as different rooms, buildings, areas, regions, and/or cities).

As discussed in more detail below, in FIG. 10A, display generation component 120a is illustrated as displaying content in the first three-dimensional environment 1000. In some embodiments, the content is displayed by a single display (e.g., display 510 of FIG. 5) included in display generation component 120a. In some embodiments, display generation component 120a includes two or more displays (e.g., left and right display panels for the left and right eyes of the first user, respectively, as described with reference to FIG. 5) having displayed outputs that are merged (e.g., by the first user's brain) to create the view of the content shown in FIGS. 10A-10O. Similarly, in some embodiments, the content displayable by display generation component 120b is displayed by a single display (e.g., display 510 of FIG. 5) included in display generation component 120b. In some embodiments, display generation component 120b includes two or more displays (e.g., left and right display panels for the left and right eyes of the second user, respectively, as described with reference to FIG. 5) having displayed outputs that are merged (e.g., by the second user's brain) to create the view of the content shown in FIGS. 10A-10O.

Display generation component 120a has a field of view (e.g., a field of view captured by external image sensors 114b-i and 114c-i and/or visible to the first user via display generation component 120a) that corresponds to the content shown in FIG. 10A. Because first computer system 101a is optionally a head-mounted device, the field of view of display generation component 120a is optionally the same as or similar to the field of view of the first user 1002. Similarly, display generation component 120b has a field of view (e.g., a field of view captured by external image sensors 114b-ii and 114c-ii and/or visible to the second user via display generation component 120b) that corresponds to the content shown in FIG. 10A. Because second computer system 101b is optionally a head-mounted device, the field of view of display generation component 120b is optionally the same as or similar to the field of view of the second user 1004.

As discussed herein, one or more air pinch gestures performed by a user (e.g., with hand 1003 below) are detected by one or more input devices of first computer system 101a and/or second computer system 101b and interpreted as one or more user inputs directed to content displayed by first computer system 101a and/or second computer system 101b. Additionally or alternatively, in some embodiments, the one or more user inputs interpreted by first computer system 101a and/or second computer system 101b as being directed to content displayed by first computer system 101a and/or second computer system 101b are detected via one or more hardware input devices (e.g., controllers) rather than via the one or more input devices that are configured to detect air gestures, such as the one or more air pinch gestures, performed by the first user 1002 and/or second user 1004. Such depiction is intended to be exemplary rather than limiting; the first user and/or the second user optionally provide user inputs using different air gestures and/or using other forms of input.

As mentioned above, the first computer system 101a and the second computer system 101b are configured to display content in the first three-dimensional environment 1000 and the second three-dimensional environment 1040, respectively, using the display generation component 120a and the display generation component 120b, respectively. In FIG. 10A, first three-dimensional environment 1000 includes virtual objects 1020 and 1011. In some embodiments, the virtual object 1020 is a user interface of an application containing content (e.g., virtual assets), such as three-dimensional and/or two-dimensional objects, or any other element displayed by first computer system 101 that is not included in the first physical environment of display generation component 120a. For example, in FIG. 10A, the virtual object 1020 is a user interface of a content creation application containing a plurality of virtual assets 1021a and 1021b (e.g., two-dimensional and/or three-dimensional models, images, and/or objects, such as of an airplane and a ship). In some embodiments, the virtual object 1020 is associated with a content aggregation application, a note-taking application, a content brainstorming application, etc. Additional examples of applications are provided below with reference to methods 800, 900 and/or 1100. Additionally, in some embodiments, the virtual object 1020 includes and/or is displayed with toolbar 1030 in the first three-dimensional environment 1000. In some embodiments, as illustrated in FIG. 10A, the toolbar 1030 includes a plurality of selectable options that is selectable to perform corresponding operations directed to the virtual object 1020, as discussed in more detail herein later. In some embodiments, the virtual object 1020 corresponds to virtual object 720 in FIGS. 7A-7AA. It should be understood that the content discussed above is exemplary and that, in some embodiments, additional and/or alternative content and/or user interfaces are provided in the first three-dimensional environment 1000, such as the content described below with reference to methods 800, 900 and/or 1100.

In some embodiments, the virtual object 1020 includes or is associated with a three-dimensional volume in the first three-dimensional environment 1000. For example, in FIG. 10A, the virtual object 1020 has a three-dimensional volume within which the virtual assets 1021a and 1021b are displayed in the first three-dimensional environment 1000, as similarly described above with reference to FIG. 7A. In some embodiments, as shown in FIG. 10A, the virtual object 1020 is displayed with a movement element (e.g., a grabber bar) in the first three-dimensional environment 1000. In some embodiments, the movement element is selectable to initiate movement of the corresponding virtual object 1020 within the first three-dimensional environment 1000 relative to the viewpoint of the first user 1002.

Additionally, as mentioned above, the first three-dimensional environment 1000 includes the virtual object 1011. In some embodiments, the virtual object 1011 is also associated with the content creation application with which the virtual object 1020 is associated. In some embodiments, as described herein, the virtual object 1011 is able to be interacted with independently of the virtual object 1020 in the first three-dimensional environment 1000. In some embodiments, the virtual object 1011 corresponds to virtual object 711 in FIGS. 7A-7AA.

In some embodiments, as shown in FIG. 10A, the virtual object 1011 includes (e.g., contains) representation 1024a corresponding to the virtual asset 1021a and representation 1024b corresponding to the virtual asset 1021b of the virtual object 1020 in the first three-dimensional environment 1000. In some embodiments, as shown in FIG. 10A, the representation 1024a corresponding to the virtual asset 1021a is displayed at a first location relative to the virtual object 1011 and the representation 1024b corresponding to the virtual asset 1021b is displayed at a second location, different from the first location, relative to the virtual object 1011 in the first three-dimensional environment 1000. Additionally, in some embodiments, as shown in FIG. 10A, the virtual object 1011 is displayed with toolbar 1013 and movement element 1032 in the three-dimensional environment 700. In some embodiments, the toolbar 1013 includes a plurality of selectable options that is selectable to perform corresponding operations directed to the virtual object 1011. In some embodiments, the selectable options included in the toolbar 1013 is different from the selectable options included in the toolbar 1030. For example, as shown in FIG. 10A, the toolbar 1013 includes fewer selectable options (e.g., a subset of the selectable options) than the toolbar 1030 in the first three-dimensional environment 1000. In some embodiments, as previously described herein, the movement element 1032 is selectable to initiate movement of the virtual object 1011 (e.g., including the representations 1024a and 1024b) in the first three-dimensional environment 1000 from the viewpoint of the first user 1002. In some embodiments, as shown in FIG. 10A, the virtual object 1011 has an orientation in the first three-dimensional environment 1000 that is different from an orientation of the virtual object 1020 relative to the viewpoint of the first user 1002. For example, as shown in FIG. 10A, the virtual object 1011 is horizontally oriented relative to the viewpoint of the first user 1002 while the virtual object 1020 is vertically oriented relative to the viewpoint of the first user 1002.

In some embodiments, as shown in FIG. 10A, while the representation 1024a corresponding to the virtual asset 1021a and the representation 1024b corresponding to the virtual asset 1021b are displayed in the first three-dimensional environment 1000 relative to the virtual object 1011, the first computer system 101a displays a visual indication 1011a of the virtual object 1011 in the virtual object 1020 in the first three-dimensional environment 1000. For example, as illustrated in FIG. 10A, the first computer system 101a is displaying a representation of the horizontal virtual object in the virtual object 1020 in the first three-dimensional environment 1000. Additionally, as shown in FIG. 10A, the virtual asset 1021a and the virtual asset 1021b are displayed within the virtual object 1020 to be relative to the visual indication 1011a. For example, in FIG. 10A, the virtual asset 1021a and the virtual asset 1021b have a spatial relationship with the visual indication 1011a in the virtual object 1020 that corresponds to (e.g., is the same as) a spatial relationship between the representation 1024a and the representation 1024b relative to the virtual object 1011 in the first three-dimensional environment 1000.

Additionally, in some embodiments, as illustrated in FIG. 10A, while the representation 1024a corresponding to the virtual asset 1021a and the representation 1024b corresponding to the virtual asset 1021b are displayed relative to the virtual object 1011 in the first three-dimensional environment 1000, the first computer system 101a is displaying the virtual asset 1021a and the virtual asset 1021b as having respective visual appearances in the first three-dimensional environment 1000. For example, in FIG. 10A, the first computer system 101a displays the virtual asset 1021a and the virtual asset 1021b with a respective amount of brightness, transparency, saturation, coloration, and/or size in the virtual object 1020. Additional details regarding the display of the virtual object 1011 and the visual indication 1011a in the first three-dimensional environment 1000 are provided with reference to methods 800 and/or 900.

In FIG. 10A, the first computer system 101a detects an input corresponding to a request to initiate a process to share the content associated the virtual object 1011 with the second user 1004 of the second computer system 101b. For example, the first computer system 101a detects an input provided by the first user 1002 for sharing the virtual object 1011 within a real-time communication session that includes the first user 1002 and the second user 1004. In some embodiments, detecting the input corresponding to the request to share the content associated with the virtual object 1011 with the second user 1004 includes detecting a selection input directed to a share option displayed with the virtual object 1011. For example, as shown in FIG. 10A, the first computer system 101a detects an air pinch gesture provided by hand 1003 of the first user 1002, optionally while attention (e.g., including gaze 1026) of the first user 1002 is directed to a selectable option that is displayed adjacent to the movement element 1032 associated with the virtual object 1011 in the first three-dimensional environment 1000.

In some embodiments, as shown in FIG. 10B, in response to detecting the selection of the share option that is associated with the virtual object 1011, the first computer system 101a displays menu user interface 1015 for designating one or more recipients of the share request. For example, as shown in FIG. 10B, the first computer system 101a displays the menu user interface 1015 that includes an indication of the second user (e.g., User B), which is selectable to designate the second user 1004 of the second computer system 101b as the recipient (e.g., or one of the recipients) of the request to share the content associated with the virtual object 1011. In FIG. 10B, while displaying the menu user interface 1015 in the first three-dimensional environment 1000, the first computer system 101a detects a selection input directed to the indication of the second user (e.g., User B) in the menu user interface 1015. For example, as shown in FIG. 10B, the first computer system 101a detects an air pinch gesture provided by the hand 1003 of the first user 1002, optionally while the attention (e.g., including the gaze 1026) of the first user 1002 is directed to the indication of the second user (e.g., User B) in the menu user interface 1015.

In some embodiments, in response to detecting the selection of the indication of the second user (e.g., User B), the first computer system 101a transmits an invitation to the second computer system 101b (e.g., which is associated with the second user 1004) for viewing the content associated with the virtual object 1011. In some embodiments, as shown in FIG. 10C, in response to receiving the invitation from the first computer system 101a, the second computer system 101b displays notification 1017 corresponding to the request to share the content associated with the virtual object 1011 from the first user 1002. For example, as shown in FIG. 10C, the second computer system 101b displays the notification 1017 that includes an accept option 1018a and a deny option 1018b in the second three-dimensional environment 1040. In some embodiments, the accept option 1018a is selectable to accept the share request from the first user 1002 of the first computer system 101a and the deny option 1018b is selectable to deny the share request from the first user 1002 of the first computer system 101a.

In FIG. 10C, while displaying the notification 1017 in the second three-dimensional environment 1040, the second computer system 101b detects a selection input provided by the second user 1004 directed to the accept option 1018a of the notification 1017. For example, as shown in FIG. 10C, the second computer system 101b detects an air pinch gesture performed by hand 1005 of the second user 1004, optionally while attention (e.g., including gaze 1027) of the second user 1004 is directed to the accept option 1018a of the notification 1017. Additional details regarding sharing and/or accepting of content are provided below with reference to method 1100.

In some embodiments, in response to detecting the selection of the accept option 1018a, the second computer system 101b transmits an indication of the acceptance of the invitation to view the content associated with the virtual object 1011 to the first computer system 101a. In some embodiments, when and/or after the first computer system 101a receives the indication of the acceptance, and/or otherwise in response to the second computer system 101b detecting the input indicating acceptance of the share request, the first computer system 101a and the second computer system 101b enter a real-time communication session. In some embodiments, a real-time communication session enables the first user 1002 and the second user 1004 to communicate live (e.g., over video, image, audio, and/or other virtual representation) while optionally also viewing and/or interacting with shared content. Additional details regarding real-time communication sessions are provided below with reference to method 1100.

In some embodiments, as shown in FIG. 10D, when the first computer system 101a and the second computer system 101b enter the real-time communication session as a result of the content associated with the virtual object 1011 being shared, the second computer system 101b displays the virtual object 1011 (e.g., a copy or digital twin of the virtual object 1011) in the second three-dimensional environment 1040. In other words, the virtual object 1011 is now a shared virtual object within the real-time communication session (e.g., as indicated by “Shared” pill in FIG. 10D), such that the content of the virtual object 1011 is now visible by and/or interactive to the first user 1002 and the second user 1004 at their respective computer systems. As such, in FIG. 10D, while the virtual object 1011 is shared between the first user 1002 and the second user 1004, the representation 1024a and the representation 1024b that are displayed relative to (e.g., above and/or anchored onto) the virtual object 1011 are visible by and/or interactive to the first user 1002 at the first computer system 101a and the second user 1004 at the second computer system 101b. In some embodiments, as shown in FIG. 10D, the virtual object 1011 is shared and displayed in the second three-dimensional environment 1040 at the second computer system 101b, without the virtual object 1020 (e.g., automatically) being displayed in the second three-dimensional environment 1040, as discussed in more detail below.

Additionally, in some embodiments, as shown in FIG. 10D, when the first computer system 101a and the second computer system 101b enter the real-time communication session, the first computer system 101a displays visual representation 1028 of the second user 1004, as illustrated in the top-down view 1010, and the second computer system 101b displays visual representation 1022 of the first user 1002. For example, in FIG. 10D, the first computer system 101a displays a virtual avatar corresponding to the second user 1004 in the first three-dimensional environment 1000 and the second computer system 101b displays a virtual avatar corresponding to the first user 1002 in the second three-dimensional environment 1040. It is understood that, as illustrated in the top-down view 1010 in FIG. 10D, the visual representation 1028 of the second user 1004 is being displayed in the first three-dimensional environment 1000, but is currently not visible from the viewpoint of the first user 1002 (e.g., because the visual representation 1028 is located behind the virtual object 1020 in the first three-dimensional environment 1000 from the viewpoint of the first user 1002). Additional details regarding the display of the visual representations 1022/1028 are provided below with reference to method 1100.

In some embodiments, as alluded to above, though the virtual object 1011 is a shared virtual object within the real-time communication session, the virtual object 1020 is not shared in the real-time communication session. In other words, as illustrated in FIG. 10D, the virtual object 1020 remains private (e.g., local) to the first user 1002 at the first computer system 101a. As such, in FIG. 10D, the second computer system 101b does not display the virtual object 1011 in the second three-dimensional environment 1040 when the virtual object 1020 is shared and displayed in the second three-dimensional environment 1040. In some embodiments, when the virtual object 1011 is shared and displayed in the second three-dimensional environment 1040, the virtual object 1011 is displayed with and/or includes selectable option 1035. In some embodiments, the selectable option 1035 is selectable to cause the second computer system 101b to display a local version or private copy of the virtual object 1011 in the second three-dimensional environment 1040, as described in more detail below.

In FIG. 10E, while displaying the virtual object 1020 in the second three-dimensional environment 1040, the second computer system 101b detects a selection input provided by the hand 1005 of the second user 1004 directed to the selectable option 1035. For example, as shown in FIG. 10E, the second computer system 101b detects an air pinch gesture provided by the hand 1005, optionally while the attention (e.g., including the gaze 1027) of the second user 1004 is directed to the selectable option 1035 in the second three-dimensional environment 1040.

In some embodiments, as shown in FIG. 10F, in response to detecting the selection input provided by the hand 1005, the second computer system 101b displays virtual object 1020-1 in the second three-dimensional environment 1040. For example, as shown in FIG. 10F, the second computer system 101b displays a private or local copy of the virtual object 1020 in the second three-dimensional environment 1040 (e.g., concurrently with the virtual object 1011). Accordingly, as discussed in more detail below, the virtual object 1020-1 at the second computer system 101b is independently viewable and/or interactive of the virtual object 1020 at the first computer system 101a. In some embodiments, as shown in FIG. 10F, the virtual object 1020-1 is displayed with and/or includes movement element 1033-1 in the second three-dimensional environment 1040. In some embodiments, the movement element 1033-1 has one or more characteristics of the movement element 1033 discussed above. In some embodiments, a location at which the virtual object 1020-1 is displayed in the second three-dimensional environment 1040 is based on a location of the virtual object 1011 from the viewpoint of the second user 1004. For example, as shown in FIG. 10F, the virtual object 1020-1 is displayed centered on and/or behind the virtual object 1011 from the viewpoint of the second user 1004 in the second three-dimensional environment 1040.

In FIG. 10F, the second computer system 101b detects a movement input provided by hand 1005 of the second user 1004 corresponding to a request to move the virtual object 1020-1 in the second three-dimensional environment 1040. For example, as shown in FIG. 10F, the second computer system 101b detects an air pinch and drag gesture performed by the hand 1005 of the second user 1004, optionally while the attention (e.g., including the gaze 1027) is directed to the movement element 1033-1 associated with the virtual object 1020-1 in the second three-dimensional environment 1040. In some embodiments, as shown in FIG. 10F, the movement of the hand 1005 corresponds to movement of the virtual object 1020-1 in a leftward direction relative to the viewpoint of the second user 1004 and with a respective magnitude (e.g., of speed and/or distance).

In some embodiments, as shown in FIG. 10G, in response to detecting the movement input provided by the hand 1005 directed to the virtual object 1020-1, the second computer system 101b moves the virtual object 1020-1 relative to the viewpoint of the second user 1004 in accordance with the movement input. For example, as shown in FIG. 10G, the second computer system 101b moves the virtual object 1020-1 leftward in the second three-dimensional environment 1040 in accordance with the leftward movement of the hand 1005. In some embodiments, as shown in FIG. 10G, the second computer system 101b moves the virtual object 1020-1 independent of the virtual object 1020 at the first computer system 101a as alluded to above. For example, in FIG. 10G, the first computer system 101a does not move the virtual object 1020 in response to and/or when the second computer system 101b moves the virtual object 1020-1 (e.g., because the virtual object 1020-1 is private to the second user 1004 at the second computer system 101b). Additionally, as shown in FIG. 10G, the second computer system 101b moves the virtual object 1020-1 without moving or otherwise updating display of the virtual object 1011 in the second three-dimensional environment 1040. For example, the second computer system 101b does not move the virtual object 1011 when moving the virtual object 1020-1 in the second three-dimensional environment 1040.

In FIG. 10G, the second computer system 101b detects an input corresponding to a request to move the virtual object 1011 in the second three-dimensional environment 1040. For example, as shown in FIG. 10G, the second computer system 101b detects an air pinch and drag gesture provided by the hand 1005 of the second user 1004 while the attention (e.g., including the gaze 1027) of the second user 1004 is directed to the movement element 1032 that is displayed with the virtual object 1011 in the second three-dimensional environment 1040. In some embodiments, as shown in FIG. 10G, the movement of the hand 1005 corresponds to movement of the virtual object 1011 in a rightward direction relative to the viewpoint of the second user 1004 and with a respective magnitude (e.g., of speed and/or distance).

In some embodiments, as shown in FIG. 10H, in response to detecting the movement input directed to the virtual object 1011, the second computer system 101b moves the virtual object 1011 (e.g., including the representations 1024a and 1024b) in the second three-dimensional environment 1040 in accordance with the movement input. Particularly, in FIG. 10H, the second computer system 101b moves the virtual object 1011 rightward relative to the viewpoint of the second user in the second three-dimensional environment 1040 in accordance with the rightward movement of the hand 1005. Additionally, in some embodiments, as shown in FIG. 10H, when the second computer system 101b moves the virtual object 1011 in the second three-dimensional environment 1040, the second computer system 101b updates a spatial arrangement of the virtual content that is considered shared within the real-time communication session, including synchronizing and/or coordinating movement of the virtual content that is considered shared within the real-time communication session. In the example of FIG. 10H, the virtual content that is considered shared within the real-time communication session includes the virtual object 1011 (e.g., including the representations 1024a and 1024b), the visual representation 1022, and the visual representation 1028. Accordingly, as shown in FIG. 10H, when the second computer system 101b moves the virtual object 1011 rightward in the second three-dimensional environment 1040 in response to detecting the movement input provided by the second user 1004, the second computer system 101b also moves the visual representation 1022 of the first user 1002 that is displayed in the second three-dimensional environment 1040, such that the virtual object 1011 and the visual representation 1022 maintain a same spatial relationship relative to the viewpoint of the second user 1004. Thus, because the virtual object 1020-1 is private to the second user 1004 at the second computer system 101b, the second computer system 101b forgoes moving the virtual object 1020-1 when updating the spatial arrangement of the virtual object 1011 and the visual representation 1022 (e.g., does not move the virtual object 1020-1 when moving the virtual object 1011 and the visual representation 1022 in the second three-dimensional environment 1040). Additionally, updating the spatial arrangement of the virtual object 1011 and the visual representation 1022 causes the first computer system 101a to move the visual representation 1028 of the second user 1004 in the first three-dimensional environment 1000. For example, as shown in the top-down view 1010 in FIG. 10H, the first computer system 101a moves the visual representation 1028 rightward in the first three-dimensional environment 1000 relative to the viewpoint of the first user 1002 based on and/or in accordance with the rightward movement of the virtual object 1011 and the visual representation 1022 at the second computer system 101b. Additional details regarding updating the spatial arrangement of the shared virtual content are provided below with reference to method 1100.

In FIG. 10I, the first computer system 101a detects an input corresponding to a request to move and/or reposition the representation 1024b relative to the virtual object 1011 in the first three-dimensional environment 1000. For example, as shown in FIG. 10I, the first computer system 101a detects an air pinch and drag gesture performed by the hand 1003 of the first user 1002, optionally while the attention (e.g., including the gaze 1026) of the first user 1002 is directed toward the representation 1024b on the virtual object 1011. In some embodiments, as indicated in FIG. 10I, the movement of the hand 1003 corresponds to movement of the representation 1024b in a forward and leftward direction relative to the viewpoint of the first user 1002 and with a respective magnitude (e.g., of speed and/or distance).

In some embodiments, as shown in FIG. 10J, in response to detecting the movement input directed to the representation 1024b, the first computer system 101a moves the representation 1024b relative to the virtual object 1011 in accordance with the movement of the hand 1003. For example, as shown in FIG. 10J, the first computer system 101a repositions the representation 1024b on and/or above the surface of the virtual object 1011 to be positioned slightly in front of and below representations 1024a from the viewpoint of the first user 1002, as illustrated in the top-down view 1010, in accordance with the diagonally leftward movement of the hand 1003. In some embodiments, because the virtual object 1011 is shared within the real-time communication session, interactions with the content of the virtual object 1011 is synchronized between the first computer system 101a and the second computer system 101b. Accordingly, when the representation 1024b is moved relative to the virtual object 1011 in the first three-dimensional environment 1000 at the first computer system 101a, the second computer system 101b correspondingly moves the representation 1024b relative to the virtual object 1011 in the second three-dimensional environment 1040, such that the new and/or updated position of the representation 1024b relative to the virtual object 1011 remains consistent and synchronized for both the first user 1002 and the second user 1004 in the real-time communication session. For example, the first computer system 101a transmits data corresponding to the input/interaction to the second computer system 101b indicating the updated position of the representation 1024b relative to the virtual object 1011. In some embodiments, as shown in FIG. 10J, when the representation 1024b is repositioned relative to the virtual object 1011 at the first computer system 101a and the second computer system 101b, the virtual asset 1021b is correspondingly repositioned relative to the visual indication 1011a in the virtual object 1020 and the virtual object 1020-1, as similarly described previously with reference to methods 800 and/or 900 above. It is understood that additional or alternative interactions affecting the content of the virtual object 1011 are similarly synchronized and/or coordinated between the first computer system 101a and the second computer system 101b while the virtual object 1011 is shared in the real-time communication session, such as the interactions discussed with reference to method 1100.

In FIG. 10K, the second computer system 101b detects a selection input directed to the selectable option 1035 that is associated with the virtual object 1011 in the second three-dimensional environment 1040. For example, as shown in FIG. 10K, the second computer system 101b detects the hand 1005 of the second user 1004 perform an air pinch gesture while the attention (e.g., including the gaze 1027) of the second user 1004 is directed to the selectable option 1035 in the second three-dimensional environment 1040. In some embodiments, because the virtual object 1020-1 is currently displayed in the second three-dimensional environment 1040 when the selection of the selectable option 1035 is detected, the selectable option 1035 is selectable to cease display of the virtual object 1020-1, as described below.

In some embodiments, as shown in FIG. 10L, in response to detecting the selection input directed to the selectable option 1035 associated with the virtual object 1011, the second computer system 101b ceases display of the virtual object 1020-1 in the second three-dimensional environment 1040. In some embodiments, as similarly discussed herein above, because the virtual object 1020-1 was private (e.g., local) to the second user 1004 at the second computer system 101b, ceasing display of the virtual object 1020-1 in the second three-dimensional environment 1040 does not affect the display of the virtual object 1020 at the first computer system 101a. For example, in FIG. 10L, the first computer system 101a maintains display of the virtual object 1020 in the first three-dimensional environment 1000 when and/or after the virtual object 1020-1 is no longer displayed in the second three-dimensional environment 1040 at the second computer system 101b. Further, as shown in FIG. 10L, the second computer system 101b (e.g., and the first computer system 101a) maintains display of the virtual object 1011 when the virtual object 1020-1 ceases to be displayed in the second three-dimensional environment 1040 (e.g., because the virtual object 1011 is still shared within the real-time communication session).

In FIG. 10L, the first computer system 101a detects an input provided by the first user 1002 corresponding to a request to cease the sharing of the content associated with the virtual object 1011 and/or end the real-time communication session with the second user 1004. In some embodiments, the input is detected as being directed to a settings user interface 1042 that is associated with the real-time communication session. For example, as shown in FIG. 10L, in response to detecting an input for displaying communication settings of the real-time communication session (e.g., selection of a respective option, selection of the representation 1028 of the second user 1004 in the first three-dimensional environment 1000, and/or a voice input), the first computer system 101a displays the settings user interface 1042 that includes a plurality of options corresponding to controls for the real-time communication session. For example, the settings user interface 1042 includes options for controlling display of the first user's representation (e.g., whether to be visually represented by an avatar or by another representation, such as through video or an image), for controlling voice output that is detectable by the first computer system 101 (e.g., muting or unmuting the first user's voice while in the real-time communication session), for controlling the sharing of content in the real-time communication session (e.g., such as the virtual object 1011), and/or for ending the real-time communication session, such as via end option 1043. In some embodiments, as illustrated in FIG. 10L, the first computer system 101a detects a selection of the end option 1043 in the settings user interface 1042. For example, as shown in FIG. 10L, the first computer system 101a detects an air pinch gesture performed by the hand 1003 of the first user 1002, optionally while the attention (e.g., including gaze 1026) of the first user 1002 is directed to the end option 1043 in the first three-dimensional environment 1000. Additional examples of inputs for ending real-time communication sessions and/or ceasing the sharing of content are provided below with reference to method 1100.

In some embodiments, in response to detecting the selection of the end option 1043, the first computer system 101a initiates a process to end the real-time communication session between the first user 1002 and the second user 1004 of the second computer system 101b. For example, the first computer system 101a ceases communication (e.g., ends the live call) with the second computer system 101b. In some embodiments, ending the real-time communication session includes ceasing the sharing of the content associated with the virtual object 1011. For example, the virtual object 1011 is no longer shared between the first user 1002 and the second user 1004. Accordingly, as illustrated in FIG. 10M, the second computer system 101b ceases display of the virtual object 1011, including the content of the virtual object 1011 (e.g., the representations 1024a and 1024b), in the second three-dimensional environment 1040. For example, the first computer system 101a revokes access to the content associated with the virtual object 1011 from the second computer system 101b and/or ceases transmission of the display data corresponding to the virtual object 1011 that enables the second computer system 101b to display the virtual object 1011 in the second three-dimensional environment 1040. Additionally, in some embodiments, as shown in FIG. 10M, when the real-time communication session is terminated, the visual representations of the first user 1002 and the second user 1004 cease to be displayed. For example, in FIG. 10M, the first computer system 101a is no longer displaying the visual representation 1028 of the second user 1004 and the second computer system 101b is no longer displaying the visual representation 1022 of the first user 1002, as similarly illustrated in the top-down views 1010 and 1012. In some embodiments, when the content of the virtual object 1011 ceases to be shared with the second computer system 101b, the second computer system 101b displays notification 1045 in the second three-dimensional environment 1040 indicating that the sharing of the content has ceased and/or been revoked by the first user 1002 (e.g., User 1). Additionally, in some embodiments, when the content of the virtual object 1011 ceases to be shared with the second computer system 101b, the first computer system 101a maintains display of the virtual object 1011 in the first three-dimensional environment 1000, such that the virtual object 1011 is now private to the first user 1002 at the first computer system 101a (e.g., similarly as the virtual object 1020 as discussed herein above).

In some embodiments, one or more of the above interactions similarly apply for users who are collocated in a same physical environment while participating in a real-time communication session. For example, in FIG. 10N, the first user 1002 of the first computer system 101a and the second user 1004 of the second computer system 101b are alternatively located in the same physical environment (e.g., the same physical room or space) while the first computer system 101a and the second computer system 101b are communicatively linked in a real-time communication session. As such, as shown in FIG. 10N, the first computer system 101a and the second computer system 101b forgo displaying visual representations (e.g., virtual avatars or other virtual images and/or video) of the first user 1002 and the second user 1004. Rather, as shown in FIG. 10N, the first user 1002 is visually represented by their physical person (e.g., body) in the second three-dimensional environment 1040 at the second computer system 101b and the second user 1004 is visually represented by their physical person (e.g., body) in the first three-dimensional environment 1000 at the first computer system 101a.

Additionally, in FIG. 10N, while the first user 1002 and the second user 1004 are participating in the real-time communication session, the first computer system 101a and the second computer system 101b are sharing the content associated with the virtual object 1011. For example, as discussed previously above, the virtual object 1011 is a shared virtual object within the real-time communication session. Accordingly, as shown in FIG. 10N, in some embodiments, the first computer system 101a is displaying the virtual object 1011 (e.g., including the representations 1024a and 1024b) in the first three-dimensional environment 1000 and the second computer system 101b is displaying the virtual object 1011 (e.g., including the representations 1024a and 1024b) in the second three-dimensional environment 1040. As described herein, because the content associated with the virtual object 1011 is currently shared in the real-time communication session, the content is viewable by and/or interactive to the participants of the real-time communication session, including the first user 1002 and the second user 1004 via their respective computer systems. Similarly, the virtual object 1011 itself is optionally viewable by and/or interactive to the participants of the real-time communication session, as described below.

In FIG. 10N, the first computer system 101a detects a movement input provided by the first user 1002 directed to the virtual object 1011 in the first three-dimensional environment 1000. For example, as shown in FIG. 10N, the first computer system 101a detects an air pinch and drag gesture performed by the hand 1003 of the first user 1002, optionally while the attention (e.g., the including the gaze 1026) of the first user 1002 is directed to the movement element 1032 associated with the virtual object 1011 in the first three-dimensional environment 1000. In some embodiments, as indicated in FIG. 10N, the movement input directed to the virtual object 1011 corresponds to a request to move the virtual object 1011 leftward relative to the viewpoint of the first user 1002 and/or with a respective magnitude (e.g., of speed and/or distance).

In some embodiments, as shown in FIG. 10O, in response to detecting the movement input directed to the virtual object 1011, the first computer system 101a moves the virtual object 1011 in the first three-dimensional environment 1000 in accordance with the movement input. For example, in FIG. 10O, the first computer system 101a moves the virtual object 1011 (e.g., including the representations 1024a and 1024b that are displayed relative to the virtual object 1011) leftward in the first three-dimensional environment 1000 from the viewpoint of the first user 1002 in accordance with the leftward movement of the hand 1003 of the first user 1002. Additionally, in some embodiments, because the virtual object 1011 is shared between the first user 1002 and the second user 1004 in the real-time communication session, the movement of the virtual object 1011 at the first computer system 101a causes the second computer system 101b to correspondingly move the virtual object 1011 in the second three-dimensional environment 1040. For example, as shown in FIG. 10O, the second computer system 101b moves the virtual object 1011 (e.g., including the representations 1024a and 1024b) rightward in the second three-dimensional environment 1040 in accordance with and/or based on the movement input detected by the first computer system 101a discussed above. Thus, the interactions with the virtual object 1011 are synchronized between and coordinated by the first computer system 101a and the second computer system 101b while the virtual object 1011 (e.g., including its content) is shared within the real-time communication session. It is understood that interactions with the content associated with the virtual object 1011 (e.g., movement of the representations 1024a and/or 1024b, addition of representations to the virtual object 1011, removal of one or more of the representations from the virtual object 1011, and/or annotations to the representations 1024a and/or 1024b on the virtual object 1011) are similarly synchronized and coordinated between the first computer system 101a and the second computer system 101b in the manner(s) similarly discussed above. Additional details and examples regarding the display and interaction with virtual objects that are shared between collocated users are provided below with reference to method 1100.

FIG. 11 is a flowchart illustrating an exemplary method of facilitating shared interactions with virtual assets associated with a virtual object in a three-dimensional environment within a real-time communication session in accordance with some embodiments. In some embodiments, the method 1100 is performed at a computer system (e.g., computer system 101 in FIG. 1 such as a tablet, smartphone, wearable computer, or head mounted device) including a display generation component (e.g., display generation component 120 in FIGS. 1, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1100 is governed by instructions that are stored in a non-transitory computer-readable storage medium and that are executed by one or more processors of a computer system, such as the one or more processors (e.g., processing units 202) of computer system 101 (e.g., control unit 110 in FIG. 1A). Some operations in method 1100 are, optionally, combined and/or the order of some operations is, optionally, changed.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. For example, facilitating sharing of a horizontal virtual object that includes representations of content within a real-time communication session that includes a plurality of users, while maintaining private display of a vertical virtual object associated with the horizontal virtual object, allows the content of the horizontal virtual object to be collaboratively viewed and interacted with by the plurality of users independent of the vertical virtual object, thereby improving the overall user experience during the real-time communication session, and helps preserve computing resources that would otherwise be consumed to coordinate display of the horizontal virtual object and the vertical virtual object within the real-time communication session.

In some embodiments, a method 800 is performed at a first computer system (e.g., first computer system 101a in FIG. 10A) in communication with one or more display generation components (e.g., display 120a) and one or more input devices (e.g., image sensors 114a-114i through 114c-114i). For example, the first computer system is or corresponds to a mobile device (e.g., a tablet, a smartphone, a media player, or a wearable device), or a computer or other electronic device. In some embodiments, the first computer system has one or more characteristics of the computer system in methods 800 and/or 900. In some embodiments, the one or more display generation components have one or more characteristics of the one or more display generation components in methods 800 and/or 900. In some embodiments, the one or more input devices have one or more characteristics of the one or more input devices in methods 800 and/or 900.

In some embodiments, while an environment (e.g., a three-dimensional environment) is visible via the one or more display generation components, such as three-dimensional environment 1000 in FIG. 10A, the first computer system detects (1102) a first indication of a request to initiate communication with a second user (e.g., second user 1004 in FIG. 10A), different from a first user (e.g., first user 1002 in FIG. 10A) of the first computer system, of a second computer system (e.g., second computer system 101b in FIG. 10A), different from the first computer system, such as the selection of the indication of User B in menu user interface 1015, wherein the request includes an invitation to share content (e.g., one or more virtual objects) between the first user and the second user. In some embodiments, the three-dimensional environment has one or more characteristics of the three-dimensional environment described with reference to methods 800 and/or 900. In some embodiments, the second computer system has one or more characteristics similar to or the same as one or more characteristics of the first computer system. In some embodiments, the first computer system receives and/or initiates a request to join a spatial communication session with the second computer system. In some embodiments, the second computer system is remote from (e.g., is not proximate to) the first computer system. For example, the second computer system is more than a threshold distance (e.g., 0.1, 0.5, 0.75, 1, 2, 3, 5, 10, 12, 15, 20, 25, 30, or 50 m) of the first computer system when the first indication is detected, such as the second user being in a different or separate room or physical space (e.g., building or general location) from the first user. In some embodiments, when the first indication is detected, the second user is outside of a field of view of the first user. In some embodiments, the second computer system is proximate to the first computer system. For example, the second computer system is within a threshold distance (e.g., 0.1, 0.5, 0.75, 1, 2, 3, 5, 10, 12, 15, 20, 25, 30, or 50 m) of the first computer system when the first indication is detected. In some embodiments, when the first indication is detected, the second computer system is located in a same physical environment of the first computer system. For example, the second user is in a same or nearby room or space as the first user. In some embodiments, when the first indication is detected, the second user is in a field of view of the first user in the environment (e.g., and/or vice versa). In some embodiments, the first indication of the request to initiate spatial communication with the second user corresponds to a request to initiate a phone call with the second user. For example, the first computer system or the second computer system detects an input (e.g., provided by the first user or the second user) directed to a user interface of a phone calling application (e.g., a contact card of the second user or the first user) corresponding to a request to call the second user or the first user (e.g., selection of a call button in the user interface). In some embodiments, the first indication of the request to initiate spatial communication with the second user corresponds to a request to initiate a video call with the second user. For example, the first computer system or the second computer system detects an input (e.g., provide by the first user or the second user) directed to a user interface of a video conferencing application (e.g., a contact card of the second user or the first user) corresponding to a request to initiate a video conference with the second user or the first user (e.g., selection of a video call button in the user interface). In some embodiments, the first indication includes input directed to a selectable option that is displayed with virtual content that is being displayed by the second computer system or the first computer system. For example, the invitation to share content between the first user and the second user is initiated in response to detecting a selection of the selectable option. In some embodiments, in response to detecting the selection of the selectable option, the first computer system or the second computer system displays a virtual menu that includes visual indications of one or more recipients of the sharing, including the first user and/or the second user. For example, the first computer system and/or the second computer system initiate the spatial communication and initiate sharing of the content between the first user and the second user in response to detecting a selection or designation of the first user and/or the second user as recipients of the sharing of the content (e.g., the one or more virtual objects, as described below). In some embodiments, the first indication includes input directed to a “suggested users” user interface displayed at the first computer system (or the second computer system). For example, the suggested users user interface includes visual indications (e.g., images, icons, and/or other representations) of users and/or computer systems who are proximate to the first computer system, such as the second user if the second user is within the threshold distance of the first user (e.g., and therefore the first computer system). In some embodiments, the first indication includes a selection of a visual indication of the second user within the suggested “users” user interface (e.g., if the second user is proximate to the first user).

In some embodiments, as discussed in more detail below, spatial communication includes communication in which the first user and other participants (e.g., the second user) share a common virtual space. For example, the participants are represented by virtual avatars (or similar representations) in the three-dimensional environment, wherein the virtual avatars provide the first user of the first computer system with visual indications of the locations and/or orientations of the participants within the virtual space shared among the participants.

In some embodiments, in response to detecting the first indication, the first computer system enters (1104) a real-time communication session with the second user, including displaying, via the one or more display generation components, a first object having a first orientation in the environment relative to a viewpoint of the first user, such as virtual object 1011 in first three-dimensional environment 1000 in FIG. 10D, wherein the first object is shared between the first user and the second user in the real-time communication session, as illustrated by the virtual object 1011 being displayed in second three-dimensional environment 1040 in FIG. 10D, and wherein the first object is displayed with a first option (e.g., selectable option 1035 in FIG. 10D) that is selectable to display a second object (e.g., a request to create and/or generate the second object or a request to open or launch the second object) that is associated with the first object in the environment. In some embodiments, the first computer system enters the real-time communication session with the second computer system in accordance with a determination that the invitation to share content between the first user and the second user is accepted (e.g., by the first user and/or the second user). For example, in response to detecting the first indication, the first computer system displays a notification or other user interface informing the first user of the communication request, and the first computer system enters the real-time communication session with the second user in response to detecting an input accepting/approving the request, such as a selection of an “answer” or “accept” option displayed within the notification. In some embodiments, the real-time communication session is a non-spatial communication session that includes audio (e.g., real-time voice audio from the first user and/or the second user) and/or video (e.g., real-time video of the environment of the first user and/or second user). For example, the first computer system displays a virtual object via which to visually and/or audibly communicate with the second user in the three-dimensional environment in response to detecting the first indication. In some embodiments, the virtual object is displayed as a user interface (e.g., a non-spatial window) that includes a two-dimensional rendering of the second user based on image data captured by sensors in an environment of the second user, such as one or more cameras of the second computer system. For example, the two-dimensional rendering of the second user corresponds to a photograph, cartoon, sketch, or other still image selected by the second user or corresponds to a (e.g., live) video feed of the second user. In some embodiments, the two-dimensional rendering of the second user corresponds to a two-dimensional animated representation of the second user (e.g., a two-dimensional avatar rather than a three-dimensional avatar as discussed above). Additionally, in some embodiments, the virtual object is or includes a non-spatial communication interface (e.g., a virtual video panel that includes a two-dimensional rendering of the second user) via which to communicate with the second user (e.g., in lieu of a virtual avatar, as discussed in more detail below). Accordingly, in some embodiments, the virtual object (e.g., the non-spatial communication interface) serves as a visual indication that the first user and the second user are engaging in a non-spatial communication session. In some embodiments, as discussed in more detail below, the virtual object includes one or more selectable options for controlling the non-spatial communication with the second user. For example, the non-spatial communication interface included in the virtual object includes one or more options for ending the non-spatial communication with the second user, adding another participant (e.g., a third user) to the non-spatial real-time communication session, initiating spatial communication with the second user (e.g., transitioning the non-spatial real-time communication session to a spatial real-time communication session), and/or muting verbal input provided by the first user (e.g., deactivating the microphone of the first computer system). In some embodiments, the virtual object is configured to be movable and/or repositioned in the environment as other virtual objects are, such as application windows including other user interfaces and/or content, three-dimensional models or shapes, images, and/or other content displayed in the environment. In some embodiments, the first object is displayed at a predetermined location in the environment (e.g., selected automatically by the first computer system), optionally independent of a location of the second user in the environment. For example, the virtual object is displayed at a predetermined distance from a viewpoint of the first user and/or with a predetermined orientation (e.g., facing toward the viewpoint of the first user), rather than based on the location of the second user relative to the viewpoint of the first user.

In some embodiments, the real-time communication session is a spatial communication session. For example, the first and/or second computer systems initiate display of a shared three-dimensional environment to facilitate communication between the first user of the first computer system and the second user of the second computer system. In some embodiments, as previously discussed above, entering the spatial real-time communication session includes establishing a shared virtual space (e.g., in the form of a shared three-dimensional environment) in which media and other content is able to be shared between the first user and the second user, including the first object discussed below. In some embodiments, while the first user and the second user are in the spatial real-time communication session, the first user and the second user have unique viewpoints in the shared three-dimensional environment determined based on the locations of the first computer system and the second computer system, respectively, relative to the three-dimensional environment. In some embodiments, while the first computer system and the second computer system are in the spatial communication session, the first computer system displays a spatial visual representation of the second user in the environment. In some embodiments, the spatial visual representation of the second user corresponds to a virtual avatar. In some embodiments, the spatial visual representation visually provides the first user of the first computer system with an indication of a location and/or orientation of the second user in the virtual space within the spatial communication session relative to the viewpoint of the first user, whereas the virtual object (e.g., the non-spatial representation of the second user) described above does not visually provide the first user of the first computer system with an indication of a location and/or orientation of the second user in the virtual space relative to the viewpoint of the first user. Additionally, as opposed to the virtual object discussed above, the spatial visual representation of the second user is, in certain instances, not able to be movable and/or repositioned in the environment as other virtual objects are. For example, movement input directed to the spatial visual representation of the second user does not cause the first computer system to move the spatial visual representation of the second user relative to other virtual objects (e.g., virtual windows, as previously discussed above) that are shared and displayed in the virtual space within the spatial communication session. In some embodiments, the determination of whether the real-time communication session is a spatial communication session or a non-spatial communication session is based on the request itself (e.g., the initiating user selects/designates that the real-time communication session will be spatial or non-spatial). In some embodiments, the determination of whether the real-time communication session is a spatial communication session or a non-spatial communication session is based on whether content is being shared (e.g., whether the initiating user is sharing content with the other user), such as the invitation to share the first object discussed above.

In some embodiments, the first orientation of the first object corresponds to a horizontal orientation relative to the viewpoint of the user, as similarly described with reference to methods 800 and/or 900. For example, the first object is a three-dimensional horizontal virtual platter or plane relative to the viewpoint of the user in the three-dimensional environment and/or relative to a floor or ground or another surface in the three-dimensional environment. In some embodiments, the first object has the first orientation relative to gravity. In some embodiments, the second object is associated with a content creation application that is running on the first computer system. For example, as similarly described with reference to methods 800 and/or 900, the first object (e.g., a horizontal platter or plane) includes representations of a plurality of virtual assets corresponding to content, such as three-dimensional and/or two-dimensional virtual objects, including three-dimensional and/or two-dimensional images, models, shapes, and/or other predefined or existing virtual assets. In some embodiments, the first object includes representations of the plurality of virtual assets that are able to be interacted with in the environment to create content (e.g., groups of two-dimensional and/or three-dimensional assets, such as within a scene of content). In some embodiments, as similarly described with reference to method 900, the group of virtual assets corresponding to content in the three-dimensional environment is associated with (e.g., is anchored to and/or is housed within) the first object (e.g., as a scene of content). In some embodiments, the first object has one or more characteristics of the second object described with reference to method 900.

In some embodiments, the first object is shared between the first user and the second user at their respective computer systems in the real-time communication session. For example, within the shared virtual space of the real-time communication session, the first user and the second user experience spatial truth with respect to the first object via their respective computer systems, such that the first object, including the content of the first object (e.g., the representations of the plurality of virtual assets described above), is visible to and/or interactive to the first user at the first computer system and the second user at the second computer system. Accordingly, in some embodiments, as described in more detail below, respective input detected by the first computer system and/or the second computer system for interacting with the first object and/or the content of the first object causes the display of the first object to be updated in the shared virtual space, such that the update is reflected (e.g., visible) at both the first computer system and the second computer system within the real-time communication session. In some embodiments, the first object is displayed concurrently with the visual representation of the second user (e.g., the non-spatial virtual object or the spatial visual representation (e.g., virtual avatar)) of the second user described above) in the environment. In some embodiments, the first object is displayed in the environment based on and/or in accordance with data provided by the second computer system, such as display and/or image data defining one or more characteristics of the first object and its associated content (e.g., a visual appearance of the first object and/or the plurality of virtual assets and/or an interactivity of the first object and/or the plurality of virtual assets). In some embodiments, the first object is displayed in the environment using the content creation application discussed above. For example, the first computer system, after receiving the share request from the second computer system, launches the content creation application on the first computer system and uses data provided directly from the content creation application to display the first object in the environment.

In some embodiments, when the first computer system displays the first object in the environment after entering the real-time communication session with the second computer system, the first computer system displays a first option with the first object in the environment. In some embodiments, the first option corresponds to a user interface element of a plurality of user interface elements associated with the first object in the environment. For example, the plurality of user interface elements control one or more aspects of the display of the first object in the environment. In some embodiments, the plurality of user interface elements includes a movement element (e.g., a grabber bar or handlebar affordance) that is selectable to initiate movement of (e.g., repositioning of) the first object, including the content of the first object, within the environment (e.g., which is visible to both the first user and the second user as similarly discussed above). In some embodiments, the plurality of user interface elements includes an exit option that is selectable to cease display of the first object in the environment, and optionally cease sharing of the first object, including the content of the first object, in the real-time communication session. In some embodiments, the first option and the exit option are displayed at opposite ends and/or sides of the movement element in the environment. In some embodiments, the plurality of user interface elements is displayed below the first object (e.g., below a bottom surface of the first object) in the environment from the viewpoint of the first user. In some embodiments, the plurality of user interface elements is displayed overlaid on a portion of the first object in the environment from the viewpoint of the first user. In some embodiments, the plurality of user interface elements is displayed at an alternative location relative to the first object and proximate to the first object in the environment, such as above the first object or to a side of the first object, from the viewpoint of the first user. In some embodiments, as described in more detail below, the first option is selectable to display a second object that is associated with the first object in the environment (e.g., a virtual object associated with the same content creation application running on the first computer system and/or the second computer system).

In some embodiments, while displaying the first object with the first option in the environment, the first computer system detects (1106), via the one or more input devices, a first input corresponding to a selection of the first option, such as the selection input directed to the selectable option 1035 performed by hand 1005 of second user 1004 in FIG. 10E. For example, the first computer system detects an air pinch gesture performed by a hand of the first user, optionally while the attention (e.g., gaze) of the first user is directed to the first option in the three-dimensional environment. In some embodiments, the first input has one or more characteristics of the inputs described with reference to methods 800 and/or 900.

In some embodiments, in response to detecting the first input (1108), the first computer system displays (1110), via the one or more display generation components, the second object (e.g., a virtual object) that is associated with the first object in the environment, such as the display of virtual object 1020-1 in FIG. 10F, wherein the second object has a second orientation (e.g., different from the first orientation) relative to the viewpoint of the first user, wherein the second object is not shared between the first user and the second user in the real-time communication session. For example, in response to detecting the first input, the first computer system displays a virtual object having a vertical orientation in the three-dimensional environment relative to the viewpoint of the first user. In some embodiments, a front-facing surface of the second object is and/or appears to be flat relative to the viewpoint of the first user in the three-dimensional environment and/or relative to a floor or ground or another surface in the three-dimensional environment. In some embodiments, displaying the second object with the second orientation includes displaying the second object with a respective amount of tilt or angular rotation that causes the front-facing surface of the second object to visually appear to be tilted toward or away from the viewpoint of the first user in the environment. In some embodiments, the first computer system maintains display of the second object in the environment when the first object is displayed in the environment. In some embodiments, the second object includes a plurality of virtual assets corresponding to the representations of the plurality of virtual assets displayed on and/or within the first object described above. For example, the second object functions as a visual library of three-dimensional and/or two-dimensional assets, such as images, models, shapes, and other virtual objects, that can be added to the first object (e.g., via input directed to a respective virtual asset in the second object) to create a scene of content associated with the second object, as similarly described with reference to method 800. In some embodiments, the second object is displayed at a predefined (e.g., initial) location relative to the first object in the environment. For example, the second object is displayed at a location that is behind the first object (e.g., centered on the first object) and/or is above the first object in the three-dimensional environment from the viewpoint of the first user. In some embodiments, the second object has one or more characteristics of the first object described with reference to method 900.

In some embodiments, when the first computer system displays the second object in the environment, the second object is displayed as a private object in the environment. For example, the second object, including the content of the second object, is private to the first user at the first computer system. In some embodiments, because the second object is not shared between the first user and the second user, the second object is visible to and/or interactive to only the first user at the first computer system. Accordingly, the second computer system optionally does not display the second object in a three-dimensional environment displayed at the second computer system and/or does not coordinate/synchronize the display of the second object in the three-dimensional environment displayed at the second computer system. For example, while the first user and the second user are in the real-time communication session, the second computer system is configured to also display a vertical virtual object that is similar to the second object, but the vertical virtual object that is displayed by the second computer system is private to the second user at the second computer system. As such, the first computer system and the second computer system can optionally independently display instances of the vertical virtual object (e.g., the second object described above), but the computer systems do not display the same, shared instance of the vertical virtual object within the real-time communication session (e.g., in the way that the computer systems are displaying a shared, synchronized instance of the first object described above (e.g., the horizontal virtual object)). Accordingly, in some embodiments, the first user and the second user do not experience spatial truth via their respective computer systems with respect to the second object (e.g., despite experiencing spatial truth with respect to the first object as discussed above). For example, if the first computer system detects input directed to the second object, such as input for moving the second object, the first computer system updates display of the second object in the environment in accordance with the input, without transmitting data or other instructions to the second computer system for similarly updating display of the second object (e.g., if the second object is displayed at the second computer system) at the second computer system (e.g., because the second object is private to the first user), as discussed in more detail below.

In some embodiments, in response to detecting the first indication, entering the real-time communication session with the second user further includes displaying, via the one or more display generation components, a visual representation of the second user concurrently with the first object in the environment, such as visual representation (e.g., virtual object 1020) of the second user 1004 in top-down view 1010 in FIG. 10D. For example, as similarly described above, the first computer system displays a virtual object or virtual avatar representing the second user in the three-dimensional environment. In some embodiments, as similarly discussed above, one or more visual properties (e.g., a type and/or form) of the visual representation of the second user are based on whether the real-time communication session is a spatial communication session or a non-spatial communication session. For example, if the real-time communication session is a spatial communication session, as discussed above, the visual representation of the second user is a virtual avatar (e.g., or similar virtual representation) of the second user that is concurrently displayed with the first object in the three-dimensional environment. In some embodiments, if the real-time communication session is a non-spatial communication session, as discussed above, the visual representation of the second user is a virtual object, such as a user interface, that includes a video or other (e.g., two-dimensional) image or representation of the second user. In some embodiments, the visual representations of the second user and the first object have a first (e.g., predefined) spatial arrangement relative to the viewpoint of the first user in the environment when the first computer system and the second computer system enter the real-time communication session. For example, the visual representation of the second user, the first object, and the viewpoint of the first user occupy unique locations in the three-dimensional environment, such that the first user and the second user experience and/or interact with shared content (e.g., the first object) within the real-time communication session via their unique viewpoints. In some embodiments, the one or more visual properties of the visual representation of the second user are based on whether the second user (e.g., and/or the second computer system) is collocated or non-collocated with (e.g., proximate or not proximate to) the first user (e.g., and/or the first computer system) in the environment when entering the real-time communication session. Particularly, if the first user and the second user are collocated in a physical environment of the first user, the first computer system presents/displays the visual representation of the second user as a passthrough or see-through representation that is displayed or otherwise visible via the one or more displays of the first computer system. For example, the second user is represented in the three-dimensional environment by their physical body/person because the second user is proximate to (e.g., in the same room or space as) the first user while in the real-time communication session. In some embodiments, if the first user and the second user are non-collocated in the physical environment of the first user, the first computer system displays the visual representation of the second user as the virtual avatar or non-spatial virtual object (e.g., user interface) described above.

In some embodiments, while displaying the first object and the visual representation of the second user in the environment, the first computer system detects, via the one or more input devices, a second input corresponding to a request to move the first object in the environment, such as the movement input directed to the virtual object 1011 in the second three-dimensional environment 1040 performed by the hand 1005 of the second user 1004 in FIG. 10G. For example, the first computer system detects an air pinch and drag gesture directed to the first object in the three-dimensional environment. In some embodiments, the second input includes an air pinch gesture performed by a hand of the first user, optionally while attention (e.g., including gaze) of the first user is directed to the first object. In some embodiments, the attention of the first user is directed to the movement element associated with the first object, as previously described above. In some embodiments, the second input includes movement of the hand of the first user in space (optionally while maintaining the air pinch gesture) relative to the viewpoint of the first user. In some embodiments, the first computer system detects the movement of the hand of the first user in a respective direction (e.g., relative to the viewpoint of the first user) and/or with a respective magnitude (e.g., of speed, distance, and/or duration). In some embodiments, the second input has one or more characteristics of the inputs described in methods 800 and/or 900.

In some embodiments, in response to detecting the second input, the first computer system updates a spatial arrangement of the first object and the visual representation of the second user in the environment relative to the viewpoint of the first user in accordance with the second input, such as the movement of the virtual object 1011 and visual representation 1022 of the first user 1002 in second three-dimensional environment 1040 shown in FIG. 10H. For example, the first computer system moves the first object in the three-dimensional environment relative to the viewpoint of the first user in accordance with the movement of the hand of the first user. In some embodiments, updating the spatial arrangement of the first object and the visual representation of the second user in the environment includes concurrently moving the first object and the visual representation of the second user in the environment relative to the viewpoint of the first user (e.g., because the first object is shared between the first user and the second user in the real-time communication session). For example, if the real-time communication session is a spatial communication session (e.g., the visual representation of the second user is a virtual avatar of the second user), the first computer system concurrently moves the first object and the visual representation of the second user in a first direction and/or with a first magnitude that is based on the movement of the hand of the first user discussed above. In some embodiments, when the first computer system updates the spatial arrangement of the first object and the visual representation of the second user in the environment, the first computer system transmits data corresponding to the second input to the second computer system (e.g., data indicating that the first user has moved the shared horizontal virtual object in the shared virtual space of the real-time communication session), as discussed in more detail below. In some embodiments, if the second object is displayed in the environment when the second input is detected, updating the spatial arrangement of the first object and the visual representation of the second user includes forgoing movement of the second object in the environment relative to the viewpoint of the first user (e.g., because the second object is not shared between the first user and the second user in the real-time communication session). In some embodiments, if the real-time communication session is a non-spatial communication session (e.g., the visual representation of the second user is a user interface that includes an image or video of the second user), the first computer system moves the first object in the environment without moving the visual representation of the second user when updating the spatial arrangement of the first object and the visual representation of the second user relative to the viewpoint of the first user. Similarly, in some embodiments, if the real-time communication session is a spatial communication session in which the second user is collocated in the environment with the first user (e.g., the visual representation of the second user is a passthrough or see-through representation of the second user), the first computer system moves the first object in the environment without moving or otherwise updating display of the visual representation of the second user when updating the spatial arrangement of the first object and the visual representation of the second user relative to the viewpoint of the first user (e.g., because the second user is being visually represented via their physical body within the real-time communication session).

In some embodiments, the first object is displayed with a plurality of user interface elements, including the first option and a movement element, such as movement element 1032 in FIG. 10E. In some embodiments, the plurality of user interface elements corresponds to the plurality of user interface elements described above. For example, the plurality of user interface elements is displayed relative to (e.g., below) the first object in the three-dimensional environment from the viewpoint of the first user. In some embodiments, the movement element is selectable to initiate movement of the first object within the environment relative to the viewpoint of the first user.

In some embodiments, the first option is displayed adjacent to the movement element relative to the first object in the environment, such as the selectable option 1035 being displayed adjacent to the movement element 1032 in FIG. 10E. For example, the plurality of user interface elements is displayed as a row of user interface elements relative to (e.g., below) the first object, and the first option is displayed next to the movement element within the row of user interface elements. In some embodiments, the first option is displayed to a left side of the movement element from the viewpoint of the first user. In some embodiments, the first option is displayed to a right side of the movement element from the viewpoint of the first user. In some embodiments, the first computer system actively displays and/or reveals the first option of the plurality of user interface elements in response to detecting the attention (e.g., gaze) of the first user directed to the first object and/or the movement element in the environment. In some embodiments, the first computer system displays the first option concurrently with the movement element irrespective of the location of the attention of the first user (e.g., so long as the first object is displayed in the environment).

In some embodiments, while displaying the first object, the plurality of user interface elements, and the second object in the environment, the first computer system detects, via the one or more input devices, a second input corresponding to a selection of the first option in the environment, such as the selection input directed to the selectable option 1035 performed by the hand 1005 of the second user 1004 in FIG. 10K. For example, the first computer system detects an air pinch gesture directed to the first option in the three-dimensional environment. In some embodiments, the first computer system detects the air pinch gesture performed by the hand of the first user while the attention (e.g., including the gaze) of the first user is directed to the first option in the three-dimensional environment. In some embodiments, the second input corresponds to a second selection (e.g., a reselection) of the first option in the environment. For example, the first computer system detects the second selection after the second object has already been displayed in the three-dimensional environment in response to detecting the first input discussed above. In some embodiments, the second input has one or more characteristics of the inputs described in methods 800 and/or 900.

In some embodiments, in response to detecting the second input, the first computer system ceases display, via the one or more display generation components, of the second object in the environment, while maintaining display of the first object and the plurality of user interface elements in the environment, such as ceasing display of the virtual object 1020-1 while maintaining display of the virtual object 1011 in the second three-dimensional environment 1040 as shown in FIG. 10L. For example, in response to detecting the second selection of the first option after displaying the second object in the three-dimensional environment, the first computer system ceases display of the second object in the three-dimensional environment. In some embodiments, the first computer system forgoes transmitting data to the second computer system corresponding to the second input in response to detecting the second input. For example, because the second object is not shared between the first user and the second user in the real-time communication session, the first computer system forgoes providing an indication to the second computer system that the second object is no longer displayed in the three-dimensional environment at the first computer system. In other words, ceasing display of the second object in the environment in response to detecting the second input optionally does not affect the display of a similar vertical virtual object (e.g., a separate, unshared instance of the second object) that is displayed at the second computer system during the real-time communication session. Additionally, in some embodiments, as mentioned above, ceasing display of the second object in the environment does not change and/or affect the display of the first object and its associated plurality of user interface elements in the environment.

In some embodiments, when the second object is displayed in the environment in response to detecting the first input, the second object is displayed at a first location relative to the first object in the environment, such as the virtual object 1020-1 being centered on the virtual object 1011 in the second three-dimensional environment 1040 as shown in FIG. 10F. For example, as mentioned above, the second object is displayed at a predetermined location relative to the first object in the three-dimensional environment. In some embodiments, the first location corresponds to a location that is behind the first object from the viewpoint of the first user in the environment. In some embodiments, the first location corresponds to a location that is centered on the first object from the viewpoint of the first user in the environment. In some embodiments, the first location corresponds to a location that is above the first object from the viewpoint of the first user in the environment. In some embodiments, the first location corresponds to a location that is adjacent to (e.g., to a side of) the first object from the viewpoint of the first user in the environment. In some embodiments, displaying the second object at the first location has one or more characteristics of the display of horizontal virtual objects as described in methods 800 and/or 900.

In some embodiments, while displaying the first object and the second object at the first location relative to the first object in the environment, the first computer system detects, via the one or more input devices, a second input corresponding to a request to move the second object in the environment, such as the movement input directed to the virtual object 1020-1 provided by the hand 1005 of the second user 1004 in FIG. 10F. For example, the first computer system detects an air pinch and drag gesture directed to the second object in the three-dimensional environment. In some embodiments, the second input includes an air pinch gesture performed by a hand of the first user, optionally while attention (e.g., including gaze) of the first user is directed to the second object. In some embodiments, the attention of the first user is directed to a movement element associated with the second object (e.g., a grabber bar or handlebar affordance displayed with the second object in the environment), as similarly described above. In some embodiments, the second input includes movement of the hand of the first user in space (optionally while maintaining the air pinch gesture) relative to the viewpoint of the first user. In some embodiments, the first computer system detects the movement of the hand of the first user in a respective direction (e.g., relative to the viewpoint of the first user) and/or with a respective magnitude (e.g., of speed, distance, and/or duration). In some embodiments, the second input has one or more characteristics of the inputs described in methods 800 and/or 900.

In some embodiments, in response to detecting the second input, the first computer system moves the second to a second location, different from the first location, relative to the first object in the environment, without moving (e.g., the first computer system forgoes moving) the first object in the environment, in accordance with the second input, such as the movement of the virtual object 1020-1 in the second three-dimensional environment 1040 without moving the virtual object 1011 as shown in FIG. 10G. For example, the first computer system moves the second object in the three-dimensional environment relative to the viewpoint of the first user in accordance with the movement of the hand of the first user. In some embodiments, as mentioned above, the first computer system moves the second object and maintains display of the first object at its position within the environment in response to detecting the second input because the second object is not shared between the first user and the second user in the real-time communication session. In some embodiments, because the second object is private to the first user at the first computer system, the first computer system performs the private movement of the second object to the second location relative to the first object irrespective of whether the real-time communication session is a non-spatial communication session or a spatial communication session, as discussed above. In some embodiments, the first computer system forgoes transmitting data to the second computer system corresponding to the second input in response to detecting the second input. For example, because the second object is not shared between the first user and the second user in the real-time communication session, the first computer system forgoes providing an indication to the second computer system that the second object has been moved in the three-dimensional environment at the first computer system. In other words, moving the second object in the environment in response to detecting the second input optionally does not affect the display of a similar vertical virtual object (e.g., a separate, unshared instance of the second object) that is displayed at the second computer system during the real-time communication session.

In some embodiments, the second user of the second computer system is collocated with (e.g., is proximate to, such as within a threshold distance of) the first user in the environment, such as the first user 1002 and the second user 1004 being located in the same physical room as shown in FIG. 10N. For example, as previously described above, the second user of the second computer system and the first user of the first computer system are physically in the same or similar location (e.g., room, building, area, and/or space) when the real-time communication session is initiated. In some embodiments, the determination that the second user and the first user are collocated in the environment is based on a wireless signal transferred between the first computer system and the second computer system. For example, the first and/or second computer systems optionally detect and evaluate a strength of a received signal power, signal-to-noise ratio, signal quality, signal energy, and/or another suitable signal metric(s) of one or more signals transmitted by the other computer system, including Wireless Fidelity (Wi-Fi), BlueTooth®, and/or cellular communication. In some embodiments, the determination that the second user and the first user are collocated in the environment is based on the first computer system and the second computer system being within range and/or actively connected to a same wireless network. In some embodiments, the determination that the second user and the first user are collocated in the environment is based on a determination that the first computer system and the second computer system detect a same sound in the environment. For example, the first computer system determines that a sound generated by the first computer system is audible to the second computer system in response to obtaining an indication of that sound from the second computer system, including ambient sounds from the environment and/or speech of the first user and/or the second user. In some embodiments, the determination that the second user and the first user are collocated in the environment is based on a determination that at least a portion of the second user of the second computer system is included within the viewport of the first computer system. For example, the first computer system optionally detects that one or more image sensors indicate a portion of the body of the second user of the second computer system is visible to the first user. It is understood that the determination that the second user is collocated or non-collocated with the first user in the environment is based on any one or combination of the above factors. In some embodiments, as similarly described above, the second user is visually represented in the environment via their physical body, rather than via a virtual avatar or other virtual object or user interface, because the first user and the second user are collocated in the environment (e.g., a visual representation of the second user corresponds to a passthrough or see-through representation in the environment).

In some embodiments, while displaying the first object and the second object in the environment, the first computer system detects, via the one or more input devices, a second input corresponding to a request to move the first object in the environment, such as the movement input directed to virtual object 1011 provided by hand 1003 of the first user 1002 shown in FIG. 10N. For example, the first computer system detects an air pinch and drag gesture directed to the first object in the three-dimensional environment. In some embodiments, the second input includes an air pinch gesture performed by a hand of the first user, optionally while attention (e.g., including gaze) of the first user is directed to the first object. In some embodiments, the attention of the first user is directed to the movement element associated with the first object, as previously described above. In some embodiments, the second input includes movement of the hand of the first user in space (optionally while maintaining the air pinch gesture) relative to the viewpoint of the first user. In some embodiments, the first computer system detects the movement of the hand of the first user in a respective direction (e.g., relative to the viewpoint of the first user) and/or with a respective magnitude (e.g., of speed, distance, and/or duration). In some embodiments, the second input has one or more characteristics of the inputs described in methods 800 and/or 900.

In some embodiments, in response to detecting the second input, the first computer system moves the first object in the environment relative to the viewpoint of the first user, without moving (e.g., the first computer system forgoes moving) the second object in the environment, in accordance with the second input, such as moving the virtual object 1011 in the first three-dimensional environment 1000 in accordance with the movement of the hand 1003 as shown in FIG. 10O. For example, the first computer system moves the first object in the three-dimensional environment relative to the viewpoint of the first user in accordance with the movement of the hand of the first user. In some embodiments, the first computer system moves the first object in the environment because the first object is shared between the first user and the second user in the real-time communication session. In some embodiments, the first computer system maintains display of the second object at its position in the environment because the second object is not shared between the first user and the second user in the real-time communication session. In some embodiments, when the first computer system moves the first object in the environment in response to detecting the second input, the first computer system transmits data corresponding to the second input to the second computer system (e.g., data indicating that the first user has moved the shared horizontal virtual object in the shared virtual space of the real-time communication session), as discussed in more detail below. In some embodiments, if the second object is displayed in the environment when the second input is detected, updating the spatial arrangement of the first object and the visual representation of the second user includes forgoing movement of the second object in the environment relative to the viewpoint of the first user (e.g., because the second object is not shared between the first user and the second user in the real-time communication session). Similarly, in some embodiments, the first computer system moves the first object in the environment without moving or otherwise updating display of the visual representation of the second user when moving the first object relative to the viewpoint of the first user (e.g., because the second user is being visually represented via their physical body within the real-time communication session).

In some embodiments, the first object includes one or more representations of one or more virtual assets, such as representations 1024a and 1024b displayed on the virtual object 1011 as shown in FIG. 10I. For example, as similarly described above, the first object contains and/or is displayed with content items, such as two-dimensional and/or three-dimensional virtual objects, images, models, labels, annotations, and/or shapes, that are individually movable relative to the first object to define and/or update a spatial arrangement of (e.g., the scene of) the content items. In some embodiments, the one or more representations of the one or more virtual assets are displayed above and/or atop a top (e.g., flat) surface of the first object from the viewpoint of the first user in the environment. In some embodiments, as discussed in more detail below, because the first object is shared between the first user and the second user within the real-time communication session, the one or more representations of the one or more virtual assets that are displayed on and/or within the first object are also shared between the first user and the second user within the real-time communication session. In some embodiments, the one or more representations of the one or more virtual assets have one or more characteristics of representations of virtual assets described with reference to methods 800 and/or 900.

In some embodiments, while displaying the first object that includes the one or more representations of the one or more virtual assets in the environment, the first computer system detects, via the one or more input devices, a second input corresponding to a request to update display of the one or more representations of the one or more virtual assets, such as the movement input directed to the representation 1024b provided by the hand 1003 of the first user 1002 in FIG. 10I. In some embodiments, the second input corresponds to a movement input that is directed to a first representation of a first virtual asset of the one or more representations of the one or more virtual assets in the environment. For example, the first computer system detects an air pinch and drag gesture directed to the first representation of the first virtual asset that is displayed on the first object in the three-dimensional environment. In some embodiments, the second input includes an air pinch gesture performed by a hand of the first user, optionally while attention (e.g., including gaze) of the first user is directed to the first representation of the first virtual asset. In some embodiments, the second input includes movement of the hand of the first user in space (optionally while maintaining the air pinch gesture) relative to the viewpoint of the first user. In some embodiments, the first computer system detects the movement of the hand of the first user in a respective direction (e.g., relative to the viewpoint of the first user) and/or with a respective magnitude (e.g., of speed, distance, and/or duration). In some embodiments, the second input corresponds to a request to add a new or additional representation of a virtual asset to the one or more representations of the one or more virtual assets in the environment. For example, when the second input is detected, the first computer system is concurrently displaying the first object and the second object (e.g., the private vertical virtual object) that is associated with the first object in the three-dimensional environment. In some embodiments, as previously discussed above, the second object includes a plurality of virtual assets, including the one or more virtual assets that are displayed on the first object in the environment. For example, the second object serves as a visual repository or library of virtual assets (e.g., content items) that are able to be selected and added onto the first object in the environment for associating a respective virtual asset with the one or more virtual assets on the first object (e.g., as a scene of content), as similarly described in method 800. In some embodiments, the second input corresponds to a movement input that is directed to a first virtual asset that is displayed in the second object in the environment. For example, the first computer system detects an air pinch and drag gesture directed to the first virtual asset that is displayed on the second object in the three-dimensional environment. In some embodiments, the second input includes an air pinch gesture performed by a hand of the first user, optionally while attention (e.g., including gaze) of the first user is directed to the first virtual asset in the second object. In some embodiments, the second input includes movement of the hand of the first user in space (optionally while maintaining the air pinch gesture) corresponding to movement of the first virtual asset from the second object toward a surface of the first object relative to the viewpoint of the first user. Alternatively, in some embodiments, the second input corresponds to a request to delete or remove a respective representation of a respective virtual asset from the one or more representations of the one or more virtual assets in the environment. For example, the second input includes an air pinch and drag gesture that includes movement of a second representation of a second virtual asset from the first object toward the second object in the three-dimensional environment. In some embodiments, the second input has one or more characteristics of the inputs described in methods 800 and/or 900.

In some embodiments, in response to detecting the second input, the first computer system updates display, via the one or more display generation components, of one or more visual properties of (e.g., positions, orientations, spatial arrangements, quantity, size, and/or color of) the one or more representations of the one or more virtual assets on the first object in accordance with the second input, such as the movement of the representation 1024b relative to the virtual object 1011 as shown in FIG. 10J. For example, if the second input corresponds to movement of the first representation of the first virtual asset relative to the first object, the first computer system moves the first representation of the first virtual asset relative to the first object in the environment. In some embodiments, the movement of the first representation of the first virtual asset causes a spatial arrangement of the one or more representations of the one or more virtual assets to be updated on the first object in the environment (e.g., as a result of the updated position of the first representation of the first virtual asset on the surface of the first object). In some embodiments, the movement of the first representation of the first virtual asset has one or more characteristics of movement of representations of virtual assets described in methods 800 and/or 900. In some embodiments, if the second input corresponds to a request to add a new and/or additional virtual asset to the one or more representations of one or more virtual assets on the first object, the first computer updates display of the one or more representations of the one or more virtual assets to include a new representation of a new virtual asset on the first object in the environment. For example, the first computer system adds the first virtual asset from the second object (e.g., the vertical virtual object) to the first object in the three-dimensional environment in response to detecting the second input, thereby increasing the number of representations of virtual assets displayed on the first object. In some embodiments, a first representation of the first virtual asset is displayed at a location and/or with an orientation relative to (e.g., on or above) the first object in the environment that is based on the second input. For example, the location of the first representation of the first virtual asset on the top surface of the first object corresponds to a location of the first virtual asset when the first computer system detected termination of (e.g., release of) the second input. Alternatively, in some embodiments, if the second input corresponds to a request to delete or remove a respective representation of a respective virtual assets from the one or more representations of the one or more virtual assets on the first object, the first computer system updates display of the one or more representations of the one or more virtual assets to no longer include a second representation of a second virtual asset on the first object in the environment. For example, the first computer system deletes the second virtual asset from the first object and adds the second virtual asset to the second object in the three-dimensional environment in response to detecting the second input, thereby decreasing the number of representations of virtual assets displayed on the first object.

In some embodiments, in response to detecting the second input, the first computer system transmits, to the second computer system, data corresponding to the second input for updating the display of the one or more representations of the one or more virtual assets on the first object, such as transmitting data to the second computer system 101b that causes the second computer system 101b to move the representation 1024b relative to the virtual object 1011 in the second three-dimensional environment 1040 in FIG. 10J. In some embodiments, as discussed above, because the first object is shared between the first user and the second user within the real-time communication session, interactions with the first object (e.g., movement of the first object, rotation of the first object, resizing of the first object, and/or closing of the first object) are synchronized between the first computer system and the second computer system. Thus, because the first object is shared between the first user and the second user within the real-time communication session, interactions with the content of the first object are optionally also synchronized between the first computer system and the second computer system. As mentioned above, synchronizing interactions with shared content within the real-time communication session includes exchanging data corresponding to the interactions between the first computer system and the second computer system. Accordingly, in some embodiments, when the first computer system updates display of the content (e.g., the one or more representations of the one or more virtual assets) of the first object in the environment, the first computer system transmits data corresponding to the interaction to the second computer system, which enables and/or causes the second computer system to correspondingly update display of its own instance of the content that is displayed at the second computer system. For example, as mentioned above, because the first object is shared between the first user and the second user in the real-time communication session, the first object (e.g., a shared instance or version of the first object) is displayed in three-dimensional environments at both the first computer system and the second computer system (e.g., within the shared virtual space of the real-time communication session). Thus, if the first computer system moves a respective representation of a respective virtual asset relative to the first object in the environment (e.g., repositions the respective representation of the surface of the first object) in response to the second input, the data corresponding to the second input that is transmitted to the second computer system enables and/or causes the second computer system to similarly and/or correspondingly move the (e.g., same) respective representation of the respective virtual asset relative to the version of the first object that is displayed at the second computer system. In some embodiments, the data transmitted from the first computer system to the second computer system includes an indication of an updated display state (e.g., updated display location, orientation, size, color, and/or quantity) of the one or more representations of the one or more virtual assets of the first object. In some embodiments, the data transmitted from the first computer system to the second computer system includes express instructions for updating display of the one or more representations of the one or more virtual assets of the first object. Other interactions with the one or more representations of the one or more virtual assets, including the interactions described above (e.g., adding and/or deleting virtual assets from the first object), are similarly synchronized between the first computer system and the second computer system within the real-time communication session.

In some embodiments, the first object includes one or more representations of one or more virtual assets (e.g., corresponding to the one or more representations of the one or more virtual assets described above that are displayed relative to (e.g., on or above) the first object in the three-dimensional environment), such as representations 1024a and 1024b displayed on the virtual object 1011 as shown in FIG. 10I. In some embodiments, while displaying the first object that includes the one or more representations of the one or more virtual assets in the environment, the first computer system receives, from the second computer system, data corresponding to respective input detected by the second computer system for updating display of the one or more representations of the one or more virtual assets, such as the second computer system 101b receiving data from the first computer system 101a corresponding to movement of the representation 1024b relative to the virtual object 1011 in FIG. 10J. For example, the second computer system has detected user input (e.g., provided by the second user) corresponding to one or more interactions with the content (e.g., the one or more representations of the one or more virtual assets) of the first object in a three-dimensional environment displayed at the second computer system. In some embodiments, the respective input has one or more characteristics of the inputs described above and/or in methods 800 and/or 900. In some embodiments, the respective input for updating display of the one or more representations of the one or more virtual assets corresponds to any one or combination of the interactions described above (e.g., moving a respective representation of a virtual asset, adding a new virtual asset, and/or deleting a virtual asset). In some embodiments, as similarly described above, because the first object is shared between the first user and the second user within the real-time communication session, the first computer system and the second computer system synchronize user interactions with the first object and/or the content of the first object. Thus, the second computer system optionally transmits the data corresponding to the respective input to the first computer system when the second computer system updates display of the one or more representations of the one or more virtual assets of the first object in response to detecting the respective input.

In some embodiments, in response to receiving the data, the first computer system updates display, via the one or more display generation components, of one or more visual properties of (e.g., positions, orientations, spatial arrangements, quantity, size, and/or color of) the one or more representations of the one or more virtual assets of the first object in the environment in accordance with the data, such as the second computer system 101b moving the representation 1024b relative to the virtual object 1011 in the second three-dimensional environment 1040 in FIG. 10J. For example, the data enables and/or causes the first computer system to update display of the one or more representations of the one or more virtual assets in accordance with and/or based on the update performed by the second computer system. In some embodiments, the data provided by the second computer system includes an indication of an updated display state (e.g., updated display location, orientation, size, color, and/or quantity) of the one or more representations of the one or more virtual assets of the first object. Accordingly, in response to receiving the data, to maintain spatial truth and display consistency of the first object that is shared between the first user and the second user, the first computer system optionally utilizes the data to correspondingly reposition one or more of the representations of the virtual assets, update an orientation of one or more representations of the virtual assets, resize one or more of the representations of the virtual assets, change a color of one or more of the representations of the virtual assets, and/or increase or decrease a number of the one or more representations of the one or more virtual assets in the environment. In some embodiments, the data transmitted from the second computer system to the first computer system includes express instructions for updating display of the one or more representations of the one or more virtual assets of the first object in the environment. Thus, in some embodiments, the exchange of data between the first computer system and the second computer system in response to detecting interactions with the first object and/or the content of the first object enables the interactions to be synchronized between the first user and the second user in real time.

In some embodiments, while displaying the first object and the second object in the environment, the first computer system detects a second indication of a request to cease one or more aspects of the communication between the first user and the second user, such as the selection input directed to end option 1043 provided by the hand 1003 of the first user 1002 corresponding to a request to end the real-time communication session. For example, while the first object is shared between the first user and the second user in the real-time communication session, and after displaying the second object in the environment in response to detecting the first input, the first computer system receives an input or other indication for ending the real-time communication session between the first user and the second user. In some embodiments, detecting the second indication includes detecting input provided by the first user for ending the real-time communication session between the first user and the second user. For example, the first computer system detects a selection of (e.g., via an air pinch gesture provided by the first user) an option for ending the real-time communication session, such as an end call or end session option that is displayed in a settings user interface associated with the real-time communication session. In some embodiments, detecting the second indication includes detecting input provided by the first user for ceasing the sharing of the first object between the first user and the second user (e.g., without necessarily ending the real-time communication session). For example, the first object includes a user interface element (e.g., an option, pill, label, or other indication) indicating that the first object is shared between the first user and the second user, and which is selectable to control one or more sharing settings for the first object, including ceasing the sharing of the first object between the first user and the second user. In some embodiments, detecting the second indication includes detecting input corresponding to the first user ceasing use of the first computer system. For example, the first computer system detects a selection or press of a power button, a sleep button, or detects disassociation of the first computer system from the first user (e.g., the first user removes the first computer system that is being worn on their head), which indicates that the first user is no longer using the first computer system. In some embodiments, detecting the second indication includes detecting a loss or end of communication (e.g., over Wi-Fi or cellular data) from the second computer system, indicating that the second computer system has detected input from the second computer system for ending the real-time communication session (e.g., similar to the inputs described above). In some embodiments, detecting the second indication includes detecting a loss or end of streaming data or other data provided by the second computer system for displaying the first object in the environment. For example, the first computer system receives information from the second computer system that the first object is no longer being shared between the first user and the second user (e.g., as a result of input provided by the second user for ending the sharing of the first object with the first user, similar to the inputs discussed above).

In some embodiments, in response to detecting the second indication, the first computer system ends the sharing of the first object between the first user and the second user, including ceasing display, via the one or more display generation components, of the first object and the second object in the environment, such as the second computer system 101b ceasing display of the virtual object 1011 in the second three-dimensional environment 1040 as shown in FIG. 10M. For example, the second computer system ceases sharing the first object with the first computer system, which causes the first computer system to cease display of the first object in the three-dimensional environment. In some embodiments, because the second object is associated with the first object (e.g., is an accompanying virtual object to the first object) and is thus tied to the display of the first object, ceasing display of the first object causes the first computer system to also cease display of the second object (e.g., despite the second object being private to the first object). In some embodiments, as alluded to above, ending the sharing of the first object between the first user and the second user includes ending the real-time communication session between the first user and the second user. For example, because the real-time communication session is ended (e.g., the first user or the second user ends the call or video session), the sharing of any content, including the first object, is ended between the computer systems. Additionally, in some embodiments, ending the real-time communication session causes the visual representation of the second user (e.g., the virtual avatar or other virtual object representing the second user) discussed previously above to cease being displayed in the environment. In some embodiments, if the sharing of the first object between the first user and the second user does not include and/or is not as a result of ending the real-time communication session, the first computer system ceases display of the first object and the second object in the environment while continuing to facilitate the real-time communication session with the second computer system. For example, though the first object and the second object are no longer displayed in the three-dimensional environment, the first computer system continues to provide audio and/or video capabilities of the users with the second computer system, optionally continuing to display the visual representation of the second user described previously above in the three-dimensional environment.

It should be understood that the particular order in which the operations in method 1100 have been described is merely exemplary and is not intended to indicate that the described order is the only order in which the operations could be performed. It should be understood that the particular order in which the operations in method 1100 have been described is merely exemplary and is not intended to indicate that the described order is the only order in which the operations could be performed. One of ordinary skill in the art would recognize various ways to reorder the operations described herein. In some embodiments, aspects/operations of methods 800, 900, and/or 1100 may be interchanged, substituted, and/or added between these methods. For example, the three-dimensional environment in methods 800, 900 and/or 1100, the virtual content and/or virtual objects in methods 800, 900 and/or 1100, and/or the interactions with virtual content and/or the virtual objects in methods 800, 900 and/or 1100 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method comprising:
at a computer system in communication with one or more display generation components and one or more input devices:
while displaying, via the one or more display generation components, a first object including one or more representations of virtual assets in an environment, the first object having a first orientation relative to a current viewpoint of a user of the computer system, detecting, via the one or more input devices, a first input directed to a first representation of a first virtual asset of the one or more representations of virtual assets; and
in response to detecting the first input, in accordance with a determination that the first input satisfies one or more first criteria:
displaying, via the one or more display generation components, a second object, different from the first object, in the environment, the second object having a second orientation, different from the first orientation, relative to the current viewpoint of the user; and
displaying, via the one or more display generation components, the first representation of the first virtual asset of the one or more representations of virtual assets relative to the second object in the environment.

2. The method of claim 1, wherein displaying the first object including the one or more representations of the virtual assets in the environment includes displaying, via the one or more display generation components, a view of the one or more representations of the virtual assets within a three-dimensional space associated with the first object.

3. The method of claim 1, wherein displaying the first representation of the first virtual asset relative to the second object in the environment includes displaying the first representation of the first virtual asset in the environment above a top plane of the second object from the current viewpoint of the user.

4. The method of claim 1, wherein displaying the second object in the environment includes displaying, via the one or more display generation components, the second object concurrently with the first object in the environment.

5. The method of claim 1, further comprising:
while displaying the first representation of the first virtual asset relative to the second object, displaying, via the one or more display generation components, a second representation, different from the first representation, of the first virtual asset in the first object in the environment.

6. The method of claim 1, wherein the first input corresponds to a request to move the first representation of the first virtual asset in the environment, and the one or more first criteria include a criterion that is satisfied when a movement of the first representation of the first virtual asset causes at least a portion of the first representation of the first virtual asset to exceed a front plane of the first object from the current viewpoint of the user.

7. The method of claim 1, further comprising:
in accordance with a determination that the first input does not satisfy the one or more first criteria, forgoing displaying the second object in the environment.

8. The method of claim 1, wherein displaying the second object in the environment includes:
while detecting the first input, and while the one or more first criteria are satisfied, displaying the second object in the environment with a first visual appearance, and
in response to detecting an end of the first input while the one or more first criteria are satisfied, displaying the second object in the environment with a second visual appearance, different from the first visual appearance.

9. The method of claim 1, further comprising:
while displaying the second object at a first location in the environment, and while the first representation of the first virtual asset has a first spatial relationship with the second object, detecting, via the one or more input devices, a second input corresponding to a request to move the second object to a second location, different from the first location, in the environment; and
in response to detecting the second input, moving the second object to the second location in accordance with the second input, while maintaining the first spatial relationship between the first representation of the first virtual asset and the second object in the environment.

10. The method of claim 9, wherein the first object is displayed at a third location, different from the first location, in the environment while the second object is displayed at the first location in the environment, the method further comprising:
while moving the second object to the second location in response to detecting the second input, maintaining display, via the one or more display generation components, of the first object at the third location in the environment.

11. The method of claim 1, further comprising:
while displaying the first representation of the first virtual asset relative to the second object, wherein the first representation of the first virtual asset has a first spatial relationship with the second object in the environment, detecting, via the one or more input devices, a second input corresponding to a request to move the first representation of the first virtual asset in the environment; and
in response to detecting the second input, moving the first representation of the first virtual asset relative to the second object such that the first representation of the first virtual asset has a second spatial relationship, different from the first spatial relationship, with the second object in the environment.

12. The method of claim 11, wherein moving the first representation of the first virtual asset relative to the second object in response to detecting the second input includes:
in accordance with a determination that movement of the first representation of the first virtual asset relative to the second object corresponds to movement of the first representation of the first virtual asset to a boundary associated with the second object, displaying, via the one or more display generation components, a visual effect corresponding to the boundary associated with the second object in the environment.

13. The method of claim 12, wherein the visual effect corresponding to the boundary has one or more first visual characteristics that are based on one or more second visual characteristics of the first representation of the first virtual asset in the environment.

14. The method of claim 11, wherein the second object is associated with one or more boundaries in the environment, and wherein moving the first representation of the first virtual asset relative to the second object in response to detecting the second input includes:
in accordance with a determination that the second input includes an air pinch gesture that satisfies one or more timing criteria and that moving the first representation of the first virtual asset corresponds to movement of the first representation of the first virtual asset beyond a respective boundary of the one or more boundaries, moving the first representation of the first virtual asset beyond the respective boundary in the environment in accordance with the second input.

15. The method of claim 1, further comprising:
while displaying the first representation of the first virtual asset relative to the second object in the environment:
detecting, via the one or more input devices, a second input directed to a second representation of a second virtual asset, different from the first representation of the first virtual asset; and
in response to detecting the second input, in accordance with a determination that the second input satisfies one or more second criteria, displaying, via the one or more display generation components, the second representation of the second virtual asset relative to the second object in the environment.

16. The method of claim 1, further comprising:
in response to detecting an end of the first input, and while displaying the second object in the environment, displaying, in the first object, a first visual indication of the second object, wherein the first visual indication has a first visual appearance in the environment.

17. The method of claim 16, further comprising:
while displaying the second object in the environment, and while displaying the first visual indication having the first visual appearance in the first object, detecting, via the one or more input devices, a second input corresponding to a request to cease display of the second object in the environment; and
in response to detecting the second input:
ceasing display, via the one or more display generation components, of the second object in the environment; and
updating display of the first visual indication of the second object in the first object to have a second visual appearance, different from the first visual appearance, in the environment.

18. The method of claim 17, wherein, while detecting the second input, the first representation of the first virtual asset is displayed with a first spatial relationship with the second object in the environment, the method further comprising:
after detecting the second input and while displaying the first visual indication of the second object having the second visual appearance in the first object, detecting, via the one or more input devices, a third input directed to the first visual indication of the second object; and
in accordance with a determination that the third input satisfies the one or more first criteria:
displaying, via the one or more display generation components, the second object in the environment; and
displaying, via the one or more display generation components, the first representation of the first virtual asset with the first spatial relationship with the second object in the environment.

19. The method of claim 1, wherein:
while displaying the first representation of the first virtual asset in the first object, the first representation of the first virtual asset corresponds to a visual indication of a plurality of virtual objects having a first spatial arrangement, and
displaying the first representation of the first virtual asset relative to the second object includes displaying the plurality of virtual objects in the environment relative to the second object, the plurality of virtual objects having the first spatial arrangement.

20. The method of claim 19, further comprising:
while displaying the plurality of virtual objects in the environment relative to the second object in accordance with the determination that the first input satisfies the one or more first criteria in response to detecting the first input, detecting, via the one or more input devices, a second input directed to a first virtual object of the plurality of virtual objects; and
in response to detecting the second input, in accordance with a determination that the second input satisfies one or more second criteria:
ceasing display, via the one or more display generation components, of the first virtual object relative to the second object in the environment; and
displaying, via the one or more display generation components, a representation of the first virtual object in the first object.

21. The method of claim 1, wherein:
displaying the first object in the environment includes displaying the first object with a first virtual toolbar, the first virtual toolbar including a first set of selectable options that is selectable to perform one or more first operations; and
displaying the second object in the environment includes displaying the second object with a second virtual toolbar, the second virtual toolbar including a second set of selectable options, different from the first set of selectable options, which is selectable to perform one or more second operations.

22. The method of claim 21, further comprising:
while displaying the first object with a first level of immersion in the environment, detecting, via the one or more input devices, a second input directed to a first selectable option of the first set of selectable options; and
in response to detecting the second input, displaying, via the one or more display generation components, the first object with a second level of immersion, greater than the first level of immersion, in the environment.

23. The method of claim 1, further comprising:
while displaying the second object in the environment, and while displaying a visual indication of one or more virtual objects in the first object, detecting, via the one or more input devices, a second input directed to the visual indication of the one or more virtual objects;
in accordance with a determination that the second input satisfies the one or more first criteria, displaying, via the one or more display generation components, a third object in the environment having the second orientation relative to the current viewpoint of the user, wherein the third object is displayed in the environment concurrently with the second object;
while displaying the second object and the third object in the environment, detecting, via the one or more input devices, a third input corresponding to user interaction with a respective object in the environment; and
in response to detecting the third input:
in accordance with a determination that the third input corresponds to user interaction with the second object, performing an operation in association with the second object and forgoing performing the operation in association with the third object; and
in accordance with a determination that the third input corresponds to user interaction with the third object, performing the operation in association with the third object and forgoing performing the operation in association with the second object.

24. The method of claim 1, wherein the environment further includes a user interface associated with a first application running on the computer system, the method further comprising:
while concurrently displaying the first representation of the first virtual asset relative to the second object and the user interface associated with the first application in the environment, detecting, via the one or more input devices, a second input corresponding to a request to move the first representation of the first virtual asset in the environment, wherein the second input includes an air pinch gesture satisfying one or more timing criteria; and
in response to detecting the second input, in accordance with a determination that the request to move the first representation of the first virtual asset in the environment corresponds to movement of the first representation of the first virtual asset to the user interface in the environment:
moving the first representation of the first virtual asset toward the user interface in the environment in accordance with the second input; and
displaying, via the one or more display generation components, a second representation of the first virtual asset in the user interface in the environment.

25. A computer system that is in communication with one or more input devices and one or more display generation components, the computer system comprising:
one or more processors;
memory; and
one or more programs, wherein the one or more programs are stored in the memory and configured to be executed by the one or more processors, the one or more programs including instructions for:
while displaying, via the one or more display generation components, a first object including one or more representations of virtual assets in an environment, the first object having a first orientation relative to a current viewpoint of a user of the computer system, detecting, via the one or more input devices, a first input directed to a first representation of a first virtual asset of the one or more representations of virtual assets; and
in response to detecting the first input, in accordance with a determination that the first input satisfies one or more first criteria:
displaying, via the one or more display generation components, a second object, different from the first object, in the environment, the second object having a second orientation, different from the first orientation, relative to the current viewpoint of the user; and
displaying, via the one or more display generation components, the first representation of the first virtual asset of the one or more representations of virtual assets relative to the second object in the environment.

26. A non-transitory computer readable storage medium storing one or more programs, the one or more programs comprising instructions, which when executed by one or more processors of a computer system that is in communication with one or more input devices and one or more display generation components, cause the computer system to perform a method comprising:
while displaying, via the one or more display generation components, a first object including one or more representations of virtual assets in an environment, the first object having a first orientation relative to a current viewpoint of a user of the computer system, detecting, via the one or more input devices, a first input directed to a first representation of a first virtual asset of the one or more representations of virtual assets; and
in response to detecting the first input, in accordance with a determination that the first input satisfies one or more first criteria:
displaying, via the one or more display generation components, a second object, different from the first object, in the environment, the second object having a second orientation, different from the first orientation, relative to the current viewpoint of the user; and
displaying, via the one or more display generation components, the first representation of the first virtual asset of the one or more representations of virtual assets relative to the second object in the environment.

27-69. (canceled)
